(19) United States
(12) Patent Application Publication
(10) Pub. No.: US 2025/0035986 A1
(43) Pub. Date: Jan. 30, 2025

(54) OPTICALLY FUNCTIONAL FILM, OPTICAL LAMINATE, FORMED PRODUCT, MANUFACTURING METHOD OF OPTICAL COMPONENT, OPTICAL COMPONENT, VIRTUAL REALITY DISPLAY APPARATUS, OPTICAL FILM, AND FORMING METHOD

(71) Applicant: FUJIFILM Corporation, Tokyo (JP)

(72) Inventors: Naoyoshi YAMADA, Minamiashigara-shi (JP); Ryuji SANETO, Minamiashigara-shi (JP); Yohei HAMACHI, Minamiashigara-shi (JP)

(73) Assignee: FUJIFILM Corporation, Tokyo (JP)

(21) Appl. No.: 18/913,432

(22) Filed: Oct. 11, 2024

Related U.S. Application Data
(63) Continuation of application No. PCT/JP2023/015071, filed on Apr. 13, 2023.

(30) Foreign Application Priority Data
Apr. 14, 2022 (JP) 2022-066980
Aug. 23, 2022 (JP) 2022-132735
Oct. 5, 2022 (JP) 2022-160935

(51) Int. Cl. G02F 1/13363; G02B 1/08; G02F 1/1333

(52) U.S. Cl. CPC G02F 1/133636; G02B 1/08; G02F 1/133382

(57) ABSTRACT

An object of the present invention is to provide an optically functional film in which expression of a phase difference and a change in phase difference in a case of being formed into a three-dimensional shape including a curved surface are suppressed, and for example, in a case of being applied to a pancake lens-type virtual reality display apparatus, it is possible to reduce light leakage. Another object of the present invention is to provide an optical laminate including the above-described optically functional film, a formed product, a manufacturing method of an optical component, an optical component, and a virtual reality display apparatus.

The optically functional film of the present invention is an optically functional film obtained by forming a composition which contains at least a liquid crystal compound having a polymerizable group, in which a polymerization rate of the liquid crystal compound is 40% or less. In addition, the optical laminate, the formed product, the manufacturing method of an optical component, the optical component, and the virtual reality display apparatus of the present invention include the above-described optically functional film.

### CROSS-REFERENCE TO RELATED APPLICATIONS

This application is a Continuation of PCT International Application No. PCT/JP2023/015071 filed on Apr. 13, 2023, which claims priority under 35 U.S.C. § 119(a) to Japanese Patent Application No. 2022-066980 filed on Apr. 14, 2022, and Japanese Patent Application No. 2022-132735 filed on Aug. 23, 2022, and Japanese Patent Application No. 2022-160935 filed on Oct. 5, 2022. The above applications are hereby expressly incorporated by reference, in their entirety, into the present application.

### BACKGROUND OF THE INVENTION

### 1. Field of the Invention

The present invention relates to an optically functional film, an optical laminate, a formed product, a manufacturing method of an optical component, an optical component, a virtual reality display apparatus, an optical film, and a forming method.

### 2. Description of the Related Art

A virtual reality display apparatus is a display device which can obtain a realistic effect as if entering a virtual world by wearing a dedicated headset on a head and visually recognizing a video displayed through a composite lens.

The virtual reality display apparatus generally includes an image display panel and a Fresnel lens, but a distance from the image display panel to the Fresnel lens is large, and thus a headset is thick and has poor wearability, which are problems.

Therefore, as disclosed in JP2020-519964A and U.S. Ser. No. 10/394,040B2, a lens configuration of a composite lens called a pancake lens has been proposed, the lens configuration including an image display panel, a reflective type polarizer, and a half mirror, in which the entire thickness of a headset is reduced by reciprocating rays emitted from the image display panel between the reflective type polarizer and the half mirror.

The reflective polarizer herein is a polarizer having a function of reflecting one polarized light in incidence ray and transmitting the other polarized light. Reflected light and transmitted light due to the reflective polarizer are in a polarization state of being orthogonal to each other. Here, the polarization state of being orthogonal to each other denotes a polarization state in which both lights are positioned at antipodal points on the Poincare sphere, and for example, linearly polarized lights orthogonal to each other or clockwise circularly polarized light and counterclockwise circularly polarized light are in the corresponding state.

As the reflective type linear polarizer in which the transmitted light and the reflected light are linearly polarized, for example, a film in which a dielectric multi-layer film is stretched and a wire grid polarizer have been known. In addition, as a reflective type circular polarizer in which the transmitted light and the reflected light are converted into circularly polarized light, for example, a cholesteric liquid crystal layer having a light reflecting layer in which a cholesteric liquid crystalline phase is immobilized has been known.

### SUMMARY OF THE INVENTION

JP2020-519964A discloses a method of bonding an optical laminate on a curved surface of a spherical surface of an aspherical surface of an optical lens in order to obtain a wide visual field, low chromatic aberration, low distortion, and excellent modulation transfer function (MTF).

However, in order to bond the optical laminate including an optically anisotropic layer to a curved surface, it is necessary to form the optical laminate into a three-dimensional shape including a curved surface, and in this case, there is a problem that phase difference is exhibited in the optically anisotropic layer, or inherent phase difference in the optically anisotropic layer changes due to stretching of the optically anisotropic layer. In addition, in the forming of the three-dimensional shape including a curved surface, the optical laminate is stretched at different stretching ratios depending on the location, and the amount of expression or the amount of change of the phase difference may be different depending on the location, which is also a problem.

In a case where the optically anisotropic layer is a retardation layer such as λ/4 retardation layer, the phase difference of the optically anisotropic layer may be unintentionally expressed due to the expression of the undesirable phase difference. Furthermore, an optical axis of the optically anisotropic layer may be changed to an unintended orientation.

In addition, even in a case where the optically anisotropic layer is a layer which usually does not have phase difference, such as a cholesteric liquid crystal layer, the optically anisotropic layer may exhibit new phase difference by stretching the optically anisotropic layer. In a case where the cholesteric liquid crystal layer exhibits the phase difference, there may be a problem that the reflected polarized light is not intended circularly polarized light but elliptically polarized light.

According to the studies of the present inventors, it has been found that the expression of such an undesirable phase difference and the change in phase difference disturb the polarization of rays emitted from the image display device in the pancake lens, and thus a part of the rays is to be leaked light, which leads to double images and a decrease in contrast.

In addition, JP2020-519964A discloses a composite lens having a configuration of a pancake lens, including an image display panel, a reflective type linear polarizer, and a half mirror in this order, in which the reflective type linear polarizer is used as the reflective type polarizer. In a case of including the image display panel, the reflective type polarizer, and the half mirror in this order, it is necessary for the reflective type polarizer to have an action of a concave mirror with respect to a ray incident from the half mirror side. In order to impart the action of the concave mirror to the reflective type linear polarizer, a configuration in which the reflective type linear polarizer is formed into a curved surface shape is proposed.

In addition, U.S. Ser. No. 10/394,040B2 discloses a composite lens having a configuration of a pancake lens, including an image display panel, a half mirror, and a reflective type linear polarizer in this order, in which the reflective type linear polarizer is used as the reflective type polarizer. U.S. Ser. No. 10/394,040B2 proposes a configuration in which both the half mirror and the reflective type polarizer are curved to improve field curvature. In this case, it is necessary for the reflective type polarizer to have an action of a convex mirror.

According to the studies of the present inventors, in a case where the reflective type linear polarizer is formed into a curved shape, the phase difference of the retardation film which is disposed between the reflective type polarizer and the half mirror and converts circularly polarized light and linearly polarized light, changes, and as a result, incidence ray cannot be appropriately reflected and transmitted, leading to an increase in light leakage. As the light leakage increases, ghost is visually noticeable.

A first embodiment of the present invention has been made in view of the above-described circumstances, and an object to be achieved by the first embodiment of the present invention is to provide an optically functional film in which expression of a phase difference and a change in phase difference in a case of being formed into a three-dimensional shape including a curved surface are suppressed, and for example, in a case of being applied to a pancake lens-type virtual reality display apparatus, it is possible to reduce light leakage. Another object to be achieved by the first embodiment of the present invention is to provide an optical laminate, a formed product, a manufacturing method of an optical component, an optical component, and a virtual reality display apparatus.

A second embodiment of the present invention has been made in view of the above-described circumstances, and an object to be achieved by the second embodiment of the present invention is to provide an optical film which suppresses occurrence of light leakage in a case of being applied to a pancake lens-type virtual reality display apparatus.

Another object to be achieved by the second embodiment of the present invention is to provide a forming method of the above-described optical film.

As a result of intensive studies repeatedly conducted by the present inventors on the above-described object, it has been found that the above-described object can be achieved by the following configurations.

[1] An optically functional film obtained by forming a composition which contains at least a liquid crystal compound having a polymerizable group,
in which a polymerization rate of the liquid crystal compound is 40% or less.

[2] The optically functional film according to [1],
in which the liquid crystal compound is aligned in one direction.

[3] The optically functional film according to [1],
in which the liquid crystal compound is helically aligned.

[4] An optical laminate comprising:
the optically functional film according to any one of [1] to [3]; and
a substrate film consisting of a resin having a peak temperature of tan δ of 170° C. or lower.

[5] A formed product obtained by forming, into a three-dimensional shape including a curved surface, the optically functional film according to any one of [1] to [3] or an optical laminate including the optically functional film according to any one of [1] to [3] and a substrate film.

[6] A manufacturing method of an optical component, comprising:
a curing step of performing at least one curing treatment selected from the group consisting of a heat treatment and an ultraviolet irradiation on the formed product according to [5],
in which the polymerization rate of the liquid crystal compound in the optically functional film is to be 50% or more by the curing treatment.

[7] The manufacturing method of an optical component according to [6], further comprising, before the curing step:
an alignment step of heating the formed product to align the liquid crystal compound.

[8] An optical component manufactured by the manufacturing method of an optical component according to [6] or [7].

[9] A virtual reality display apparatus comprising:
an image display device which emits polarized light; and
the optical component according to [8].

As a result of intensive studies, the present inventors have found that a thin virtual reality display apparatus having a pancake lens configuration capable of reducing light leakage can be realized by an optical film having a non-planar shape, in which a curvature radius is 30 to 1,000 mm and an in-plane variation of a phase difference is less than 5%.

In other words, it has been found that the above-described objects can be achieved by employing the following configurations.

[10] An optical film having a non-planar shape,
in which a curvature radius is 30 mm to 1,000 mm, and
an in-plane variation of a phase difference is less than 5%.

[11] The optical film according to [10],
in which the curvature radius is 30 mm to 100 mm.

[12] The optical film according to [10] or [11],
in which the in-plane variation of the phase difference is less than 3%.

[13] The optical film according to any one of [10] to [12],
in which an in-plane variation of a film thickness is less than 5%.

[14] The optical film according to any one of [10] to [13],
in which the optical film is a retardation film.

[15] The optical film according to any one of [10] to [14],
in which the optical film is a retardation film in which an in-plane retardation at a wavelength of 550 nm is in a range of 120 nm to 160 nm.

[16] The optical film according to any one of [10] to [13],
in which the optical film is a laminated optical body including a retardation film and a reflective type polarizer.

[17] A forming method of an optical film, comprising:
a step of heating an optical film having a planar shape;
a first forming step of pressing the optical film against a first mold to deform the optical film along a shape of the first mold; and
a second forming step of pressing the optical film obtained in the first forming step against a second mold to deform the optical film along a shape of the second mold.

[18] The forming method of an optical film according to [17],
in which the shape of the first mold includes a convex curved surface portion, and
the shape of the second mold includes a concave curved surface portion.

[19] The forming method of an optical film according to [17] or [18],
in which a curvature radius of the first mold is larger than a curvature radius of the second mold.

[20] A forming method of an optical film, comprising:
a step of heating an optical film having a planar shape;
a step of pressing the optical film against a mold to deform the optical film along a shape of the mold; and
a step of cutting the deformed optical film,
in which the heating step is a step of heating the optical film by irradiating the optical film with infrared rays, and
an irradiation amount of the infrared rays has a distribution in a plane of the optical film.

[21] The forming method of an optical film according to [20],
in which the mold is substantially concave sphere, and
in a case where an in-plane position of the optical film is projected onto the mold from a normal direction of a surface of the optical film, an amount of infrared irradiation to the optical film located at a vertex of the concave sphere is smaller than an amount of infrared irradiation to the optical film located at an end part of the concave sphere.

[22] The forming method of an optical film according to [20] or [21],
in which the mold is substantially concave sphere, and
in a case where an in-plane position of the optical film is projected onto the mold from a normal direction of a surface of the optical film, a temperature of the optical film located at a vertex of the concave sphere is lower than a temperature of the optical film located at an end part of the concave sphere.

[23] A forming method of an optical film, in which an optical film having a planar shape is deformed into a non-planar shape,
in which an in-plane variation of a product of a stretching ratio in a diameter direction and a stretching ratio in a circumferential direction is less than 5%.

[24] The forming method of an optical film according to [23],
in which the in-plane variation of the product of the stretching ratio in the diameter direction and the stretching ratio in the circumferential direction is less than 3%.

[25] The forming method of an optical film according to [23] or [24],
in which the stretching ratio in the diameter direction increases as a distance from a center increases.

According to the first embodiment of the present invention, it is possible to provide an optically functional film in which expression of a phase difference and a change in phase difference in a case of being formed into a three-dimensional shape including a curved surface are suppressed, and for example, in a case of being applied to a pancake lens-type virtual reality display apparatus, it is possible to reduce light leakage. In addition, according to the first embodiment of the present invention, it is possible to provide an optical laminate, a formed product, a manufacturing method of an optical component, an optical component, and a virtual reality display apparatus.

According to the second embodiment of the present invention, it is possible to provide an optical film which suppresses occurrence of light leakage in a case of being applied to a pancake lens-type virtual reality display apparatus.

In addition, according to the second embodiment of the present invention, it is possible to provide a forming method of the above-described optical film.

### BRIEF DESCRIPTION OF THE DRAWINGS

FIG. 1 is a schematic view showing an example of a virtual reality display apparatus according to the first embodiment.

FIG. 2 is a schematic view showing another example of the virtual reality display apparatus according to the first embodiment.

FIG. 3 is an example of a virtual reality display apparatus using the laminated optical body according to the second embodiment of the present invention, and shows an example of a ray of a main image.

FIG. 4 is an example of the virtual reality display apparatus using the laminated optical body according to the second embodiment of the present invention, and shows an example of a ray of ghost.

FIG. 5 is a schematic view showing an example of the laminated optical body according to the second embodiment of the present invention.

FIG. 6 is a schematic view showing an example of a reflective type circular polarizer according to the second embodiment of the present invention.

FIG. 7 is a schematic view showing an example of the laminated optical body according to the second embodiment of the present invention.

FIG. 8 is an example of a pattern drawn on an optical film in a forming method according to the second embodiment of the present invention to investigate a stretching ratio in a diameter direction and a stretching ratio in a circumferential direction.

FIG. 9 is a view for describing a procedure for forming a film using a forming die having a concave forming surface.

FIG. 10 is a view for describing a procedure for forming a film using a forming die having a concave forming surface.

FIG. 11 is a top view of the film used for forming.

FIG. 12 is a view for describing a procedure for forming a film using a forming die having a convex forming surface.

FIG. 13 is a view for describing a procedure for forming a film using a forming die having a convex forming surface.

FIG. 14 is a view for describing a forming method 1.

FIG. 15 is a view for describing the forming method 1.

FIG. 16 is a view for describing the forming method 1.

FIG. 17 is a view for describing a forming method 2.

FIG. 18 is a top view of an optical film having a planar shape, used in the forming method 2.

### DESCRIPTION OF THE PREFERRED EMBODIMENTS

Hereinafter, the present invention will be described in detail.

The description of configuration requirements described below may be made based on typical embodiments of the present invention, but the present invention is not limited to such embodiments.

Any numerical range expressed using “to” in the present specification refers to a range including the numerical values before and after the “to” as a lower limit value and an upper limit value, respectively.

In addition, in the present specification, a liquid crystal composition and a liquid crystal compound include those which no longer exhibit liquid crystal properties due to curing or the like as a concept.

Hereinafter, the present invention will be described in detail with reference to the accompanying drawings. The description of the configuration requirements described below may be made based on representative embodiments and specific examples, but the present invention is not limited to such embodiments. Any numerical range expressed using “to” in the present specification refers to a range including the numerical values before and after the “to” as a lower limit value and an upper limit value, respectively.

In the present specification, the term “orthogonal” does not denote 90° in a strict sense, but denotes 90°±10°, preferably 90°±5°. In addition, a term “parallel” does not denote 0° in a strict sense, but denotes 0°±10°, preferably 0°±5°. Furthermore, a term “45°” does not denote 45° in a strict sense, but denotes 450±10°, preferably 450° 5°.

In the present specification, a term “absorption axis” denotes a polarization direction in which absorbance is maximized in a plane in a case where linearly polarized light is incident. In addition, a term “reflection axis” denotes a polarization direction in which reflectivity is maximized in a plane in a case where linearly polarized light is incident. In addition, a term “transmission axis” denotes a direction orthogonal to the absorption axis or the reflection axis in a plane. Furthermore, a term “slow axis” denotes a direction in which refractive index is maximized in a plane.

In the present specification, a phase difference denotes an in-plane retardation unless otherwise specified, and is referred to as Re (λ). Here, Re (λ) represents an in-plane retardation at a wavelength λ, and the wavelength λ is 550 nm unless otherwise specified.

In addition, a retardation at the wavelength λ in a thickness direction is referred to as Rth (λ) in the present specification.

As Re (λ) and Rth (λ), values measured at the wavelength λ with AxoScan OPMF-1 (manufactured by Opto Science, Inc.) can be used. By inputting an average refractive index ((nx+ny+nz)/3) and a film thickness (d (μm)) in AxoScan,
a slow axis direction (°)
Re (λ)=R0 (λ), and
“Rth (λ)=((nx+ny)/2−nz)×d” are calculated.

In the present specification, a polymerization rate of a liquid crystal compound having a polymerizable group represents a proportion of the number of polymerizable groups which contribute to a polymerization reaction in a case where the liquid crystal compound having a polymerizable group is polymerized by irradiation with active energy rays and/or heating. That is, (Polymerization rate (%)={Number of polymerizable groups disappeared by polymerization reaction/Number of polymerizable groups before polymerization reaction}×100.

Specifically, the polymerization rate of the liquid crystal compound having a polymerizable group can be obtained by measuring a ratio of an absorbance of an infrared absorption peak due to the polymerizable group before and after the polymerization reaction. For example, in a case where the polymerizable group is a methacrylate monomer or a methacrylate monomer, it is preferable to obtain the above-described polymerization rate based on an absorbance of an absorption peak to be measured, in which the absorption peak can be measured based on a polymerizable group (acryloyloxy group or methacryloyloxy group) in the vicinity of 810 cm⁻¹ in an infrared absorption spectrum of a film or the like, containing the polymerizable compound. In addition, in a case where the polymerizable compound is an oxetane compound, it is preferable that an absorption peak based on a polymerizable group (oxetanyl group) can be measured in the vicinity of 986 cm⁻¹ of the infrared absorption spectrum of the film or the like, containing the polymerizable compound, and the above-described polymerization rate is obtained from an absorbance of the measured absorption peak. In a case where the polymerizable compound is an epoxy compound, it is preferable that an absorption peak based on a polymerizable group (epoxy group) can be measured in the vicinity of 750 cm⁻¹ of the infrared absorption spectrum of the film or the like, containing the polymerizable compound, and the above-described polymerization rate is obtained from an absorbance of the measured absorption peak.

As a unit for measuring the infrared absorption spectrum of the optically functional film, a commercially available infrared spectrophotometer can be used. Either a transmission type or a reflection type may be used, and it is preferable to appropriately select the type according to the form of the sample. The infrared absorption spectrum of the optically functional film can be measured using, for example, an infrared spectrophotometer “FTS-6000” manufactured by Bio-Rad Laboratories, Inc.

A more specific method of measuring the polymerization rate of the liquid crystal compound in the optically functional film described above is as follows. For example, in a case where the optically functional film is formed of a composition containing a liquid crystal compound having a polymerizable group, before irradiating a coating film formed of the composition with active energy rays and/or heating the coating film, an infrared absorption spectrum A of the coating film is measured by Attenuated Total Reflection (ATR) method. Subsequently, an infrared absorption spectrum B of a film to be formed after the irradiation with active energy rays and/or the heating is measured by the ATR method in the same manner. In each of the infrared absorption spectra A and B, an absorption peak based on the polymerizable group included in the liquid crystal compound appears. The polymerization rate of the liquid crystal compound having a polymerizable group in the optically functional film can be obtained from an absorbance A of an absorption peak appearing in the infrared absorption spectrum A and an absorbance B of an absorption peak appearing in the infrared absorption spectrum B, based on Expression (1).

$$Polymerization rate ( \% ) = \{ ( Absorbance A - Absorbance B ) / ( Absorbance A ) \} \times 100 \qquad ( 1 )$$

### <Optically Functional Film>

The optically functional film according to the first embodiment is formed of a composition containing a liquid crystal compound having a polymerizable group. Since the liquid crystal compound can be easily aligned in any orientation by photo alignment or the like, various optical functions can be imparted.

In addition, in the optically functional film according to the first embodiment, a polymerization rate of the liquid crystal compound having a polymerizable group is 40% or less.

Hereinafter, the liquid crystal compound having a polymerizable group may be simply referred to as “liquid crystal compound”.

The liquid crystal compound also includes a compound which no longer exhibits liquid crystallinity due to curing or the like.

In the optically functional film, the liquid crystal compound may be aligned in one direction, for example. The optically functional film in which such a liquid crystal compound is aligned in one direction can be used as a retardation film.

In addition, an optically functional film containing a liquid crystal compound aligned in one direction and further containing a dichroic substance can be used as an absorption type linear polarizer.

Furthermore, in the optically functional film, the liquid crystal compound may be helically aligned. The helically aligned liquid crystal compound is also referred to as a cholesteric liquid crystal, and the optically functional film containing the helically aligned liquid crystal compound can be used as a reflective type circular polarizer.

Any of the above-described optically functional films is useful in a pancake lens-type virtual reality display apparatus or the like.

Here, a virtual reality display apparatus manufactured using the optically functional film according to the first embodiment will be described with reference to the drawings.

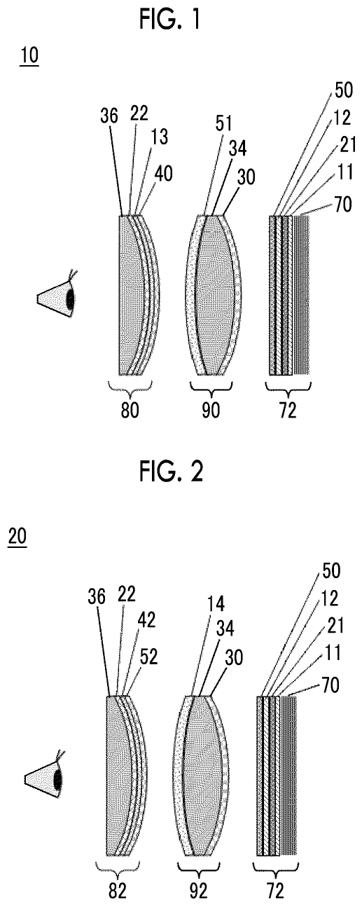

FIG. 1 is a schematic view showing an example of the virtual reality display apparatus according to the first embodiment.

A virtual reality display apparatus 10 shown in FIG. 1 includes, from the right side in the drawing, an image display device 72 consisting of an image display panel 70, λ/4 retardation layer 11, an absorption type linear polarizer 21, a λ/4 retardation layer 12, and an antireflection layer 50; a biconvex lens 90 with an optically functional layer, consisting of a half mirror 30, a lens base material 34, and an antireflection layer 51; and a plano-convex lens 80 with an optically functional layer, consisting of a reflective type circular polarizer 40, λ/4 retardation layer 13, an absorption type linear polarizer 22, and a lens base material 36.

As will be described later, in the virtual reality display apparatus 10 shown in FIG. 1, each of the λ/4 retardation layer 13, the absorption type linear polarizer 22, and the reflective type circular polarizer 40 may be a film obtained by forming the optically functional film according to the first embodiment into a three-dimensional shape including a curved surface (hereinafter, also referred to as “curved shape”) and performing a predetermined curing treatment.

As shown in a modification example of a virtual reality display apparatus described later, the usage of the optically functional film according to the first embodiment is not limited to the above-described optical members of the virtual reality display apparatus 10 shown in FIG. 1, and is also useful, for example, as an optical member to be bonded to the biconvex lens.

In the virtual reality display apparatus 10, the lens base material 34 is a biconvex lens, the half mirror 30 is formed into a curved shape and bonded to one surface of the lens base material 34, and the antireflection layer 51 is formed into a curved shape and bonded to the other surface. The bonding in this case may be performed by a known method such as a method using an optical clear adhesive (OCA) or the like. The same applies to the bonding in the following.

In addition, the lens base material 36 is a plano-convex lens, and the absorption type linear polarizer 22, the λ/4 retardation layer 13, and the reflective type circular polarizer 40 are each formed into a curved shape and bonded to the convex surface of the lens base material 36 in this order.

The lens base material 34 and the lens base material 36 are formed of a material which is transparent to visible light, such as glass and an acrylic plate, preferably a material having no phase difference.

The image display panel 70 is, for example, a known image display panel (display panel) such as an organic electroluminescence display panel.

In the illustrated example, the image display panel 70 emits an image (image light) of unpolarized light. The image of unpolarized light emitted from the image display panel 70 passes through the λ/4 retardation layer 11, is transmitted through the absorption type linear polarizer 21 to be linearly polarized light, is converted into circularly polarized light by the λ/4 retardation layer 12, and is transmitted through the antireflection layer 50. As a result, levorotatory circularly polarized light is emitted from the image display device 72.

For example, the absorption type linear polarizer 21 is an absorption type linear polarizer which transmits linearly polarized light in a direction perpendicular to the paper surface. For example, the λ/4 retardation layer 12 is provided with its slow axis aligned so that the linearly polarized light in the direction perpendicular to the paper surface is converted into levorotatory circularly polarized light.

The antireflection layer 50 and the antireflection layer 51 are a known antireflection layer (AR coat) such as a magnesium fluoride layer and a silicon oxide layer. In addition, an antireflection film known in the related art may be bonded.

Next, the levorotatory circularly polarized light transmitted through the antireflection layer 50 is incident on the half mirror 30, and half of the levorotatory circularly polarized light is transmitted. The levorotatory circularly polarized light transmitted through the half mirror 30 is transmitted through the lens base material 34 and the antireflection layer 51.

The levorotatory circularly polarized light reflected by the half mirror 30 is converted into dextrorotatory circularly polarized light by reflection, and is transmitted through the antireflection layer 50 and is incident on the λ/4 retardation layer 12.

The λ/4 retardation layer 12 converts linearly polarized light in a direction perpendicular to the paper surface into levorotatory circularly polarized light. Therefore, the dextrorotatory circularly polarized light incident on the λ/4 retardation layer 12 is converted into linearly polarized light in an up-down direction of the paper surface, and is incident on the absorption type linear polarizer 21.

The absorption type linear polarizer 21 is an absorption type linear polarizer which transmits linearly polarized light in a direction perpendicular to the paper surface. Therefore, the linearly polarized light in the up-down direction of the paper surface is absorbed by the absorption type linear polarizer 21.

The same applies to a virtual reality display apparatus 20 shown in FIG. 2, which will be described later.

The reflective type circular polarizer 40 is, for example, a reflective type circular polarizer including a cholesteric liquid crystal layer, and is a reflective type circular polarizer which reflects levorotatory circularly polarized light and transmits other light. Therefore, the levorotatory circularly polarized light incident on the reflective type circular polarizer 40 is reflected by the reflective type circular polarizer 40, and is transmitted through the antireflection layer 51 and the lens base material 34 to be incident on the half mirror 30.

The reflective type circular polarizer 40 may be a reflective type circular polarizer which is obtained by forming the optically functional film according to the first embodiment, which contains a helically aligned liquid crystal compound, into a curved shape and performing a predetermined curing treatment.

Half of the levorotatory circularly polarized light incident on the half mirror 30 is reflected by the half mirror 30. By the reflection, the levorotatory circularly polarized light is converted into dextrorotatory circularly polarized light.

The dextrorotatory circularly polarized light reflected by the half mirror 30 is transmitted through the lens base material 34 and the antireflection layer 51, and is incident on the reflective type circular polarizer 40.

As described above, the reflective type circular polarizer 40 is a reflective type circular polarizer (cholesteric liquid crystal layer) which reflects the levorotatory circularly polarized light and transmits the other light. Therefore, the dextrorotatory circularly polarized light incident on the reflective type circular polarizer 40 is transmitted through the reflective type circular polarizer 40 and is incident on the λ/4 retardation layer 13.

The λ/4 retardation layer 13 is a λ/4 retardation layer disposed to align a slow axis direction such that dextrorotatory circularly polarized light is converted into linearly polarized light in the up-down direction of the paper surface. In addition, the absorption type linear polarizer 22 is a linear polarizer disposed with a transmission axis aligned to transmit linearly polarized light in the up-down direction of the paper surface. Therefore, the dextrorotatory circularly polarized light incident on the λ/4 retardation layer 13 is converted into linearly polarized light in the up-down direction of the paper surface by the λ/4 retardation layer 13, and then is transmitted through the absorption type linear polarizer 22, transmitted through the lens base material 36, and observed by the user of the virtual reality display apparatus 10 as a virtual reality image.

The λ/4 retardation layer 13 may be a reflective type circular polarizer which is obtained by forming the optically functional film according to the first embodiment, which contains a liquid crystal compound aligned in one direction, into a curved shape and performing a predetermined curing treatment. In addition, the absorption type linear polarizer 22 may be a reflective type circular polarizer which is obtained by forming the optically functional film according to the first embodiment, which contains a liquid crystal compound aligned in one direction and a dichroic substance, into a curved shape and performing a predetermined curing treatment.

The absorption type linear polarizer 22 prevents light which is unnecessarily transmitted through the reflective type circular polarizer 40 from being leaked (ghost) and observed by the user of the virtual reality display apparatus 10 by shielding the light.

That is, in a case where the levorotatory circularly polarized light is incident on the reflective type circular polarizer 40 for the first time, there is also the levorotatory circularly polarized light which is not reflected by the reflective type circular polarizer 40 and is unnecessarily transmitted through the reflective type circular polarizer 40.

However, the levorotatory circularly polarized light is converted into linearly polarized light in the up-down direction of the paper surface by the λ/4 retardation layer 13 converting the dextrorotatory circularly polarized light into linearly polarized light in the direction perpendicular to the paper surface. Therefore, since the linearly polarized light is absorbed by the absorption type linear polarizer 22 which is a linear polarizer disposed with a transmission axis aligned to transmit linearly polarized light in the up-down direction of the paper surface, the linearly polarized light is absorbed as leaked light, and thus the linearly polarized light can be prevented from being observed by the user.

Here, in the virtual reality display apparatus 10 shown in FIG. 1, the reflective type circular polarizer 40, the λ/4 retardation layer 13, and the absorption type linear polarizer 22 are formed into a curved shape and bonded to the convex surface of the lens base material 36 which is a plano-convex lens.

In a case where the optically functional film is formed into a curved shape, residual stress is generated in the optically functional film after the forming due to stretching, and a phase difference is expressed or changed by a photoelastic effect. In addition, in the forming of the curved shape, since a stretching ratio varies depending on the position, the amount of expression or the amount of change of the phase difference may be locally different.

For example, in the λ/4 retardation layer 13 formed in a curved shape of the virtual reality display apparatus 10, in a case where the actual phase difference is at least locally different from the intended phase difference, the levorotatory circularly polarized light transmitted through the reflective type circular polarizer 40 is converted into light including not only the component in the vertical direction of the paper surface but also the component in the up-down direction of the paper surface, depending on the position of the λ/4 retardation layer 13. Since such light is not completely absorbed by the absorption type linear polarizer 22, leaked light (ghost) is observed by the user of the virtual reality display apparatus 10.

On the other hand, the cholesteric liquid crystal layer usually does not have a phase difference. However, in the cholesteric liquid crystal layer, the amount of phase difference may vary locally due to the residual stress generated during the stretching in a case of being formed into a curved shape.

For example, in the virtual reality display apparatus 10 shown in FIG. 1, the reflective type circular polarizer 40 having a cholesteric liquid crystal layer and formed into a curved shape may reflect circularly polarized light including unintended circularly polarized light, such as elliptically polarized light, depending on the position of the reflective type circular polarizer 40. As a result, the amount of light unnecessarily transmitted through the reflective type circular polarizer 40 is increased, leading to an increase in the amount of light observed by the user of the virtual reality display apparatus 10 as light leakage (ghost).

On the other hand, the optically functional film according to the first embodiment is a film formed of a composition containing a liquid crystal compound having a polymerizable group, in which the polymerization rate of the liquid crystal compound having a polymerizable group is 40% or less.

The liquid crystal compound having a polymerizable group can be polymerized by irradiation with active energy rays and by heating, and an alignment direction of the liquid crystal compound can be fixed. However, by setting the polymerization rate to 40% or less, flexibility can be imparted to the optically functional film. Therefore, even in a case where the optically functional film according to the first embodiment is formed into a curved shape, the residual stress generated by stretching is reduced, so that, by using, in the optical member of the virtual reality display apparatus, a formed product obtained by forming the optical functionality film according to the first embodiment into a curved shape, it is possible to reduce the expression and change in (local) phase difference due to the forming into the curved shape in the optical member.

Accordingly, with the optically functional film according to the first embodiment, for example, in a case of being applied to a pancake lens-type virtual reality display apparatus, it is possible to display a virtual reality image having high image quality by reducing the light leakage.

The configuration of the virtual reality display apparatus manufactured using the optically functional film according to the first embodiment is not limited to the virtual reality display apparatus 10 shown in FIG. 1.

FIG. 2 conceptually shows another example of the virtual reality display apparatus according to the first embodiment.

In a virtual reality display apparatus 20 shown in FIG. 2, the same members as those of the virtual reality display apparatus 10 shown in FIG. 1 are frequently used. Therefore, in the following description, the same reference numerals are assigned to the same members, and the differences from the virtual reality display apparatus 10 shown in FIG. 1 will be mainly described.

The virtual reality display apparatus 20 shown in FIG. 2 includes, from the right side in the drawing, an image display device 72 consisting of an image display panel 70, λ/4 retardation layer 11, an absorption type linear polarizer 21, a λ/4 retardation layer 12, and an antireflection layer 50; a biconvex lens 92 with an optically functional layer, consisting of a half mirror 30, a lens base material 34, and a λ/4 retardation layer 14; and a plano-convex lens 82 with an optically functional layer, consisting of an antireflection layer 52, a reflective type linear polarizer 42, an absorption type linear polarizer 22, and a lens base material 36.

In the virtual reality display apparatus 20 shown in FIG. 2, each of the λ/4 retardation layer 14 and the absorption type linear polarizer 22 may be a film obtained by forming the optically functional film according to the first embodiment into a curved shape and performing a predetermined curing treatment.

In the biconvex lens 92 with an optically functional layer, the half mirror 30 is formed into a curved shape and bonded to one surface of the lens base material 34, and the λ/4 retardation layer 14 is formed into a curved shape and bonded to the other surface.

In addition, in the plano-convex lens 92 with an optically functional layer, the absorption type linear polarizer 22, the reflective type circular polarizer 42, and the antireflection layer 52 are each formed into a curved shape and bonded to the convex surface of the lens base material 36 in this order.

Same as the above-described antireflection layer 51, the antireflection layer 52 may be a known antireflection layer (AR coat) or a known antireflection film.

Even in the virtual reality display apparatus 20 shown in FIG. 2, the image emitted by the image display panel 70 is converted into levorotatory circularly polarized light by the λ/4 retardation layer 11 and emitted from the image display device 72, as in the virtual reality display apparatus 10 shown in FIG. 1.

Next, the levorotatory circularly polarized light transmitted through the antireflection layer 50 is incident on the half mirror 30, and half of the levorotatory circularly polarized light is transmitted. The levorotatory circularly polarized light transmitted through the half mirror 30 is transmitted through the lens base material 34 and is incident on the λ/4 retardation layer 14.

Here, the λ/4 retardation layer 14 is, as an example, a λ/4 retardation layer disposed to align a slow axis direction such that levorotatory circularly polarized light is converted into linearly polarized light in a direction perpendicular to the paper surface. Therefore, the levorotatory circularly polarized light incident on the λ/4 retardation layer 14 is converted into linearly polarized light in the direction perpendicular to the paper surface.

The λ/4 retardation layer 14 may be a reflective type circular polarizer which is obtained by forming the optically functional film according to the first embodiment, which contains a liquid crystal compound aligned in one direction, into a curved shape and performing a predetermined curing treatment.

The linearly polarized light in the direction perpendicular to the paper surface, which has been converted by the λ/4 retardation layer 14, is transmitted through the antireflection layer 52 and is incident on the reflective type linear polarizer 42.

The reflective type linear polarizer 42 is, as an example, a reflective type linear polarizer which reflects linearly polarized light in the direction perpendicular to the paper surface and transmits the linearly polarized light in the up-down direction of the paper surface. Therefore, the linearly polarized light in the direction perpendicular to the paper surface, which has been incident on the reflective type linear polarizer 42, is reflected by the reflective type linear polarizer 42 and is incident on the λ/4 retardation layer 14 again.

The λ/4 retardation layer 14 is a λ/4 retardation layer which converts levorotatory circularly polarized light into linearly polarized light in the direction perpendicular to the paper surface. Therefore, the linearly polarized light in the direction perpendicular to the paper surface, which has been incident on the λ/4 retardation layer 14, is converted into levorotatory circularly polarized light by the λ/4 retardation layer 14.

The levorotatory circularly polarized light converted by the λ/4 retardation layer 14 is incident on the half mirror 30 by transmitting through the lens base material 34, and half of the levorotatory circularly polarized light is reflected by the half mirror 30. By the reflection, the levorotatory circularly polarized light is converted into dextrorotatory circularly polarized light.

The dextrorotatory circularly polarized light reflected by the half mirror 30 is transmitted through the lens base material 34 and is incident on the λ/4 retardation layer 14. The λ/4 retardation layer 14 is a λ/4 retardation layer which converts levorotatory circularly polarized light into linearly polarized light in the direction perpendicular to the paper surface. Therefore, the dextrorotatory circularly polarized light is converted into linearly polarized light in the up-down direction of the paper surface by the λ/4 retardation layer 14, is transmitted through the antireflection layer 52, and is incident on the reflective type linear polarizer 42.

The reflective type linear polarizer 42 is a reflective type linear polarizer which reflects linearly polarized light in the direction perpendicular to the paper surface and transmits the linearly polarized light in the up-down direction of the paper surface. Therefore, the linearly polarized light in the up-down direction of the paper surface, which has been incident on the reflective type linear polarizer 42, is transmitted through the reflective type linear polarizer 42.

Next, the linearly polarized light in the up-down direction of the paper surface, which has been transmitted through the reflective type linear polarizer 42, is transmitted through the absorption type linear polarizer 22 in the up-down direction of the paper surface, and is observed by the user of the virtual reality display apparatus 20 as a virtual reality image.

The absorption type linear polarizer 22 is used for preventing light which is unnecessarily transmitted through the reflective type linear polarizer 42 from being leaked (ghost) and observed by the user of the virtual reality display apparatus 20 by shielding the light.

That is, in a case where the linearly polarized light in the direction perpendicular to the paper surface is first incident on the reflective type linear polarizer 42, there is also linearly polarized light in the direction perpendicular to the paper surface, which is not reflected by the reflective type linear polarizer 42 and is unnecessarily transmitted through the reflective type linear polarizer 42.

However, since the absorption type linear polarizer 22 which transmits the linearly polarized light in the up-down direction of the paper surface absorbs the linearly polarized light in the direction perpendicular to the paper surface, the linearly polarized light in the direction perpendicular to the paper surface is absorbed and does not leak, and thus the linearly polarized light in the direction perpendicular to the paper surface is not observed by the user.

Here, in the virtual reality display apparatus 20 shown in FIG. 2, as described above, the λ/4 retardation layer 14 which is a biconvex lens and is bonded to the convex surface of the lens base material 34 has residual stress due to stretching in a case of being formed into a curved shape, and a phase difference is expressed or changed by a photoelastic effect. In addition, in the forming of the curved shape, since a stretching ratio varies depending on the position, in the λ/4 retardation layer 14, the amount of expression or the amount of change of the phase difference may be locally different.

In this case, in the λ/4 retardation layer 14, the initially incident levorotatory circularly polarized light cannot be converted into appropriate the linearly polarized light, and is converted into light including, for example, elliptically polarized light. Some of such light is not reflected by the reflective type linear polarizer 42, but is transmitted through the reflective type linear polarizer 42 and the absorption type linear polarizer 22 and observed by the user of the virtual reality display apparatus 20 as leaked light (ghost).

On the other hand, by using, as the λ/4 retardation layer 14, a film obtained by forming the optically functional film according to the first embodiment, in which the polymerization rate of the liquid crystal compound is 40% or less, into a curved shape, as described above, it is possible to reduce the expression and change in (local) phase difference due to the forming into the curved shape in the optical member, and as a result, it is possible to display a virtual reality image having high image quality by reducing the light leakage.

Hereinafter, the optically functional film, the optical laminate, the formed product, the manufacturing method of an optical component, the optical component, and the virtual reality display apparatus according to the first embodiment will be described in detail.

The optically functional film according to the first embodiment is an optically functional film obtained by forming a composition which contains a liquid crystal compound having a polymerizable group, in which a polymerization rate of the liquid crystal compound having a polymerizable group is 40% or less. As described above, by setting the above-described polymerization rate of the liquid crystal compound to 40% or less, flexibility is imparted to the optically functional film, which reduces the residual stress generated in a case of being formed into a curved shape, and suppresses the expression and change in phase difference.

The polymerization rate of the liquid crystal compound in the optically functional film is preferably 20% or less and more preferably 10% or less. Furthermore, in a case where an unreacted liquid crystal compound is in a solid state at normal temperature, it is preferable that all the liquid crystal compounds are unreacted (that is, the polymerization rate is 0%). That is, the above-described polymerization rate may be 0%. In a case where the polymerization rate is 20% or less (more preferably 10% or less and still more preferably 0%), an alignment treatment of aligning the liquid crystal compound can be performed by forming the optically functional film into a curved shape and then heating the optically functional film. As a result, it is possible to further suppress the expression of the phase difference and the change in phase difference due to the forming into a curved shape.

In addition, in a case where an optically functional film formed of a polymer is used as an optically anisotropic layer, the optically functional film may break as it is formed into a curved shape with a small curvature radius, depending on the type of the polymer. Therefore, it is necessary to increase the curvature radius, which is considered as a constraint in the design of the lens, and there may be a case in which a lens with the optically functional layer, having a wide visual field, low chromatic aberration, low distortion, and excellent MTF, cannot be sufficiently obtained.

On the other hand, since the optically functional film according to the first embodiment, in which the polymerization rate of the liquid crystal compound is 40% or less (preferably 20% or less, more preferably 10% or less, and still more preferably 0%), has flexibility, it is possible to suppress the breakage of the optically functional film even in a case of being formed into a three-dimensional shape including a curved surface with a relatively small curvature radius. As a result, it is possible to manufacture a lens with an optically functional layer, having improved degree of freedom, a wide visual field, low chromatic aberration, low distortion, and excellent MTF.

Furthermore, the cholesteric liquid crystal layer and the reflective type polarizer such as the reflective type linear polarizer may be stretched, causing a reflection wavelength band to shift to the short wavelength side. Due to the short wavelength shift, in the pancake lens, there may be a case in which a part of a wavelength range of rays emitted from the image display device cannot be appropriately reflected or transmitted. In this case, a part of the rays is leaked light, leading to double images and a decrease in contrast, and the tint of the image changes.

On the other hand, in the optically functional film according to the first embodiment, in which the polymerization rate of the liquid crystal compound is 40% or less (preferably 20% or less, more preferably 10% or less, and still more preferably 0%), an alignment treatment of aligning the liquid crystal compound can be performed by forming the optically functional film into a curved shape and then heating the optically functional film. In the alignment treatment, a helical pitch of the cholesteric liquid crystal layer changes to a helical pitch determined by the amount of the chiral agent, thereby suppressing the occurrence of the short wavelength shift due to the forming into a curved shape. As a result, inappropriate reflection and transmission of rays in a part of the wavelength range can be suppressed, and the light leakage and the change in tint of the image can be suppressed.

The composition used for forming the optically functional film according to the first embodiment contains at least a liquid crystal compound having a polymerizable group.

As the liquid crystal compound having a polymerizable group, either a rod-like liquid crystal compound having a polymerizable group or a disk-like liquid crystal compound having a polymerizable group can be used.

As described above, the optically functional film in which the liquid crystal compound is aligned in one direction can be used as a retardation film (retardation layer). In a case where the optically functional film is a retardation film, for example, a retardation film having reverse dispersibility can also be produced by uniformly aligning and immobilizing a rod-like liquid crystal compound having reverse dispersibility, for example, with reference to JP2020-084070A. Here, the expression “having reverse dispersibility” denotes that as the wavelength increases, the value of the phase difference at the wavelength increases. In a case where the optically functional film is a λ/4 plate (λ/4 retardation layer), it is preferable that the optically functional film has a phase difference of approximately ¼ wavelength at any of wavelengths in the visible range.

In addition, as described above, the optically functional film may be an absorption type linear polarizer. The optically functional film which is an absorption type linear polarizer can be produced, for example, by forming a coating film using a composition containing a liquid crystal compound and a dichroic substance, and aligning the liquid crystal compound and the dichroic substance in one direction.

In addition, as described above, the optically functional film may be a reflective type circular polarizer consisting of a cholesteric liquid crystal layer containing a helically aligned liquid crystal compound. The cholesteric liquid crystal layer can be produced, for example, by forming a coating film using a composition containing a liquid crystal compound and a chiral agent, and performing a heat treatment to induce helical alignment.

It is preferable that the heat treatment for helical alignment is performed after the forming into a curved shape. As a result, it is possible to suppress the change in in-plane helical pitch due to the forming into a curved shape and to make the in-plane helical pitch uniform.

As is well known, the cholesteric liquid crystal layer has a helical structure in which the liquid crystal compound is helically turned and laminated. In the helical structure, a configuration in which the liquid crystal compound is helically rotated once (rotated by 360°) and laminated is set as single helical period (the helical period), and the helically turned liquid crystal compounds are laminated a plurality of periods.

The cholesteric liquid crystal layer reflects levorotatory circularly polarized light or dextrorotatory circularly polarized light in a specific wavelength range and allows the transmission of the other light depending on the length of the helical period and the helical turning direction (sense) of the liquid crystal compound.

Therefore, in a case where the virtual reality display apparatus displays a color image, the cholesteric liquid crystal layer may include, for example, a plurality of cholesteric liquid crystal layers including a cholesteric liquid crystal layer that has a central wavelength of selective reflection for red light, a cholesteric liquid crystal layer that has a central wavelength of selective reflection for yellow light, a cholesteric liquid crystal layer that has a central wavelength of selective reflection for green light, and a cholesteric liquid crystal layer that has a central wavelength of selective reflection for blue light.

### (Composition)

Hereinafter, the composition used for forming the optically functional film according to the first embodiment (hereinafter, also referred to as “present composition”) will be described in more detail.

The liquid crystal compound having a polymerizable group, contained in the present composition, may be a rod-like liquid crystal compound or a disk-like liquid crystal compound.

The liquid crystal compound having a polymerizable group may be of a low-molecular-weight type or a high-molecular-weight type. Here, the term “high-molecular-weight” refers to a compound having a degree of polymerization of 100 or more (Polymer Physics-Phase Transition Dynamics, written by Masao Doi, p. 2, published by Iwanami Shoten, 1992).

As the liquid crystal compound, a rod-like liquid crystal compound is preferably used. In addition, the present composition may contain two or more types of liquid crystal compounds. The combination of two or more types of liquid crystal compounds may be a combination of two or more kinds of rod-like liquid crystal compounds, a combination of two or more kinds of disk-like liquid crystal compounds, or a combination of one or more kinds of rod-like liquid crystal compounds and one or more kinds of disk-like liquid crystal compounds.

The above-described liquid crystal compound preferably has two or more polymerizable groups in one molecule. In a case where the present composition contains two or more types of liquid crystal compounds, it is preferable that at least one liquid crystal compound has two or more polymerizable groups in one molecule.

In the present specification, even in a case where a liquid crystal compound is immobilized by polymerization to be a compound which does not exhibit liquid crystallinity in the optically functional film, the compound is referred to as a liquid crystal compound for convenience.

The type of the polymerizable group included in the liquid crystal compound is not particularly limited, and examples thereof include radically polymerizable groups and cationically polymerizable groups.

Examples of the radically polymerizable group include a (meth)acryloyl group, a (meth)acryloyloxy group, a vinyl group, a styryl group, and an allyl group. Here, the (meth)acryloyl group is a notation meaning a methacryloyl group or an acryloyl group; and the (meth)acryloyloxy group is a notation meaning a methacryloyloxy group or an acryloyloxy group. Examples of the cationically polymerizable group include an epoxy group and an oxetane group.

As the polymerizable group included in the liquid crystal compound, a radically polymerizable group is preferable, and a (meth)acryloyl group is more preferable.

Examples of the rod-like liquid crystal compound having a polymerizable group include liquid crystal compounds described in JP1999-513019A (JP-H11-513019A) and paragraphs [0026] to [0098] of JP2005-289980A. In addition, examples of the disk-like liquid crystal compound having a polymerizable group include liquid crystal compounds described in paragraphs [0020] to [0067] of JP2007-108732A and paragraphs [0013] to [0108] of JP2010-244038A. These descriptions are incorporated into the present specification.

The present composition may contain a dichroic substance. By using the present composition containing the liquid crystal compound and the dichroic substance, it is possible to form an absorption type linear polarizer as the optically functional film according to the first embodiment.

The dichroic substance is not particularly limited, and examples thereof include known dichroic substances (dichroic coloring agents) such as a visible light absorbing substance (dichroic coloring agent), an ultraviolet absorbing substance, an infrared absorbing substance, a nonlinear optical substance, a carbon nanotube, and an inorganic substance (for example, a quantum rod).

From the viewpoint that the decrease in degree of polarization during stretching and forming is suppressed, it is preferable that the dichroic substance has a crosslinkable group. Examples of the crosslinkable group include a (meth)acryloyl group, an epoxy group, an oxetanyl group, and a styryl group.

The present composition may contain a chiral agent.

By using the present composition containing the liquid crystal compound and the chiral agent, it is possible to form a reflective type circular polarizer consisting of a cholesteric liquid crystal layer, as the optically functional film according to the first embodiment.

The chiral agent is a compound for adjusting a helical period of the cholesteric liquid crystal compound, and a known chiral agent (for example, chiral agents described in “Liquid Crystal Device Handbook, chapter 3, section 4-3, chiral agents for TN and STN, page 199, Japan Society for the Promotion of Science edited by the 142nd committee, 1989”) can be used.

The chiral agent may have a polymerizable group. The polymerizable group included in the chiral agent is preferably the same type of group as the polymerizable group included in the liquid crystal compound. In addition, the chiral agent may be a liquid crystal compound.

It is preferable that the present composition contains a polymerization initiator.

The polymerization initiator is not particularly limited, but a photopolymerization initiator is preferable.

As the photopolymerization initiator, a known compound can be used. Examples of the photopolymerization initiator include α-carbonyl compounds (U.S. Pat. Nos. 2,367,661A and 2,367,670A), acyloin ether (U.S. Pat. No. 2,448,828A), α-hydrocarbon-substituted aromatic acyloin compounds (U.S. Pat. No. 2,722,512A), polynuclear quinone compounds (U.S. Pat. Nos. 3,046,127A and 2,951,758A), a combination of a triarylimidazole dimer and a p-aminophenyl ketone (U.S. Pat. No. 3,549,367A), acridine and phenazine compounds (JP1985-105667A (JP-S60-105667A) and U.S. Pat. No. 4,239,850A), oxadiazole compounds (U.S. Pat. No. 4,212,970A), o-acyloxime compounds ([0065] of JP2016-27384A), and acylphosphine oxide compounds (JP1988-40799B (JP-S63-40799B), JP1993-29234B (JP-H5-29234B), JP1998-95788A (JP-H10-95788A), and JP1998-29997A (JP-H10-29997A)).

In a case where the present composition contains a polymerization initiator, a content of the polymerization initiator is preferably 0.01 to 30 parts by mass with respect to 100 parts by mass of the total of the liquid crystal compound and the dichroic substance in the present composition described above.

From the viewpoint of workability and the like, it is preferable that the present composition contains a solvent.

As the solvent, a known solvent used for forming the optically functional film can be used, and examples thereof include ketones, ethers, and amides.

In a case where the present composition contains a solvent, a content of the solvent is preferably 80% to 99% by mass with respect to the total mass of the present composition.

### (Method of Forming Optically Functional Film)

A method of forming the optically functional film according to the first embodiment is not particularly limited as long as the polymerization rate of the liquid crystal compound in the formed film does not exceed 40%. Examples of the method of forming the optically functional film according to the first embodiment include a method including a coating film forming step of applying the present composition onto an alignment layer to form a coating film, and an alignment step of aligning the liquid crystal compound in the coating film, in which a curing step of curing a part of the liquid crystal compound may be performed as necessary.

The coating film forming step is a step of forming a coating film on an alignment layer using the present composition.

By using the above-described present composition containing a solvent or using a molten product obtained by heating the present composition, it is easy to apply the present composition onto the alignment layer.

Specific examples of a method of applying the present composition include known methods such as a roll coating method, a gravure printing method, a spin coating method, a wire bar coating method, an extrusion coating method, a direct gravure coating method, a reverse gravure coating method, a die-coating method, a spraying method, and an ink jet method.

As the alignment layer, a known alignment layer (alignment film) having a function of aligning the liquid crystal compound on the alignment layer can be used. Examples of the alignment layer include a rubbing-treated alignment layer formed by performing a rubbing treatment on a surface of a resin substrate, and a photoalignment layer formed by performing light irradiation on a film formed of a composition containing a radically polymerizable compound.

The above-described alignment layer may be in a state of being laminated on the optically functional film, or may be peeled off from the optically functional film at any stage.

The alignment step is a step of aligning the liquid crystal compound contained in the coating film. As a result, the optically functional film is obtained.

The alignment step may include a drying treatment. Components such as a solvent can be removed from the coating film by performing the drying treatment. The drying treatment may be performed by a method of allowing the coating film to stand at room temperature for a predetermined time (for example, natural drying) or a method of heating the coating film and/or blowing air to the coating film.

The liquid crystal compound contained in the present composition may be aligned by the above-described coating film forming step or the drying treatment. For example, in an aspect in which the present composition is prepared as a coating liquid containing a solvent, the optically functional film is obtained by drying the coating film to remove the solvent from the coating film.

In a case where the drying treatment is performed at a temperature higher than or equal to a transition temperature of the liquid crystal component contained in the coating film to the liquid crystal phase, a heat treatment described below may not be performed.

From the viewpoint of manufacturing suitability or the like, the transition temperature of the liquid crystal compound contained in the coating film to the liquid crystal phase is preferably 10° C. to 250° C. and more preferably 25° C. to 190° C. In a case where the above-described transition temperature is 10° C. or higher, a cooling treatment or the like for lowering the temperature to a temperature range in which the liquid crystal phase is exhibited is not necessary, which is preferable. In addition, in a case where the above-described transition temperature is 250° C. or lower, a high temperature is not required even in a case of setting an isotropic liquid state at a temperature higher than the temperature range in which the liquid crystal phase is temporarily exhibited, and waste of thermal energy and deformation and deterioration of a substrate can be reduced, which is preferable.

It is preferable that the alignment step includes a heat treatment. In this manner, since the liquid crystal compound contained in the coating film can be aligned, the coating film after the heat treatment can be suitably used as the optically functional film.

From the viewpoint of manufacturing suitability or the like, the heat treatment is performed at a temperature of preferably 10° C. to 250° C. and more preferably 25° C. to 190° C. In addition, a heating time is preferably 1 to 300 seconds and more preferably 1 to 60 seconds.

In the present embodiment, examples of a method of aligning the liquid crystal component contained in the coating film include the drying treatment and the heat treatment, but the present invention is not limited thereto and the liquid crystal component can be aligned by a known alignment treatment.

After the above-described alignment step, a curing step of curing the optically functional film in a range in which the polymerization rate of the liquid crystal compound does not exceed 40% may be performed.

The curing step is performed by, for example, heating the film and/or irradiating (exposing) the optically functional film with light. Among these, it is preferable that the curing step is performed by irradiating the optically functional film with light.

Examples of the light which can be used for the curing include various light such as infrared rays, visible light, and ultraviolet rays, and ultraviolet rays are preferable. In addition, ultraviolet rays may be applied while the film is heated during curing, or ultraviolet rays may be applied through a filter which transmits only a specific wavelength.

In a case where light irradiation is performed while heating, a heating temperature during the light irradiation depends on the transition temperature of the liquid crystal compound to a liquid crystal phase, but is preferably 25° C. to 140° C.

### <Optical Laminate>

The optical laminate according to the first embodiment includes the above-described optically functional film and a substrate film.

The substrate film is preferably a substrate film consisting of a resin having a peak temperature of tan δ (loss tangent (loss coefficient)) of 170° C. or lower. In addition, the optically functional film may include a plurality of laminated layers.

Examples of the resin having a peak temperature of tan δ of 170° C. or lower include polyacrylate and polymethacrylate, cyclic polyolefin, and polyolefin.

From the viewpoint of facilitating the forming of the optical laminate into a curved shape, the peak temperature of tan δ of the resin constituting the substrate film is preferably 150° C. or lower, more preferably 130° C. or lower, and still more preferably 120° C. or lower. Examples of the resin having a peak temperature of tan δ of 120° C. or lower include polyacrylate and polymethacrylate. The lower limit value thereof is not particularly limited, but may be 60° C. or higher.

Here, a method of measuring tan δ will be described.

E″ (loss elastic modulus) and E′ (storage elastic modulus) of a film sample which has been humidity-adjusted in advance in an atmosphere of a temperature of 25° C. and a humidity of 60% Rh for 2 hours or longer are measured under the following conditions using a dynamic viscoelasticity measuring device (DVA-200, manufactured by IT Measurement & Control Co., Ltd.), and the values are used to acquire tan δ (=E″/E′).
Device: DVA-200, manufactured by IT Measurement & Control Co., Ltd.
Sample: 5 mm, length of 50 mm (gap of 20 mm)
Measurement conditions: tension mode
Measurement temperature: −150° C. to 220° C.
Heating conditions: 5° C./min
Frequency: 1 Hz

Typically in optical applications, a resin base material subjected to a stretching treatment is frequently used, and the tan δ peak temperature is frequently increased due to the stretching treatment. For example, with a triacetyl cellulose (TAC) substrate (for example, TG40 manufactured by FUJIFILM Corporation), the peak temperature of tan δ is 180° C. or higher.

A thickness of the substrate film is not particularly limited, and is preferably 5 to 300 μm, more preferably 5 to 100 μm, and still more preferably 5 to 30 μm.

The optical laminate according to the first embodiment may include a layer other than the optically functional film and the substrate film. Examples of other layers include an alignment layer and an adhesive layer.

Examples of the alignment layer include the above-described alignment layers.

The optical laminate may include the adhesive layer between the optically functional film and the substrate film, or adjacent to the optically functional film or the substrate film. An adhesive contained in the adhesive layer is not particularly limited as long as it exhibits adhesiveness by drying and reaction after bonding. Examples of the adhesive include a polyvinyl alcohol-based adhesive (PVA-based adhesive) which exhibits adhesiveness by drying, and a curable adhesive which exhibits adhesiveness by reaction. Examples of the curable adhesive include an active energy ray-curable adhesive such as a (meth)acrylate-based adhesive, and a cationic polymerization-curable adhesive having an epoxy group or an oxetanyl group.

### <Formed Product>

The formed product according to the first embodiment is a member obtained by forming, into a three-dimensional shape including a curved surface, the above-described optically functional film or an optical laminate including the above-described optically functional film and a substrate film.

The formed product according to the first embodiment is, for example, a formed product in which the optically functional film or the optical laminate (preferably the optical laminate including a substrate film consisting of a resin having a peak temperature of tan δ of 170° C. or lower) is laminated onto a surface of a forming substrate. The optically functional film or the optical laminate of the formed product has at least a curved surface part.

Examples of a methods of forming the optically functional film or the optical laminate into a curved shape include thermal forming and vacuum forming. More specific examples thereof include insert molding as described in JP2004-322501A; and vacuum molding, injection molding, blow molding, decompression coating molding, in-mold transfer, and mold pressing as described in WO2010/001867A and JP2012-116094A.

In a case where the optically functional film or the optical laminate is forming into a curved shape, it is also preferable to perform a heat treatment. A temperature of the heat treatment is preferably 80° C. to 170° C., more preferably 100° C. to 150° C., and still more preferably 110° C. to 140° C.

The forming substrate used for the forming of the formed product is not particularly limited, but in a case where the formed product having the forming substrate is used as an optical component, the forming substrate is preferably made of a transparent member. Examples of the transparent member include glass, an acrylic resin, and a polyolefin-based resin. In addition, in a case of being used as an optical member for a pancake lens, it is preferable that the forming substrate does not have phase difference.

### <Manufacturing Method of Optical Component>

The optical component according to the first embodiment is obtained by performing a curing treatment on the formed product according to the first embodiment.

The curing treatment is performed by, for example, heating the film and/or irradiating (exposing) the formed product with light. Examples of the light which can be used for the curing include various light such as infrared rays, visible light, and ultraviolet rays, and ultraviolet rays are preferable. In addition, ultraviolet rays may be applied while the film is heated during curing, or ultraviolet rays may be applied through a filter which transmits only a specific wavelength.

As a manufacturing method of the optical component according to the first embodiment, it is preferable that at least one curing treatment selected from the group consisting of a heat treatment and an ultraviolet irradiation is performed on the formed product according to the first embodiment, in which the curing step is performed such that the polymerization rate of the liquid crystal compound in the optically functional film is to be 50% or more. By performing the curing treatment after lamination in a curved shape, the alignment direction of the liquid crystal compound can be fixed.

From the viewpoint of durability, the polymerization rate of the liquid crystal compound in the optically functional film included in the optical component after the curing treatment is preferably 60% or more, and more preferably 70% or more. The upper limit thereof is not particularly limited, and may be 100%.

In a case where the curing treatment is performed by heating and light irradiation, a heating temperature during the light irradiation depends on the transition temperature of the liquid crystal compound to a liquid crystal phase, but is preferably 25° C. to 140° C.; and a heating time is preferably 0.1 to 60 seconds. In addition, in a case where the curing treatment is performed only by heating, a heating temperature is preferably 100° C. to 140° C., and a heating time is preferably more than 5 minutes and 30 minutes or less.

The manufacturing method of the optical component according to the first embodiment may further include, before the above-described curing step, an alignment step of heating the formed product to align the liquid crystal compound contained in the optically functional film, and it is preferable to include the alignment step. In a case where the polymerization rate of the liquid crystal compound is sufficiently low, the liquid crystal compound can be aligned by the alignment step of heating the optically functional film. By performing the alignment step on the formed product and then performing the above-described curing step (preferably, curing step by irradiation with ultraviolet rays), the liquid crystal compound can be immobilized in any alignment state even after being formed into a curved shape.

A heating temperature in the alignment step is, for example, 10° C. to 250° C., preferably 25° C. to 190° C. In addition, a heating time is, for example, 1 to 300 seconds, preferably 1 to 60 seconds.

In the alignment step, in order to set the liquid crystal compound to a desired alignment state, it is preferable that the formed product has an alignment layer adjacent to the optically functional film. Examples of the alignment layer include the above-described alignment layers, and among these, a photoalignment layer can be suitably used.

In addition, in a case where the optically functional film is a cholesteric liquid crystal layer, it is preferable to add a chiral agent to the present composition containing the liquid crystal compound having a polymerizable group.

### (Optical Component)

The optical component according to the first embodiment is obtained by the manufacturing method of the optical component according to the first embodiment. That is, the optical component according to the first embodiment is a member obtained by performing the above-described curing treatment on the formed product according to the first embodiment.

In a case where the optical component according to the first embodiment is used in a pancake lens-type virtual reality display apparatus, it is possible to manufacture an optical component designed to have an appropriate shape with a curved surface, so that a wide field of view, low chromatic aberration, low distortion, and excellent MTF can be obtained.

### <Virtual Reality Display Apparatus>

The virtual reality display apparatus according to the first embodiment includes at least an image display device which emits polarized light, and the optical component according to the first embodiment. The virtual reality display apparatus may include additional optical members such as a half mirror and a visual acuity adjustment lens, in addition to the image display device and the optical component.

As the image display device which emits polarized light, a known image display device can be used, and examples thereof include a display device in which self-luminous microscopic light emitters are arranged on a transparent substrate, such as an organic electroluminescent display device (Organic Light Emitting Diode; OLED), a light emitting diode (LED) display device, and a micro LED display device. In these self-luminous display devices, a (circular) polarizing plate is usually bonded to a display surface to prevent reflection on the display surface. Therefore, the emitted light is polarized. In addition, a liquid crystal display device is exemplified as other image display devices. Since the liquid crystal display device also has a polarizing plate on the surface, the emitted light is polarized.

<Optical film>

The optical film according to the second embodiment of the present invention has a non-planar shape.

The non-planar shape means a shape other than a planar shape, and examples thereof include a curved shape.

The above-described curved shape means a shape having a curvature of more than 0, and includes a curved shape which is a developable surface and a three-dimensional curved shape. The developable surface is a surface which is developable onto a plane without stretching or contracting any part of the surface.

Examples of the curved shape which is a developable surface include surfaces corresponding to a cylindrical peripheral surface, an elliptical cylindrical peripheral surface, a conical peripheral surface, an elliptical conical peripheral surface, and the like; and the curved shape may be a convex curved surface or a concave curved surface. The three-dimensional curved shape is a curved surface which cannot be produced by deformation of a plane, that is, a curved surface which is not developable, and examples thereof include surfaces corresponding to a spherical surface, a rotational ellipsoid surface, and surfaces where the cross-section forms a parabola or hyperbola (for example, a rotational paraboloid surface). The three-dimensional curved shape may be a convex curved surface or a concave curved surface.

The curved shape is preferably lens-like. Examples of the lens-like curved shape include a spherical surface shape and a rotational ellipsoid surface shape; and the lens-like curved shape may be a convex lens-like shape or a concave lens-like shape.

The non-planar shape of the optical film is preferably a spherical shape, a rotational ellipsoid shape, or a rotational paraboloid shape.

The optical film has a non-planar shape as described above, and exhibits a predetermined curvature radius. That is, a portion of the non-planar shape of the optical film (non-planar shaped portion, preferably, curved shape portion) exhibits a predetermined curvature radius.

The curvature radius is 30 to 1,000 mm, and from the viewpoint that the occurrence of light leakage is further suppressed in a case where the optical film according to the second embodiment of the present invention is applied to a pancake lens-type virtual reality display apparatus (hereinafter, also simply referred to as “viewpoint that the effect of the present invention is more excellent”), it is preferably 30 to 100 mm.

The curvature radius may be constant or may vary at any position of the optical film.

An in-plane variation of a phase difference of the optical film is less than 5%. Among these, from the viewpoint that the effect of the present invention is more excellent, the in-plane variation of the phase difference is preferably less than 3%, and more preferably less than 1%. The lower limit thereof is not particularly limited, but may be, for example, 0%.

The in-plane variation of the phase difference of the optical film described above is calculated by the following method. In the present specification, the following method is also referred to as “specific method 1”. The in-plane variation of the phase difference is calculated using a measured value of an in-plane retardation at a wavelength of 550 nm at each position of the optical film.

First, the optical film is viewed in a plan view from a normal direction of an emission surface of an image display panel in a case where the optical film is applied to a virtual reality display apparatus, and an intersection between an axis extending in the normal direction and the optical film in the plan view, passing through a center of the emission surface, is defined as a center of the optical film.

Next, in a projection image obtained by planarly viewing the optical film, a straight line passing through the center and extending in one direction in the in-plane direction is defined as a first straight line; a straight line passing through the center and obtained by rotating the first straight line clockwise by 45° is defined as a second straight line; a straight line passing through the center and obtained by rotating the second straight line clockwise by 45° is defined as a third straight line; and a straight line passing through the center and obtained by rotating the third straight line clockwise by 45° is defined as a fourth straight line.

Next, a circle centered at the center of the optical film is drawn in the projection image obtained by planarly viewing the optical film. In this case, an inscribed circle having the largest radius is defined as a first circle, and a circle having a radius half the radius of the first circle is defined as a second circle.

Next, an in-plane retardation at the position of the optical film corresponding to the center of the optical film in the plan view, an in-plane retardation at the position of the optical film corresponding to two intersection points of the first straight line and the first circle, an in-plane retardation at the position of the optical film corresponding to two intersection points of the first straight line and the second circle, an in-plane retardation at the position of the optical film corresponding to two intersection points of the second straight line and the first circle, an in-plane retardation at the position of the optical film corresponding to two intersection points of the second straight line and the second circle, an in-plane retardation at the position of the optical film corresponding to two intersection points of the third straight line and the first circle, an in-plane retardation at the position of the optical film corresponding to two intersection points of the third straight line and the second circle, an in-plane retardation at the position of the optical film corresponding to two intersection points of the fourth straight line and the first circle, and an in-plane retardation at the position of the optical film corresponding to two intersection points of the fourth straight line and the second circle are each measured. The position of the optical film corresponding to the center of the optical film in the plan view is the position of the axis extending in the normal direction of the projection image through the center position in the projection image obtained by the plan view of the optical film, which corresponds to an intersection point with the optical film. That is, the position of the center in the projection image is reflected in the position of the optical film to calculate the in-plane retardations at the position of the optical film. In addition, the position of the optical film corresponding to the above-described intersection point is the position of the axis extending in the normal direction of the projection image through the intersection position selected in the projection image obtained by the plan view of the optical film, which corresponds to an intersection point with the optical film. That is, the position of the intersection point in the projection image is reflected in the position of the optical film to calculate the in-plane retardations at the position of the optical film. The in-plane retardations of the optical film at 17 locations are measured according to the above-described procedure.

Next, among the obtained measured values, the maximum value, minimum value, and average value are determined, and the in-plane variation (%) of the phase difference is calculated using the following expression.

$$\begin{matrix}Expression & \\ In - plane variation ( \% ) = \{ ( Maximum value - Minimum value ) / Average value \} \times 100 & \end{matrix}$$

A shape of an outer peripheral end of the optical film according to the second embodiment of the present invention is not particularly limited, and for example, a perfect circular shape, an elliptical shape, or an irregular shape is used.

The shape of the outer peripheral end described above refers to a shape of an outer peripheral end of the optical film in a case where the optical film is observed from the normal direction of the emission surface of the image display panel in the case where the optical film is applied to a virtual reality display apparatus.

An in-plane variation of a film thickness of the optical film according to the second embodiment of the present invention is not particularly limited, but from the viewpoint that the effect of the present invention is more excellent, it is preferably less than 5% and more preferably less than 3%. The lower limit thereof is not particularly limited, but may be, for example, 0%.

As a method of measuring the above-described in-plane variation of the film thickness, film thicknesses are measured at the 17 locations where the in-plane retardations are measured to calculate the above-described in-plane variation of the phase difference. Next, among the obtained measured values, the maximum value, minimum value, and average value are determined, and the in-plane variation (%) of the film thickness is calculated using the following expression.

$$\begin{matrix}Expression & \\ In - plane variation ( \% ) = \{ ( Maximum value - Minimum value ) / Average value \} \times 100 & \end{matrix}$$

The film thickness at each location is measured by cutting the optical film with a microtome to expose a cross section and observing the cross section with a scanning electron microscope (SEM) at an appropriate magnification (20,000 to 50,000 times) to obtain the film thickness of the optical film.

In order to easily observe the cross section, the measurement sample may be subjected to appropriate treatment such as carbon vapor deposition and etching. An acceleration voltage is preferably optimized under a condition of 1 to 10 kV.

In the present specification, the above-described method of measuring the in-plane variation of the film thickness is also referred to as “specific method 2”.

As the optical film according to the second embodiment of the present invention, for example, a retardation film, a cholesteric liquid crystal layer, a polarizer, a reflective type polarizer, an antireflection film, a transparent film, or a laminated optical body obtained by combining some of these members may be used.

That is, the optical film according to the second embodiment of the present invention may be a monolayer structured film or a multilayer structured film. For example, the optical film according to the second embodiment of the present invention may be composed of only the retardation film, or the optical film according to the second embodiment of the present invention may be a laminated optical body composed of the retardation film and the reflective type polarizer.

It is preferable that the optical film according to the second embodiment of the present invention includes at least a retardation film. That is, the optical film according to the second embodiment of the present invention is preferably composed of a single layer of a retardation film, or is preferably a laminated optical body including a retardation film.

Hereinafter, first, the retardation film will be described in detail.

### <Retardation Film (Hereinafter, Also Referred to as “Retardation Layer”)>

The retardation layer has a function of converting emitted light into substantially linearly polarized light in a case where circularly polarized light is incident. For example, a retardation layer in which Re is approximately ¼ wavelength at any of wavelengths in the visible range can be used, and an in-plane retardation Re (550) at a wavelength of 550 nm is preferably 120 nm to 150 nm, more preferably 125 nm to 145 nm, and still more preferably 135 nm to 140 nm.

In addition, a retardation layer in which the Re is an approximately ¾ wavelength or approximately 5/4 wavelength is also preferable from the viewpoint that the linearly polarized light can be converted into the circularly polarized light.

In addition, it is preferable that the retardation layer has reverse dispersibility with respect to the wavelength. It is preferable that the retardation layer has reverse dispersibility from the viewpoint that circularly polarized light can be converted into linearly polarized light over a wide wavelength range in the visible region. Here, the expression “having reverse dispersibility with respect to the wavelength” denotes that as the wavelength increases, the value of the phase difference at the wavelength increases.

The retardation layer having reverse dispersibility can be prepared, for example, by uniaxially stretching a polymer film such as a modified polycarbonate resin film having reverse dispersibility with reference to JP2017-049574A and the like.

In addition, the retardation layer having reverse dispersibility is not limited as long as the retardation layer substantially has reverse dispersibility, and can be prepared by laminating a retardation layer having Re of an approximately ¼ wavelength and a retardation layer having Re of an approximately ½ wavelength such that the slow axes form an angle of approximately 600 as described in, for example, JP06259925B. Here, it is known that even in a case where the ¼ wavelength retardation layer and the ½ wavelength retardation layer each have forward dispersibility (as the wavelength increases, the value of the phase difference at the wavelength decreases), circularly polarized light can be converted into linearly polarized light over a wide wavelength range in the visible region, and the layers can be regarded as having substantially reverse dispersibility.

In addition, it is also preferable that the retardation layer has a layer formed by immobilizing uniformly aligned liquid crystal compounds. For example, a layer formed by uniformly aligning rod-like liquid crystal compounds horizontally to the in-plane direction or a layer formed by uniformly aligning disk-like liquid crystal compounds vertically to the in-plane direction can be used. Furthermore, for example, a retardation layer having reverse dispersibility can be prepared by uniformly aligning rod-like liquid crystal compounds having reverse dispersibility and immobilizing the compounds with reference to JP2020-084070A and the like.

In addition, it is also preferable that the retardation layer body has a layer formed by immobilizing twistedly aligned liquid crystal compounds with a helical axis in the thickness direction. For example, as described in JP5753922B and JP5960743B, it is preferable that a retardation layer having a layer formed by immobilizing twistedly aligned rod-like liquid crystal compounds or twistedly aligned disk-like liquid crystal compounds with a helical axis in the thickness direction is used from the viewpoint that the retardation layer can be regarded as having substantially reverse dispersibility.

A thickness of the retardation layer is not particularly limited, but from the viewpoint of thinning, it is preferably 0.1 to 8 μm and more preferably 0.3 to 5 μm.

In addition, it is preferable that the retardation layer is transparent to near-infrared light in order to minimize the influence on various sensors incorporated in optical systems such as a virtual reality display apparatus and an electronic finder, in which near-infrared light for eye tracking, facial expression recognition, and iris recognition is used as a light source.

### <Laminated Optical Body>

One aspect of the laminated optical body includes at least a cholesteric liquid crystal layer and a retardation layer which converts circularly polarized light into linearly polarized light or converts linearly polarized light into circularly polarized light.

One aspect of the laminated optical body includes, in the following order, at least a cholesteric liquid crystal layer, a retardation layer which converts circularly polarized light into linearly polarized light or converts linearly polarized light into circularly polarized light, and a linear polarizer.

One aspect of the laminated optical body includes at least a linear polarization type reflective polarizer and a retardation layer which converts circularly polarized light into linearly polarized light or converts linearly polarized light into circularly polarized light.

One aspect of the laminated optical body includes, in the following order, at least a retardation layer which converts circularly polarized light into linearly polarized light or converts linearly polarized light into circularly polarized light, a linear polarization type reflective polarizer, and a linear polarizer.

The retardation layer included in the laminated optical body is as described above.

Hereinafter, other members which can be included in the laminated optical body will be described in detail.

### [Cholesteric Liquid Crystal Layer]

The cholesteric liquid crystal layer is an optical member which separates incidence ray into right-circularly polarized light and left-circularly polarized light, and specularly reflects one circularly polarized light and transmits the other circularly polarized light. For example, a cholesteric liquid crystal layer obtained by immobilizing a cholesteric liquid crystalline phase can be used, as described in JP2020-060627A. The film obtained by immobilizing a cholesteric liquid crystalline phase is preferable due to a thin film and its high degree of polarization of transmitted light. From the viewpoint that a decrease in degree of polarization and/or a distortion of a polarization axis is suppressed in a case of being stretched or formed into a three-dimensional shape, the cholesteric liquid crystal layer is preferably used as a film for curved surface forming. In addition, a decrease in degree of polarization due to the distortion of the polarization axis is unlikely to occur.

It is preferable that the cholesteric liquid crystal layer includes a blue light reflecting layer in which a reflectivity at a wavelength of at least 460 nm is 40% or more, a green light reflecting layer in which a reflectivity at a wavelength of 550 nm is 40% or more, a yellow light reflecting layer in which a reflectivity at a wavelength of 600 nm is 40% or more, and a red light reflecting layer in which a reflectivity at a wavelength of 650 nm is 40% or more. With such a configuration, high reflection characteristics can be exhibited over a wide wavelength range in the visible region, which is preferable. The above-described reflectivity is a reflectivity in a case where non-polarized light is incident on the cholesteric liquid crystal layer at each wavelength.

In addition, the blue light reflecting layer, the green light reflecting layer, the yellow light reflecting layer, and the red light reflecting layer, which are formed by immobilizing the cholesteric liquid crystalline phase, may have a pitch gradient layer in which the helical pitch of the cholesteric liquid crystalline phase continuously changes in the thickness direction. For example, the green light reflecting layer and the yellow light reflecting layer can be continuously produced with reference to JP2020-060627A and the like.

In addition, it is also preferable that the cholesteric liquid crystal layer includes a light reflecting layer formed by immobilizing a cholesteric liquid crystalline phase containing a rod-like liquid crystal compound, and a light reflecting layer formed by immobilizing a cholesteric liquid crystalline phase containing a disk-like liquid crystal compound. In such a configuration, since the cholesteric liquid crystalline phase containing a rod-like liquid crystal compound has a positive Rth and the cholesteric liquid crystalline phase containing a disk-like liquid crystal compound has a negative Rth, the Rth of each other is offset, and thus the occurrence of the ghost can be suppressed even for the light incident from the oblique direction, which is preferable.

The state in which the Rth is offset is represented by an expression as follows. In an optical laminated film including n light reflecting layers, in a case where the light reflecting layers are named L1, L2, L3, . . . , and Ln from a light source side, the sum of Rth's of each layer from the light reflecting layer L1 to the light reflecting layer Li is denoted by SRthi. Specifically, the expression is as follows.

$$SRth 1 = Rth 1$$

$$SRth 2 = Rth 1 + Rth 2$$

$$…$$

$$SRthi = Rth 1 + Rth 2 … + Rthi$$

$$…$$

$$SRthn = Rth 1 + Rth 2 … + Rthi … + Rthn$$

Absolute values of all of SRthi (SRth1 to SRthn) are preferably 0.3 μm or less, more preferably 0.2 μm or less, and still more preferably 0.1 μm or less. The Rthi of each layer in the above-described expression is determined by the expression for calculating Rth described above.

A thickness of the cholesteric liquid crystal layer is not particularly limited, but from the viewpoint of thinning, it is preferably 30 μm or less and more preferably 15 μm or less.

In addition, in a case where the cholesteric liquid crystal layer is stretched or formed, the reflection wavelength range of the cholesteric liquid crystal layer may shift, and thus it is preferable that the reflection wavelength range is selected in advance, considering a potential shift in wavelength. For example, in a case where an optical film obtained by immobilizing a cholesteric liquid crystalline phase is used as the cholesteric liquid crystal layer, the film extends by being stretched or formed and thus a helical pitch of the cholesteric liquid crystalline phase may be reduced. Therefore, it is preferable that the helical pitch of the cholesteric liquid crystalline phase is set to be large in advance. In addition, it is also preferable that the cholesteric liquid crystal layer includes an infrared light reflecting layer having a reflectivity of 40% or more at a wavelength of 800 nm, in consideration of the short wavelength shift of the reflection wavelength range due to the stretching or the forming.

Furthermore, in a case where a stretching ratio during the stretching or the forming is not uniform in a plane, an appropriate reflection wavelength range may be selected at each location in the plane according to the wavelength shift caused by the stretching. That is, regions with different reflection wavelength ranges may be present in the plane. In addition, it is also preferable that the reflection wavelength range is set wider than the required wavelength range in advance in consideration that the stretching ratios at the respective locations in the plane are different from each other.

### (Method of Manufacturing Cholesteric Liquid Crystal Layer)

The cholesteric liquid crystal layer can be formed according to the following procedure of: applying a liquid crystal composition, which is obtained by dissolving a liquid crystal compound, a chiral agent, a polymerization initiator, a surfactant added as necessary, and the like in a solvent, onto a support or an underlayer formed on the support; drying the liquid crystal composition to obtain a coating film; aligning the liquid crystal compound in the coating film; and irradiating the coating film with actinic ray to cure the liquid crystal composition. As a result, a cholesteric liquid crystal layer having a cholesteric liquid crystal structure in which the cholesteric regularity is fixed can be formed.

### [Applying Method]

Examples of a method of applying the liquid crystal composition include known methods such as a roll coating method, a gravure printing method, a spin coating method, a wire bar coating method, an extrusion coating method, a direct gravure coating method, a reverse gravure coating method, a die-coating method, a spraying method, and an ink jet method.

### [Method of Imparting In-Plane Distribution to Helical Pitch]

In a method of imparting the in-plane distribution to the helical pitch of the cholesteric liquid crystal layer, for example, there is a method of using a chiral agent in which HTP is changed by photoisomerization.

The details thereof will be described. By performing light irradiation corresponding to photoisomerization on the cholesteric liquid crystal layer which is obtained by applying the liquid crystal composition containing a chiral agent, in which the HTP changes due to the photoisomerization, and aligning (and optionally, subsequently heating) the liquid crystal compound, the HTP of the chiral agent is changed, and as a result, the helical pitch of the cholesteric liquid crystal layer changes, allowing the reflection wavelength to be changed. By utilizing this property, the aligned cholesteric liquid crystal layer is irradiated with light in a patterned manner using an exposure mask or the like to be photoisomerized, thereby obtaining a pattern in which the reflection wavelength is changed only in the light-irradiated region. After obtaining the pattern, the entire cholesteric liquid crystal layer is exposed to light for curing the liquid crystal composition, and the liquid crystal composition is polymerized, thereby finally obtaining a cholesteric liquid crystal layer (patterned cholesteric liquid crystal layer) having a helical pitch with an in-plane distribution. The patterned cholesteric liquid crystal layer after the curing no longer undergoes photoisomerization and has stable properties.

In order to effectively perform the pattern formation, it is preferable that the light irradiation for the photoisomerization and the light irradiation for the curing can be separated, in other words, one of the photoisomerization and the curing does not proceed as much as possible in a case where the other proceeds. Examples of a method for separating the two include separation by oxygen concentration and separation by exposure wavelength.

First, with regard to the oxygen concentration, the photoisomerization is less affected by the oxygen concentration, but the curing is less likely to occur as the oxygen concentration is higher (depending on an initiator to be used). Therefore, it is easy to perform the photoisomerization separately from the curing, by performing the photoisomerization under a condition of a high oxygen concentration, for example, in the atmosphere, and by performing the curing under a condition of a low oxygen concentration, for example, in a nitrogen atmosphere with an oxygen concentration of 300 ppm by volume or less.

In addition, with regard to the exposure wavelength, the photoisomerization by a chiral agent is likely to proceed at an absorption wavelength of the chiral agent, and the curing is likely to proceed at an absorption wavelength of the photopolymerization initiator. Therefore, in a case where the chiral agent and the photopolymerization initiator are selected such that the absorption wavelengths thereof are different from each other, it is possible to separate the photoisomerization and the curing by the exposure wavelength.

One or both of the photoisomerization and the curing may be performed under heating, as necessary. A temperature at the time of heating is preferably 25° C. to 140° C. and more preferably 30° C. to 100° C.

As another method of using the chiral agent in which the HTP is changed by the photoisomerization, there is also a method in which curing is performed in a patterned manner first and then isomerization of an uncured region is performed. That is, the aligned cholesteric liquid crystalline phase is first irradiated with light for curing in a patterned manner using an exposure mask or the like. Thereafter, by performing light irradiation for the photoisomerization on the entire surface, (since the pitch change due to the photoisomerization is unlikely to occur in the region which has been cured first), the pitch change due to the photoisomerization occurs only in the region which has not been cured first, and the reflection wavelength is changed. In this case as well, after obtaining the pattern, the entire cholesteric liquid crystal layer is exposed to light for curing the liquid crystal composition, and the liquid crystal composition is polymerized, thereby finally obtaining the patterned cholesteric liquid crystal layer.

### [Direct Application of Each Layer]

It is preferable that adjacent layers are directly formed without an adhesive layer between each light reflecting layer of the cholesteric liquid crystal layer. In a case of forming a layer, the adhesive layer can be eliminated by directly coating an adjacent layer which has already been formed. Furthermore, in order to reduce the difference in refractive index in all in-plane directions, it is preferable that alignment directions (slow axis directions) of the liquid crystal compound are arranged to continuously change at the interface. For example, in a case where a light reflecting layer formed of a rod-like liquid crystal compound is formed on a light reflecting layer formed of a disk-like liquid crystal compound, the light reflecting layer formed of a rod-like liquid crystal compound can be formed by directly applying a coating liquid containing the rod-like liquid crystal compound, and the rod-like liquid crystal compound can be aligned such that the slow axis direction continuously changes at the interface by an alignment regulating force of the disk-like liquid crystal compound in the light reflecting layer formed of a disk-like liquid crystal compound.

### [Method of Bonding Each Layer]

It is preferable that the cholesteric liquid crystal layer is a laminate consisting of a plurality of light reflecting layers. Each layer can be also bonded by an optional adhesion method, and for example, a pressure sensitive adhesive or an adhesive can be used.

As the pressure sensitive adhesive, a commercially available pressure sensitive adhesive can be optionally used. Among these, from the viewpoint of thinning and viewpoint of reducing the surface roughness Ra of the laminated optical body, a thickness of the pressure-sensitive adhesive layer is preferably 25 μm or less, more preferably 15 μm or less, and most preferably 6 μm or less. In addition, a pressure sensitive adhesive which is unlikely to generate outgas is preferable as the pressure sensitive adhesive. In particular, in a case of performing stretching or forming, a vacuum process or a heating process may be performed, and it is preferable that no outgas is generated even under such conditions.

A commercially available adhesive can be optionally used as the adhesive, and for example, an epoxy resin-based adhesive or an acrylic resin-based adhesive can be used.

From the viewpoint of thinning and viewpoint of reducing the surface roughness Ra of the cholesteric liquid crystal layer, a thickness of the adhesive layer is preferably 25 μm or less, more preferably 5 μm or less, and most preferably 1 μm or less. In addition, from the viewpoint of reducing the thickness of the adhesive layer and coating an adherend with the adhesive at a uniform thickness, a viscosity of the adhesive is preferably 300 cP or less and more preferably 100 cP or less.

In addition, in a case where the adherend has surface unevenness, from the viewpoint of reducing the surface roughness Ra of the cholesteric liquid crystal layer, an appropriate viscoelasticity or an appropriate thickness of the pressure sensitive adhesive and the adhesive can also be selected so that the surface unevenness of the layer to be bonded can be embedded. From the viewpoint of embedding the surface unevenness, it is preferable that the pressure sensitive adhesive and the adhesive have a viscosity of 50 cP or more. In addition, it is preferable that the thickness thereof is more than a height of the surface unevenness.

Examples of a method of adjusting the viscosity of the adhesive include a method of using an adhesive containing a solvent. In this case, the viscosity of the adhesive can be adjusted by a proportion of the solvent. In addition, the thickness of the adhesive can be further reduced by drying the solvent after coating the adherend with the adhesive.

In the cholesteric liquid crystal layer, from the viewpoint of reducing the extra reflection and suppressing a decrease in degree of polarization of transmitted light, it is preferable that the pressure sensitive adhesive or the adhesive used for adhering each layer has a small difference in refractive index with adjacent layers. Since the liquid crystal layer has birefringence, a refractive index in the fast axis direction and a refractive index in the slow axis direction are different from each other. In a case where an average refractive index nₐᵥₑ of a liquid crystal layer is calculated by adding the refractive indices in the fast axis direction and the slow axis direction and dividing the sum by 2, a difference between a refractive index of the adjacent pressure-sensitive adhesive layer or adhesive layer and the nₐᵥₑ is preferably 0.075 or less, more preferably 0.05 or less, and still more preferably 0.025 or less. The refractive index of the pressure sensitive adhesive or the adhesive can be adjusted, for example, by mixing fine particles of titanium oxide, fine particles of zirconia, or the like.

In addition, the cholesteric liquid crystal layer, the retardation layer, and the linear polarizer have in-plane refractive index anisotropy, but the difference in refractive index with the adjacent layer is preferably 0.10 or less in all in-plane directions. Therefore, the pressure sensitive adhesive and the adhesive may have in-plane refractive index anisotropy.

In addition, a refractive index adjusting layer, in which the difference between the refractive index in the fast axis direction and the refractive index in the slow axis direction is smaller than that of the cholesteric liquid crystal layer, may be provided between the cholesteric liquid crystal layer and the adhesive or between the cholesteric liquid crystal layer and the pressure sensitive adhesive. In this case, the refractive index adjusting layer has a cholesteric liquid crystal. By providing the refractive index adjusting layer, interfacial reflection can be further suppressed, and the occurrence of the ghost can be further suppressed. In addition, it is preferable that an average refractive index of the refractive index adjusting layer is smaller than the average refractive index of the cholesteric liquid crystal layer. In addition, a central wavelength of reflected light of the refractive index adjusting layer may be less than 430 nm or more than 670 nm, and is more preferably less than 430 nm.

In addition, in the adhesive layer between the layers, it is also preferable that a thickness of the adhesive layer is 100 nm or less. In a case where the thickness of the adhesive layer is 100 nm or less, light in the visible region is less likely to be affected by the difference in refractive index, and extra reflection can be suppressed. The thickness of the adhesive layer is more preferably 50 nm or less and still more preferably 30 nm or less. Examples of a method of forming the adhesive layer having a thickness of 100 nm or less include a method of vapor-depositing a ceramic adhesive such as silicon oxide (SiOx layer) on the bonding surface. For the bonding surface of the bonding member, before the bonding, for example, a surface reforming treatment such as a plasma treatment, a corona treatment, and a saponification treatment can be performed, and a primer layer can be applied. In addition, in a case where a plurality of bonding surfaces are present, the kind and thickness of the adhesive layer can be adjusted for each of the bonding surfaces. Specifically, for example, the adhesive layer having a thickness of 100 nm or less can be provided by the procedures (1) to (3) described below.

(1) A layer to laminate is bonded to a temporary support consisting of a glass base material.

(2) An SiOx layer having a thickness of 100 nm or less is formed on both the surface of the layer to laminate and the surface of the layer to be laminated by vapor deposition or the like; the vapor deposition can be carried out by, for example, a vapor deposition device (model number ULEYES, manufactured by ULVAC, Inc.) using SiOx powder as a vapor deposition source; in addition, it is preferable that the surface of the formed SiOx layer is subjected to a plasma treatment.

(3) After the formed SiOx layers are bonded to each other, the temporary support is peeled off; it is preferable that the bonding is carried out, for example, at a temperature of 120° C.

The application, the adhesion, or the bonding of the layers may be carried out by roll-to-roll or single-wafer.

The roll-to-roll method is preferable from the viewpoint of improving the productivity and reducing axis misalignment of each layer.

Meanwhile, the single-wafer method is preferable from the viewpoints that this method is suitable for production of many kinds in small quantities and that a special adhesion method in which the thickness of the adhesive layer is 100 nm or less can be selected.

In addition, examples of the method of coating the adherend with the adhesive include known methods such as a roll coating method, a gravure printing method, a spin coating method, a wire bar coating method, an extrusion coating method, a direct gravure coating method, a reverse gravure coating method, a die-coating method, a spraying method, and an ink jet method.

In addition, it is preferable that the cholesteric liquid crystal layer is transparent to near-infrared light in order to minimize the influence on various sensors incorporated in optical systems such as a virtual reality display apparatus and an electronic finder, in which near-infrared light for eye tracking, facial expression recognition, and iris recognition is used as a light source.

### <Linear Polarizer>

The linear polarizer is an absorption type polarizer, and absorbs linearly polarized light in an absorption axis direction among incidence rays and transmits linearly polarized light in a transmission axis direction. A typical polarizer can be used as the linear polarizer, and for example, a polarizer in which a dichroic substance is dyed on polyvinyl alcohol or another polymer resin and is stretched so that the dichroic substance is aligned may be used, or a polarizer in which a dichroic substance is aligned by using alignment of a liquid crystal compound may be used. Among these, from the viewpoint of availability and an increase in degree of polarization, a polarizer obtained by dyeing polyvinyl alcohol with iodine and stretching polyvinyl alcohol is preferable.

A thickness of the linear polarizer is preferably 10 μm or less, more preferably 7 μm or less, and still more preferably 5 μm or less. In a case where the linear polarizer is thin, cracks or breakage of the film can be prevented in a case where the laminated optical body is stretched or formed.

In addition, a single plate transmittance of the linear polarizer is preferably 40% or more and more preferably 42% or more. Moreover, the degree of polarization is preferably 90% or more, more preferably 95% or more, and still more preferably 99% or more. In the present invention, the single plate transmittance and the degree of polarization of the linear polarizer are measured using an automatic polarizing film measuring device: VAP-7070 (manufactured by Jasco Corporation).

In addition, it is preferable that the direction of the transmission axis of the linear polarizer coincides with the direction of the polarization axis of light converted into linearly polarized light by the retardation layer. For example, in a case where the retardation layer is a layer having a phase difference of a ¼ wavelength, an angle between the transmission axis of the linear polarizer and the slow axis of the retardation layer is preferably approximately 450.

It is also preferable that the linear polarizer is a light absorption anisotropic layer containing a liquid crystal compound and a dichroic substance. The linear polarizer containing a liquid crystal compound and a dichroic substance is preferable from the viewpoint that the thickness thereof can be reduced and cracks or breakage is unlikely to occur even in a case of being stretched or formed. A thickness of the light absorption anisotropic layer is not particularly limited, but from the viewpoint of thinning, it is preferably 0.1 to 8 μm and more preferably 0.3 to 5 μm.

The linear polarizer containing a liquid crystal compound and a dichroic substance can be produced with reference to, for example, JP2020-023153A.

From the viewpoint of improving the degree of polarization of the linear polarizer, an alignment degree of the dichroic substance in the light absorption anisotropic layer is preferably 0.95 or more and more preferably 0.97 or more.

In addition, it is preferable that the linear polarizer is transparent to near-infrared light in order to minimize the influence on various sensors incorporated in optical systems such as a virtual reality display apparatus and an electronic finder, in which near-infrared light for eye tracking, facial expression recognition, and iris recognition is used as a light source.

### <Other Functional Layers>

The laminated optical body may include other functional layers, in addition to the cholesteric liquid crystal layer, the retardation layer, and the linear polarizer described above.

In addition, it is preferable that the other functional layers are transparent to near-infrared light in order to minimize the influence on various sensors incorporated in optical systems such as a virtual reality display apparatus and an electronic finder, in which near-infrared light for eye tracking, facial expression recognition, and iris recognition is used as a light source.

### <Positive C-Plate>

It is also preferable that the laminated optical body further includes a positive C-plate. Here, the positive C-plate is a retardation layer in which the Re is substantially zero and the Rth has a negative value. The positive C-plate can be obtained, for example, by vertically aligning rod-like liquid crystal compounds. With regard to the details of the method for manufacturing the positive C-plate, reference can be made to the description in, for example, JP2017-187732A, JP2016-053709A, and JP2015-200861A.

The positive C-plate functions as an optical compensation layer for increasing the degree of polarization of the transmitted light with respect to light incident obliquely. A plurality of the positive C-plates may be provided at any position of the laminated optical body.

The positive C-plate may be provided adjacent to the cholesteric liquid crystal layer or inside the cholesteric liquid crystal layer. For example, in a case where a light reflecting layer containing a rod-like liquid crystal compound, which is formed by immobilizing a cholesteric liquid crystalline phase, is used as the cholesteric liquid crystal layer, the light reflecting layer has a positive Rth. Here, in a case where light is incident on the cholesteric liquid crystal layer in an oblique direction, the polarization states of the reflected light and the transmitted light may change due to the action of the Rth, and the degree of polarization of the transmitted light may decrease. In a case where the positive C-plate is provided inside the cholesteric liquid crystal layer and/or in the vicinity thereof, the change in polarization state of the oblique incident light is suppressed and the decrease in degree of polarization of the transmitted light can be suppressed, which is preferable. It is preferable that the positive C-plate is disposed on a surface of the blue light reflecting layer on a side opposite to the green light reflecting layer, but the positive C-plate may be disposed at another place. Re of the positive C-plate in this case is preferably approximately 10 nm or less, and Rth thereof is preferably −600 to −100 nm and more preferably −400 to −200 nm.

In addition, the positive C-plate may be provided adjacent to the retardation layer or inside the retardation layer. For example, in a case where a layer formed by immobilizing a rod-like liquid crystal compound is used as the retardation layer, the retardation layer has a positive Rth. Here, in a case where light is incident on the retardation layer in an oblique direction, the polarization state of the transmitted light may change due to the action of the Rth, and the degree of polarization of the transmitted light may decrease. In a case where the positive C-plate is provided inside the retardation layer and/or in the vicinity thereof, the change in polarization state of the oblique incident light is suppressed and the decrease in degree of polarization of the transmitted light can be suppressed, which is preferable. It is preferable that the positive C-plate is disposed on a surface of the retardation layer on a side opposite to the linear polarizer, but the positive C-plate may be disposed at another place. Re of the positive C-plate in this case is preferably approximately 10 nm or less, and Rth thereof is preferably −90 to −40 nm.

### <Antireflection Layer>

It is also preferable that the laminated optical body includes an antireflection layer on a surface thereof. The laminated optical body has a function of reflecting specific circularly polarized light and transmitting circularly polarized light orthogonal to the specific circularly polarized light, and the reflection on a surface of the laminated optical body typically includes unintended reflection of polarized light, which leads to the decrease in degree of polarization of the transmitted light. Therefore, it is preferable that the laminated optical body includes an antireflection layer on the surface thereof. The antireflection layer may be provided only on one surface or on both surfaces of the laminated optical body.

The type of the antireflection layer is not particularly limited, but from the viewpoint of further decreasing the reflectivity, a moth-eye film or an AR film is preferable. In addition, in a case where the laminated optical body is stretched or formed, the moth-eye film is preferable from the viewpoint that high antireflection performance can be maintained even in a case of fluctuation in the film thickness due to the stretching. Furthermore, in a case where the antireflection layer includes a support and stretching or molding is performed, from the viewpoint of facilitating the stretching or the molding, the above-described support has a Tg peak temperature of preferably 170° C. or lower and more preferably 130° C. or lower. Specifically, for example, a PMMA film or the like is preferable.

### <Second Retardation Layer>

It is also preferable that the laminated optical body further includes a second retardation layer, in addition to the above-described retardation layer. For example, the laminated optical body may include the cholesteric liquid crystal layer, the retardation layer, the linear polarizer, and a second retardation layer in this order.

It is preferable that the second retardation layer converts linearly polarized light into circularly polarized light, and for example, a retardation layer having Re of a ¼ wavelength is preferable. The reason for this will be described below.

Light which has been incident on the laminated optical body from the side of the cholesteric liquid crystal layer and transmitted through the cholesteric liquid crystal layer, the retardation layer, and the linear polarizer is converted into linearly polarized light, and a part of the light is reflected on the outermost surface on the side of the linear polarizer and emitted from the surface on the side of the cholesteric liquid crystal layer again. Such light is extra reflected light and may decrease the degree of polarization of the reflected light, and thus it is preferable that the amount of such light is reduced. Therefore, a method of laminating an antireflection layer may be considered to suppress reflection on the outermost surface on the side of the linear polarizer, but in a case where the laminated optical body is used by being bonded to a medium such as glass and plastic, the antireflection effect cannot be obtained because reflection on the surface of the medium cannot be suppressed even in a case where the antireflection layer is provided on the bonding surface of the laminated optical body.

Meanwhile, in a case where the second retardation layer which converts linearly polarized light into circularly polarized light is provided, light which reaches the outermost surface on the side of the linear polarizer is converted into circularly polarized light, and converted into circularly polarized light orthogonal to each other in a case of reflection on the outermost surface of the medium. Thereafter, in a case where the light is transmitted through the second retardation layer again and reaches the linear polarizer, the light is converted into linearly polarized light in the absorption axis azimuth of the linear polarizer and absorbed by the linear polarizer. Therefore, it is possible to prevent extra reflection.

From the viewpoint of more effectively suppressing the extra reflection, it is preferable that the second retardation layer has substantially reverse dispersibility.

### <Support>

The laminated optical body may further include a support. The support can be provided at any position, and for example, in a case where the cholesteric liquid crystal layer, the retardation layer, or the linear polarizer is a film used by being transferred from the temporary support, the support can be used as a transfer destination thereof.

The type of the support is not particularly limited, but it is preferable that the support is transparent, and examples thereof include films made of cellulose acylate, polycarbonate, polysulfone, polyethersulfone, polyacrylate and polymethacrylate, cyclic polyolefin, polyolefin, polyamide, polystyrene, polyester, or the like. Among these, a cellulose acylate film, a cyclic polyolefin film, polyacrylate, a polyacrylate film, or a polymethacrylate film is preferable. In addition, commercially available cellulose acetate films (for example, “TD80U” or “Z-TAC” manufactured by FUJIFILM Corporation) can also be used.

In addition, it is preferable that the support has a small phase difference from the viewpoint of suppressing the adverse effect on the degree of polarization of the transmitted light and viewpoint of facilitating the optical inspection of the laminated optical body. Specifically, a magnitude of Re is preferably 10 nm or less, and an absolute value of a magnitude of Rth is preferably 50 nm or less.

In a case where the laminated optical body is stretched or formed, it is preferable that the support has a tan δ peak temperature of 170° C. or lower. From the viewpoint that the laminated optical body can be formed at a low temperature, the peak temperature of tan δ is preferably 150° C. or lower and more preferably 130° C. or lower.

Here, a method of measuring tan δ will be described. E″ (loss elastic modulus) and E′ (storage elastic modulus) of a film sample which has been humidity-adjusted in advance in an atmosphere of a temperature of 25° C. and a humidity of 60% Rh for 2 hours or longer are measured under the following conditions using a dynamic viscoelasticity measuring device (DVA-200, manufactured by IT Measurement & Control Co., Ltd.), and the values are used to acquire tan δ (=E″/E′).
Device: DVA-200, manufactured by IT Measurement & Control Co., Ltd.
Sample: 5 mm, length of 50 mm (gap of 20 mm)
Measurement conditions: tension mode
Measurement temperature: −150° C. to 220° C.
Heating conditions: 5° C./min
Frequency: 1 Hz

Typically in optical applications, a resin base material subjected to a stretching treatment is frequently used, and the tan δ peak temperature is frequently increased due to the stretching treatment. For example, with a triacetyl cellulose (TAC) base material (TG40 manufactured by FUJIFILM Corporation), the peak temperature of tan δ is 180° C. or higher.

The support having a tan δ peak temperature of 170° C. or lower is not particularly limited, and various resin base materials can be used. Examples thereof include polyolefin such as polyethylene, polypropylene, and a norbornene-based polymer; a cyclic olefin-based resin; polyvinyl alcohol; polyethylene terephthalate; an acrylic resin such as polymethacrylic acid ester and polyacrylic acid ester; polyethylene naphthalate; polycarbonate; polysulfone; polyethersulfone; polyetherketone; polyphenylene sulfide, and polyphenylene oxide. Among these, from the viewpoint of being easily available from the market and having excellent transparency, a cyclic olefin-based resin, polyethylene terephthalate, or an acrylic resin is preferable, and a cyclic olefin-based resin or polymethacrylic acid ester is particularly preferable.

Examples of commercially available resin base materials include TECHNOLLOY S001G, TECHNOLLOY S014G, TECHNOLLOY S000, TECHNOLLOY C001, and TECHNOLLOY C000 (manufactured by Sumika Acryl Co., Ltd.), LUMIRROR U type, LUMIRROR FX10, and LUMIRROR SF20 (Toray Industries, Inc.), HK-53A (Higashiyama Film Co., Ltd.), TEFLEX FT3 (TOYOBO CO., LTD.), ESCENA and SCA40 (Sekisui Chemical Co., Ltd.), ZEONOR Film (ZEON CORPORATION), and an Arton Film (JSR Corporation).

A thickness of the support is not particularly limited, and is preferably 5 to 300 μm, more preferably 5 to 100 μm, and still more preferably 5 to 30 μm.

### <Method of Bonding Each Layer>

The laminated optical body is a laminate consisting of a plurality of layers. Each layer can be bonded by an optional adhesion method, and for example, a pressure sensitive adhesive or an adhesive can be used.

As the pressure sensitive adhesive, a commercially available pressure sensitive adhesive can be optionally used. From the viewpoint of thinning and viewpoint of reducing the surface roughness Ra of the laminated optical body, a thickness of the pressure-sensitive adhesive layer is preferably 25 μm or less, more preferably 15 μm or less, and still more preferably 6 μm or less. In addition, a pressure sensitive adhesive which is unlikely to generate outgas is preferable as the pressure sensitive adhesive. In particular, in a case of performing stretching or forming, a vacuum process or a heating process may be performed, and it is preferable that no outgas is generated even under such conditions.

A commercially available adhesive can be optionally used as the adhesive, and for example, an epoxy resin-based adhesive or an acrylic resin-based adhesive can be used.

From the viewpoint of thinning and viewpoint of reducing the surface roughness Ra of the laminated optical body, a thickness of the adhesive layer is preferably 25 μm or less, more preferably 5 μm or less, and still more preferably 1 μm or less. In addition, from the viewpoint of reducing the thickness of the adhesive layer and coating an adherend with the adhesive at a uniform thickness, a viscosity of the adhesive is preferably 300 cP or less, more preferably 100 cP or less, and still more preferably 10 cP or less.

In addition, in a case where the adherend has surface unevenness, from the viewpoint of reducing the surface roughness Ra of the laminated optical body, an appropriate viscoelasticity or an appropriate thickness of the pressure sensitive adhesive and the adhesive can also be selected so that the surface unevenness of the layer to be bonded can be embedded. From the viewpoint of embedding the surface unevenness, it is preferable that the pressure sensitive adhesive and the adhesive have a viscosity of 50 cP or more. In addition, it is preferable that the thickness thereof is more than a height of the surface unevenness.

Examples of a method of adjusting the viscosity of the adhesive include a method of using an adhesive containing a solvent. In this case, the viscosity of the adhesive can be adjusted by a proportion of the solvent. In addition, the thickness of the adhesive can be further reduced by drying the solvent after coating the adherend with the adhesive.

In the laminated optical body, from the viewpoint of reducing the extra reflection and suppressing a decrease in degree of polarizations of transmitted light and reflected light, it is preferable that the pressure sensitive adhesive or adhesive used for adhering each layer has a small difference in refractive index with adjacent layers. Specifically, the difference in refractive index with the adjacent layer is preferably 0.1 or less, more preferably 0.05 or less, and still more preferably 0.01 or less. The refractive index of the pressure sensitive adhesive or the adhesive can be adjusted, for example, by mixing fine particles of titanium oxide, fine particles of zirconia, or the like.

In addition, the cholesteric liquid crystal layer, the retardation layer, and the linear polarizer have in-plane refractive index anisotropy, but the difference in refractive index with the adjacent layer is preferably 0.05 or less in all in-plane directions. Therefore, the pressure sensitive adhesive or the adhesive may have in-plane refractive index anisotropy.

In addition, in the adhesive layer between the layers, it is also preferable that a thickness of the adhesive layer is 100 nm or less. In a case where the thickness of the adhesive layer is 100 nm or less, light in the visible region is less likely to be affected by the difference in refractive index, and extra reflection can be suppressed. The thickness of the adhesive layer is more preferably 50 nm or less. Examples of a method of forming the adhesive layer having a thickness of 100 nm or less include a method of vapor-depositing a ceramic adhesive such as silicon oxide (SiOx layer) on the bonding surface. For the bonding surface of the bonding member, before the bonding, for example, a surface reforming treatment such as a plasma treatment, a corona treatment, and a saponification treatment can be performed, and a primer layer can be applied. In addition, in a case where a plurality of bonding surfaces are present, the kind and thickness of the adhesive layer can be adjusted for each of the bonding surfaces. Specifically, for example, the adhesive layer having a thickness of 100 nm or less can be provided by the procedures (1) to (3) described below.

(1) A layer to laminate is bonded to a temporary support consisting of a glass base material.

(2) An SiOx layer having a thickness of 100 nm or less is formed on both the surface of the layer to laminate and the surface of the layer to be laminated by vapor deposition or the like; the vapor deposition can be carried out by, for example, a vapor deposition device (model number ULEYES, manufactured by ULVAC, Inc.) using SiOx powder as a vapor deposition source; in addition, it is preferable that the surface of the formed SiOx layer is subjected to a plasma treatment.

(3) After the formed SiOx layers are bonded to each other, the temporary support is peeled off; it is preferable that the bonding is carried out, for example, at a temperature of 120° C.

The application, the adhesion, or the bonding of the layers may be carried out by roll-to-roll or single-wafer. The roll-to-roll method is preferable from the viewpoint of improving the productivity and reducing axis misalignment of each layer.

Meanwhile, the single-wafer method is preferable from the viewpoints that this method is suitable for production of many kinds in small quantities and that a special adhesion method in which the thickness of the adhesive layer is 100 nm or less can be selected.

In addition, examples of the method of coating the adherend with the adhesive include known methods such as a roll coating method, a gravure printing method, a spin coating method, a wire bar coating method, an extrusion coating method, a direct gravure coating method, a reverse gravure coating method, a die-coating method, a spraying method, and an ink jet method.

### <Direct Application of Each Layer>

It is also preferable that the laminated optical body does not include the adhesive layer between the layers. In a case of forming a layer, the adhesive layer can be eliminated by directly coating an adjacent layer which has already been formed. Furthermore, in a case where one or both adjacent layers are layers containing a liquid crystal compound, it is preferable that the alignment direction of the liquid crystal compound is continuously changed at the interface in order to reduce the difference in refractive index in all in-plane directions. For example, the linear polarizer containing a liquid crystal compound and a dichroic substance is directly coated a retardation layer containing a liquid crystal compound, and the liquid crystal compound of the retardation layer can be aligned so as to align the liquid crystal compound continuously at the interface by alignment regulating force of the liquid crystal compound of the linear polarizer.

### <Lamination Order of Each Layer>

The laminated optical body consists of a plurality of layers, and the order of the steps of laminating the plurality of layers is not particularly limited and can be optionally selected.

For example, in a case where a functional layer is transferred from a film consisting of a temporary support and a functional layer, wrinkles or cracks during the transfer can be prevented by adjusting the laminating order such that the thickness of the film at the transfer destination reaches 10 μm or more.

In addition, from the viewpoint of reducing the surface roughness Ra of the laminated optical body, in a case where another layer is laminated on a layer having large surface unevenness, the surface unevenness may be further amplified, and thus it is preferable that the layers are laminated in order from a layer having a smaller surface roughness Ra.

In addition, from the viewpoint of quality evaluation in the step of producing the laminated optical body, the laminating order can also be selected. For example, layers excluding the cholesteric liquid crystal layer are laminated, the quality evaluation is performed using a transmission optical system, the cholesteric liquid crystal layer is laminated thereon, and the quality evaluation is performed using a reflection optical system.

In addition, from the viewpoint of improving the production yield of the laminated optical body and reducing the cost, it is also possible to select the laminating order.

As suitable usage examples of the retardation film used in the second embodiment of the present invention, the laminated optical body including the same, and the composite lens including the same, a virtual reality display apparatus using a laminated optical body will be described with the function of the laminated optical body.

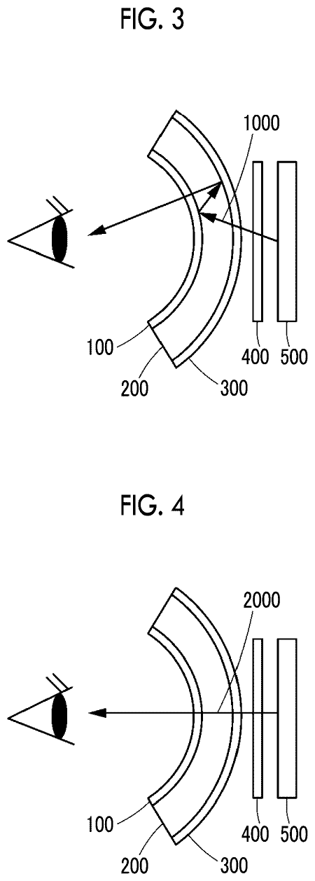

FIG. 3 is a virtual reality display apparatus using a laminated optical body. As shown in FIG. 3, a ray 1000 emitted from the image display panel 500 is transmitted through the circularly polarizing plate 400 to be converted into circularly polarized light, and is transmitted through the half mirror 300. Next, the ray is transmitted through a lens 200, is incident on and reflected by a laminated optical body 100, is transmitted through the lens 200 again, is reflected by a half mirror 300, and is incident on the laminated optical body 100 again after being transmitted through the lens 200. In this case, a circularly polarized state of the ray 1000 is not changed in a case of being reflected by the laminated optical body 100, and is changed to circularly polarized light orthogonal to circularly polarized light which is reflected by the half mirror in a case of being incident on the laminated optical body 100. Therefore, the ray 1000 is transmitted through the laminated optical body 100 and visually recognized by a user. In addition, in a case where the ray 1000 is reflected by the half mirror 300, since the half mirror has a concave mirror shape, the image is magnified so that the user can visually recognize the magnified virtual image. The system described above is referred to as a reciprocating optical system, a folded optical system, or the like.

On the other hand, FIG. 4 is a schematic view showing a case in which a ray 2000 is incident on the laminated optical body 100 for the first time, is transmitted without being reflected to be a leaked light. As can be seen from the drawing, in this case, the user visually recognizes the image which is not enlarged. This image is referred to as the ghost or the like, and the ghost or the like is required to be reduced.

Since the laminated optical body 100 satisfies the requirements of the second embodiment of the present invention, leakage of transmitted light (that is, the ghost) in a case where the ray is incident on the laminated optical body 100 for the first time can be reduced.

In addition, since the laminated optical body 100 satisfies the requirements of the second embodiment of the present invention, it is possible to increase the transmittance in a case where the ray is incidence on the laminated optical body 100 for the second time, and it is possible to improve brightness of the virtual image and further suppress tint of the virtual image.

As shown in FIGS. 3 and 4, the laminated optical body 100 may be formed on a curved surface of a lens or the like. As a result, it is possible to suppress field curvature and improve pupil swim. In addition, effects such as chromatic aberration reduction and enlargement of visual angle of view can be obtained.

For example, in the laminated optical body obtained by laminating the reflective type circular polarizer and the retardation layer having a phase difference of ¼ wavelength, since the cholesteric liquid crystal layer does not have an optical axis, a decrease in degree of polarization due to stretching or molding is unlikely to occur.

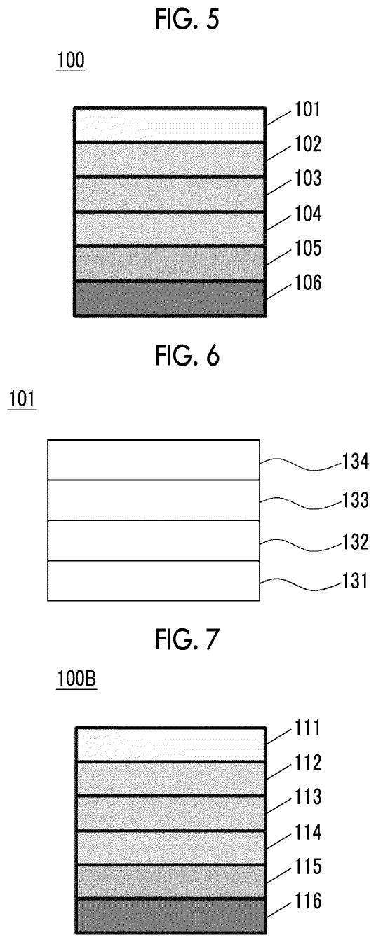

FIG. 5 shows a layer configuration of one aspect of the laminated optical body (100). In FIG. 5, for simplification, the laminated optical body which is an optical film is not shown as a non-planar shape, but as a planar shape.

A cholesteric liquid crystal layer (101), a positive C-plate (102), a retardation layer (103), a linear polarizer (104), a retardation layer (105), and an antireflection film (106) are arranged in this order. In a case where the laminated optical body is stretched or formed, a slow axis of the retardation layer or an absorption axis of the linear polarizer may be distorted. However, as described above, since the cholesteric liquid crystal layer maintains a high degree of polarization even after being stretched or molded, and the amount of leakage light from the cholesteric liquid crystal layer is small, the increase in leakage light is suppressed to a slight amount.

In addition, FIG. 6 shows an example of a layer configuration of the cholesteric liquid crystal layer (101) used in the second embodiment of the present invention. A first light reflecting layer (131), a second light reflecting layer (132), a third light reflecting layer (133), and a fourth light reflecting layer (134) are arranged in this order. In FIG. 6, for simplification, the cholesteric liquid crystal layer which can be included in the optical film is not shown as a non-planar shape, but as a planar shape.

FIG. 7 shows a layer configuration of another aspect of a laminated optical body (100B). In FIG. 7, for simplification, the laminated optical body which is an optical film is not shown as a non-planar shape, but as a planar shape.

In the laminated optical body (100B), a positive C-plate (111), a retardation layer (112), a linear polarization type reflective polarizer (113), a linear polarizer (114), a retardation layer (115), and an antireflection film (116) are arranged in this order.

In addition, in the laminated optical body, a surface roughness Ra is preferably 100 nm or less. As the Ra is small, sharpness of the image can be improved, for example, in a case where the laminated optical body is used in the virtual reality display apparatus or the like, which is preferable. The present inventors have presumed that, in a case where the light is reflected on the laminated optical body, an angle of the reflected light is distorted in a case where the laminated optical body has unevenness, which leads to image distortion and blurriness. The Ra of the laminated optical body is preferably 50 nm or less, more preferably 30 nm or less, and still more preferably 10 nm or less.

In addition, the laminated optical body is produced by laminating a plurality of layers. In a case where a layer is laminated on a layer with unevenness, the unevenness may be amplified. Therefore, in the laminated optical body, it is preferable that the Ra is small in all layers. Each layer of the laminated optical body preferably has an Ra of 50 nm or less, more preferably 30 nm or less, and still more preferably 10 nm or less.

In addition, from the viewpoint of further enhancing image sharpness of the reflection image, it is particularly preferable that the Ra of the cholesteric liquid crystal layer is small.

The surface roughness Ra can be measured by, for example, a non-contact surface/layer cross-sectional shape measuring system VertScan (manufactured by Ryoka System, Inc.). Since the Vertscan is a surface shape measurement method using a phase of reflected light from a sample, in a case of measuring a cholesteric liquid crystal layer consisting of a light reflecting layer formed by immobilizing a cholesteric liquid crystalline phase, the reflected light from inside the film may overlap, which makes it possible to accurately measure the surface shape. In this case, a metal layer may be formed on the surface of the sample to increase the reflectivity of the surface and further suppress the reflection from the inside. As a main method of forming the metal layer on the surface of the sample, a sputtering method is used. Au, Al, Pt, or the like is used as a material to be sputtered.

It is preferable that the number of point defects per unit area in the laminated optical body is small. Since the laminated optical body is produced by laminating a large number of layers, it is preferable that the number of point defects in each layer is also small in order to reduce the number of point defects in the entire laminated optical body. Specifically, the number of point defects in each layer is preferably 20 or less, more preferably 10 or less, and still more preferably 1 or less per square meter. The number of point defects in the entire laminated optical body is preferably 100 or less, more preferably 50 or less, and still more preferably 5 or less per square meter.

Since the point defects lead to a decrease in degree of polarization of transmitted light or reflected light or a decrease in image sharpness, it is preferable that the number of point defects is small.

Here, the point defects include foreign matter, scratches, stains, fluctuations in film thickness, alignment failure of a liquid crystal compound, and the like.

In addition, it is preferable that the number of the above-described point defects is counted with the number of point defects having a size of preferably 100 μm or more, more preferably 30 μm or more, and still more preferably 10 μm or more.

In addition, it is preferable that the laminated optical body is transparent to near-infrared light in order to minimize the influence on various sensors incorporated in optical systems such as a virtual reality display apparatus and an electronic finder, in which near-infrared light for eye tracking, facial expression recognition, and iris recognition is used as a light source.

### <Composite Lens>

One aspect of the composite lens includes a lens and the optical film according to the second embodiment of the present invention. A half mirror may be formed on one surface of the lens. As the lens, a convex lens or a concave lens can be used. As the convex lens, a biconvex lens, a plano-convex lens, or a convex meniscus lens can be used. As the concave lens, a biconcave lens, a plano-concave lens, or a concave meniscus lens can be used.

As the lens used in the virtual reality display apparatus, a convex meniscus lens or a concave meniscus lens is preferable for enlarging the angle of view, and a concave meniscus lens is more preferable in that chromatic aberration can be further suppressed.

As a material of the lens, a material transparent to visible light, such as glass, crystal, and plastic, can be used. Since the birefringence of the lens causes rainbow-like unevenness or light leakage, it is preferable that the birefringence is small, and a material having zero birefringence is more preferable.

### <Virtual Reality Display Apparatus>

One aspect of the virtual reality display apparatus includes at least an image display device which emits polarized light, and a composite lens including the optical film according to the second embodiment of the present invention. In addition, the virtual reality display apparatus may include an additional optical member such as a half mirror and a visual acuity adjustment lens.

### <Image Display Device>

As the image display device used in the second embodiment of the present invention, a known image display device can be used. Examples thereof include a display device in which self-luminous microscopic light emitters are arranged on a transparent substrate, such as an organic electroluminescent display device, a light emitting diode (LED) display device, and a micro LED display device. In these self-luminous display devices, a (circular) polarizing plate is usually bonded to a display surface to prevent reflection on the display surface. Therefore, the emitted light is polarized. In addition, a liquid crystal display device is exemplified as other image display devices. Since the liquid crystal display device also has a polarizing plate on the surface, the emitted light is polarized. In the following description, the organic electroluminescent display device will also be referred to as “OLED”. OLED is an abbreviation for “Organic Light Emitting Diode”.

<Forming method>

A manufacturing method of the above-described optical film having a non-planar shape is not particularly limited.

Among these, the forming method of the optical film according to the second embodiment of the present invention preferably includes a step of heating the optical film having a planar shape, a step of pressing the heated optical film against a mold to deform the optical film along a shape of the mold, and a step of cutting the optical film.

Hereinafter, each of the steps will be described in detail.

### (Step of Heating Optical Film Having Planar Shape)

The optical film used in this step has a planar shape. As will be described later, a predetermined shape is transferred to the optical film having a planar shape, and thus the optical film having a non-planar shape described above is obtained.

The optical film having a planar shape includes various members (for example, the retardation film) which can be included in the optical film having a non-planar shape described above. Here, various members included in the optical film having a planar shape also have a planar shape.

Examples of a method of heating the optical film having a planar shape include heating by bringing a heated solid into contact, heating by bringing a heated liquid into contact, heating by bringing a heated gas into contact, heating by irradiating with infrared rays, and heating by irradiating with microwaves. The heating by irradiating with infrared rays is preferable because the optical film having a planar shape can be heated remotely immediately before the forming.

A wavelength of the infrared rays used for the heating is preferably 1.0 μm to 30.0 μm and more preferably 1.5 μm to 5 μm.

As the IR light source, a near-infrared lamp heater in which a tungsten filament is inserted into a quartz tube, a wavelength control heater in which a mechanism for cooling a part between quartz tubes with air is provided by multiplexing the quartz tubes, or the like can be used. In addition, by distributing the irradiation amount of infrared rays on the optical film, physical property values during the forming can be controlled according to the purpose. As a method of providing intensity distribution, a method of varying the density of the arrangement of the IR light sources, or a method of placing a filter with a patterned transmittance to infrared light between the IR light sources and the optical film can be used. As the filter in which the transmittance is patterned, a filter in which a metal is deposited on glass, a filter in which a cholesteric liquid crystal layer having a reflection band in an infrared region is provided, a filter in which a dielectric multi-layer film having a reflection band in an infrared region is provided, a filter obtained by applying an ink that absorbs infrared rays, or the like is used. A temperature of the optical film is controlled by the intensity of the infrared irradiation, and by the infrared irradiation time or the illuminance of the infrared irradiation. The temperature of the optical film can be monitored using a noncontact radiation thermometer, a thermocouple, or the like, and the optical film can be formed at a target temperature.

### (Step of Pressing Optical Film Against Mold to Deform Optical Film Along Shape of Mold)

As a method of pressing the heated optical film against the mold to deform the optical film along a shape of the mold, decompression and/or pressurization of the forming space is used. In addition, a method of pushing the mold can also be used.

As one aspect of the forming device used in the present step, a box 1 having an opening portion on an upper side and a box 2 having an opening portion on a lower side are provided. The opening portion of the box 1 and the opening portion of the box 2 are fitted together directly or through other holding devices to form a sealed forming space. A mold (also referred to as an adherend) having a forming shape and the film to be formed are arranged in the forming space. The film to be formed is used as a partition to divide the forming space which consists of the box 1 and the box 2 into two spaces. The mold is disposed on the box 1 side below the film to be formed. Furthermore, a vacuum forming device includes multiple heating elements arranged in a dispersed manner to heat the film to be formed. The heating element may be disposed within the forming space, or may be disposed outside the forming space to heat the film to be formed by irradiation through a transparent window.

### (Step of Cutting Optical Film)

As a method of cutting the formed optical film into any desired shape, a cutter, scissors, a cutting plotter, or a laser cutting machine can be used.

### <Concept of Forming Method not Generating Phase Difference Distribution>

In a case of forming the optical film having a planar shape to obtain the above-described optical film having a non-planar shape and having an in-plane variation of the phase difference of less than 5%, it is preferable that an in-plane distribution of the phase difference does not occur during the forming. Hereinafter, the concept of a forming method not generating a phase difference distribution will be described in detail using a retardation film included in the optical film, as an example.

As described above, in a case where the retardation film is formed on a curved surface, it is preferable that the in-plane distribution of the phase difference does not occur. As a result, it is possible to suppress the occurrence of ghost even in a case where the retardation film formed into a curved surface is used in the pancake lens of the virtual reality display apparatus.

The reason why the in-plane distribution of the phase difference of the retardation film occurs is that a film thickness d after forming is different depending on the location, and thus a retardation Re which is a product of the birefringence An and the film thickness d has an in-plane distribution. The reason why the film thickness d has an in-plane distribution is due to the fact that a stretching ratio (product of stretching ratios in two orthogonal orientations) during forming varies depending on the location. Therefore, in order to suppress the occurrence, it is necessary that the product of the stretching ratios in the two orthogonal orientations remains is constant while the film is deformed along the curved surface of the mold. As the two orthogonal orientations, for example, in a case where a centroid position of the shape of the mold in the forming of a curved surface is defined as a point O and a polar coordinate system with the point O as a center is assumed, it is preferable that a product of a stretching ratio in a diameter direction (a direction in which a straight line connecting the position of each point and the point O extends) and a stretching ratio in a circumferential direction (a direction orthogonal to the diameter direction) of each point is constant. Here, the term “constant” means that, in a case where the in-plane variation (%) is represented by {(Maximum value−Minimum value)/Average value}×100, the in-plane variation is preferably less than 5%, more preferably less than 3%, and still more preferably less than 1%. The lower limit thereof is not particularly limited, but may be, for example, 0%.

A method of calculating the stretching ratio in the diameter direction and the stretching ratio in the circumferential direction described above will be described in detail later.

By setting the variation in the product of the stretching ratio in the diameter direction and the stretching ratio in the circumferential direction to less than 5%, a variation in the film thickness can be suppressed to less than 5%, and thus the variation in the phase difference can be suppressed to less than 5%.

Furthermore, by setting the variation in the product of the stretching ratio in the diameter direction and the stretching ratio in the circumferential direction to less than 3%, a variation in the film thickness can be suppressed to less than 3%, and thus the variation in the phase difference can be suppressed to less than 3%.

Furthermore, by setting the variation in the product of the stretching ratio in the diameter direction and the stretching ratio in the circumferential direction to less than 1%, a variation in the film thickness can be suppressed to less than 1%, and thus the variation in the phase difference can be suppressed to less than 1%.

As a specific stretching characteristic for achieving this, it is preferable that the stretching ratio in the diameter direction increases as a distance from the point O increases. More preferably, in a case where the distance from the point O is x, the stretching ratio in the diameter direction is in accordance with the following expression.

$$Stretching ratio in diameter direction = p * x / R / sqrt ( 1 - {( 1 - p * {x}^{2} / 2 / {R}^{2} )}^{2} )$$

Here, * represents a product and sqrt represents a square root. In addition, p represents the product of the stretching ratio in the diameter direction and the stretching ratio in the circumferential direction, and R represents a curvature radius of the mold.

### <Method of Installing Mold>

A method of installing the mold in the forming device is not particularly limited. For example, a movable stage with a horizontal top plate can be installed in the box 1 on the lower side of the above-described forming device, and the mold can be installed on the stage. In this case, the inside of the forming device is evacuated, and then the movable stage is raised, so that the mold can be pressed against the film to be formed.

In addition, the number of molds to be installed on the stage may be one or more. From the viewpoint of improving productivity, a film to be formed, having an area larger than an area of the mold, can be used, and a plurality of molds can be installed to simultaneously produce a plurality of formed products.

### <Holding Device for Gripping Mold>

In addition, it is also preferable to grip the mold using a holding device with a recess capable of fitting the mold so that the mold does not move on the stage. In this way, the mold can be fixed to prevent movement on the stage.

In addition, it is preferable that the holding device for gripping the mold covers surfaces of the mold, other than the forming surface (surface to which the film to be formed is bonded). In a case where the film to be formed attempts to coat not only the forming surface of the mold but also the edge surface of the mold, the film to be formed is significantly stretched, which may result in significant unevenness in film thickness and optical characteristics of the film. Therefore, it is preferable to use a holding device which covers surfaces of the mold other than the forming surface to prevent the film to be formed from coming into contact with the surfaces of the mold other than the forming surface.

In addition, it is preferable that the holding device has a surface with a height substantially equal to the forming surface of the mold and a horizontal surface in the portion where the mold is not present. In this manner, the stretching of the film to be formed in portions other than the forming surface of the mold can be suppressed, thereby improving uniformity of the film thickness and optical characteristics of the film.

In addition, in a case of forming the film to be formed in the mold, it is preferable to use the holding device and the movable stage on which the mold is installed, thereby raising the stage so that the position of the forming surface of the mold is at a height approximately equal to the position of the film to be formed. In this way, the film to be formed comes into contact with the edge surface of the holding device, preventing the film from being greatly stretched.

The above-described holding device may be integrated with the above-described stage.

### <Method of Bonding Optical Film to Adherend>

A method of bonding the optical film to the adherend is not particularly limited. For example, the optical film may be adhered to the adherend such as a lens using an adhesive or the like after being formed into a curved shape by any of the above-described methods.

In addition, from the viewpoint of simplifying the process, it is preferable to bond a pressure-sensitive adhesive sheet in advance to the surface of the optical film, which comes into contact with the mold, and to bond the pressure-sensitive adhesive sheet to the curved surface part of the mold simultaneously as the optical film is formed into a curved shape.

### <Method of Evaluating Stretching Ratio>

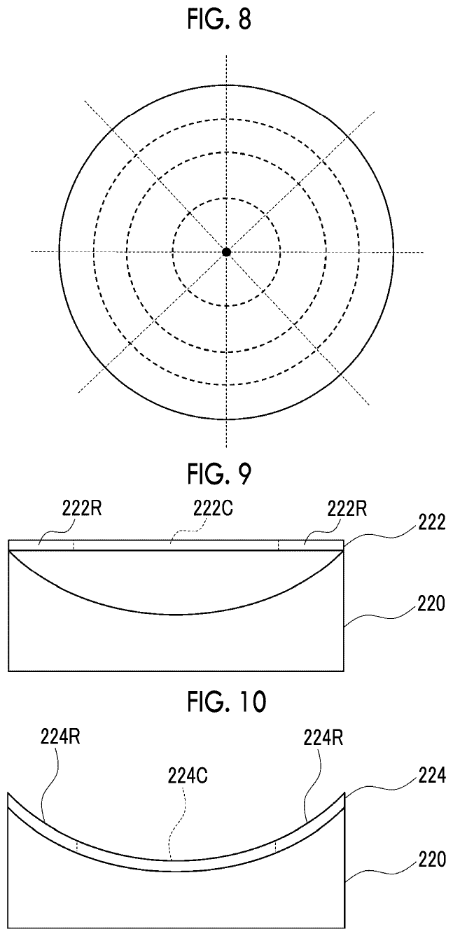

In order to evaluate the stretching ratio for each location in the forming method, for example, a pattern as shown in FIG. 8 is drawn on the film before the forming. As an example of the pattern, a circle drawn at an interval of ¼ of a radius of a circumscribed circle (for example, in FIG. 8, a circle shown by a broken line at an interval of 5 mm in a case where the radius of a circle shown by a solid line is 20 mm) is drawn on the film before the forming, and a straight line (a straight broken line in FIG. 8) is drawn at an interval of 45 degrees in the azimuthal angle direction. A center of the circle corresponds to the centroid of the film. In addition, all the above-described straight lines pass through the center of the circle. Coordinates of the intersections of the pattern are measured before and after the forming, and a rate of change between adjacent intersections is obtained, whereby the stretching ratio in the diameter direction can be evaluated. More specifically, in a case where a distance between two points before the forming is denoted by L0 and a distance between the two points after the forming is denoted by L1, the two points being located in the diameter direction, the stretching ratio is obtained by calculating L1/L0. According to the above-described procedure, 32 points of L1/L0 values are calculated, and the obtained values are defined as the stretching ratio in the diameter direction of each point.

In addition, the stretching ratio in the circumferential direction can be evaluated by using the coordinates of each intersection with respect to the center of the circle. More specifically, in a case where a distance from the center before the forming is denoted by r0 and a distance between the center and an intersection, when the center is projected onto a plane parallel to a tangent plane of the center, is denoted by r1, a circumference length of a circle drawn with this distance changes from 2πr0 to 2πr1, so that the stretching ratio in the circumferential direction can be obtained by r1/r0. r0 and r1 can be obtained from xyz coordinates of each point (the center is origin 0, 0, 0) by r0=sqrt(x0²+y0²) and r1=sqrt(x1²+y1²). According to the above-described procedure, r1/r0 at each of the 32 points, where the above-described stretching ratio in the diameter direction is obtained by appropriately changing r0, is calculated, and the obtained r1/r0 is used as the stretching ratio in the circumferential direction of each point.

A product of the stretching ratio in the diameter direction and the stretching ratio in the circumferential direction (direction orthogonal to the diameter direction) at each of the 32 points calculated as described above is calculated, and the maximum value, the minimum value, and the average value are obtained to calculate the above-described in-plane variation (%).

### <Forming Method 1 not Generating Phase Difference Distribution>

As an example of the forming method not generating the phase difference distribution, a forming method of an optical film, including a step of heating an optical film having a planar shape, a first forming step of pressing the heated optical film against a first mold to deform the optical film along a shape of the first mold, and a second forming step of pressing the optical film formed in the first forming step against a second mold to deform the optical film along a shape of the second mold is exemplified.

In particular, in the above-described forming method, it is preferable that a shape of the first mold includes a convex curved surface portion, and a shape of the second mold includes a concave curved surface portion.

In addition, in the above-described forming method, it is preferable that a curvature radius of the first mold is larger than a curvature radius of the second mold.

In this manner, it is possible to impart the forming characteristic in which the stretching ratio in the diameter direction increases as the distance from the center increases. As a result, the variation in the product of the stretching ratio in the diameter direction and the stretching ratio in the circumferential direction can be suppressed, and the variation in the film thickness and the variation in the phase difference can be suppressed.

Hereinafter, suitable aspects of the above-described method will be described in more detail.

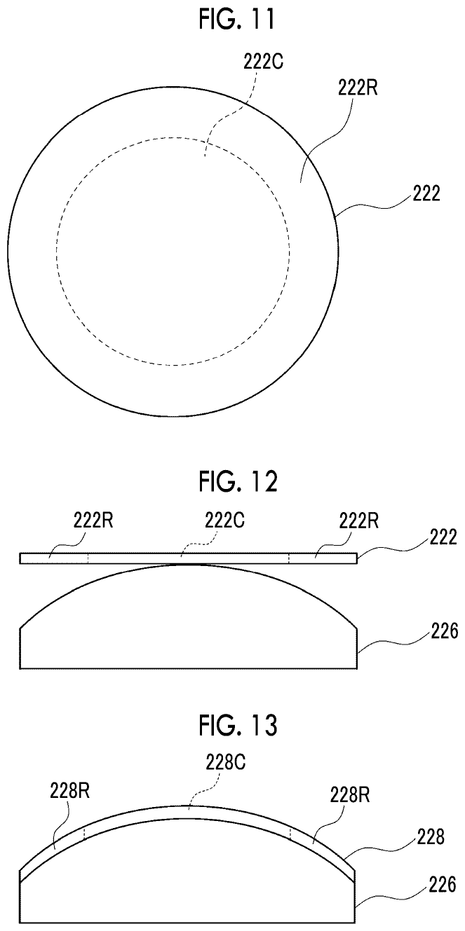

First, a phenomenon occurring in a case of forming a film using a forming die having a concave forming surface will be described with reference to FIGS. 9 to 11. FIGS. 9 and 10 show a procedure for forming a film using a forming die having a concave forming surface, and FIG. 11 shows the film used for the forming.

As shown in FIG. 9, a circular film 222 is placed on a forming die 220 having a concave forming surface, and as shown in FIG. 10, the film 222 is deformed along a forming surface of the forming die 220, whereby a film 224 with the concave surface shape transferred is obtained.

Usually, in a case of forming with the concave surface, a difference in stretching ratio occurs in a center portion 222C and a periphery portion 222R surrounding the center portion 222C of the film 222, as shown in FIGS. 9 and 11. More specifically, the center portion 222C of the film 222 is more easily stretched than the periphery portion 222R of the film 222. As a result, in the film 224 on which the concave surface shape is transferred, a film thickness of a center portion 224C is smaller than a film thickness of a periphery portion 224R.

Next, a phenomenon occurring in a case of forming a film using a forming die having a convex forming surface will be described with reference to FIGS. 11 to 13. FIGS. 12 and 13 show a procedure for forming a film using a forming die having a convex forming surface, and FIG. 11 shows the film used for the forming.

As shown in FIG. 12, a circular film 222 is placed on a forming die 226 having a convex forming surface, and as shown in FIG. 13, the film 222 is deformed along a forming surface of the forming die 226, whereby a film 228 with the convex surface shape transferred is obtained.

Usually, in a case of forming with the convex surface, a difference in stretching ratio occurs in a center portion 222C and a periphery portion 222R of the film 222, as shown in FIGS. 11 and 12. More specifically, the periphery portion 222R of the film 222 is more easily stretched than the center portion 222C of the film 222. As a result, in the film 228 on which the convex surface shape is transferred, a film thickness of a periphery portion 228R is smaller than a film thickness of a center portion 228C.

As described above, in the case of forming with the concave surface, the film thickness of the center portion of the obtained film is smaller than the film thickness of the periphery portion, and in the case of forming with the convex surface, the film thickness of the periphery portion of the obtained film is smaller than the film thickness of the center portion.

Therefore, as described above, a suitable aspect of the above-described forming method 1 include a manufacturing method including a step 1A of deforming the optical film having a planar shape along the forming surface of the forming die having a convex forming surface, and a step 2A of deforming the optical film obtained in the step 1A, on which the convex surface shape has been transferred, along the forming surface of the forming die having a concave forming surface with a curvature radius smaller than that of the convex forming surface, in which the surface of the optical film on a side opposite to the surface of the optical film, which has been in contact with the forming die in the step 1A and in which the convex surface shape had been transferred in the step 1A, is in contact with the forming surface of the forming die in the step 2A.

Hereinafter, the above-described suitable aspect of the forming method 1 will be described with reference to the accompanying drawings.

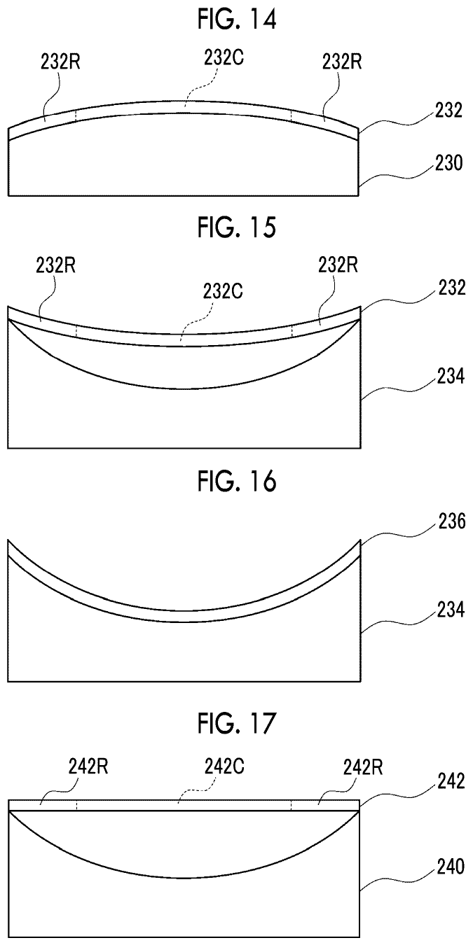

In the suitable aspect of the forming method 1, first, the step 1A of deforming the optical film having a planar shape along the forming surface of the forming die having a convex forming surface is performed using the forming die. By performing the step, as shown in FIG. 14, an optical film 232 on which the convex surface shape is transferred is obtained on a forming die 230 having a convex forming surface. In the optical film 232, as described with reference to FIGS. 12 and 13 above, the film thickness of the periphery portion 232R of the optical film 232 is smaller than the film thickness of the center portion 232C.

Next, the step 2A of deforming the optical film obtained in the step 1A, on which the convex surface shape has been transferred, along the forming surface of the forming die having a concave forming surface with a curvature radius smaller than that of the convex forming surface, in which the surface of the optical film on a side opposite to the surface of the optical film, which has been in contact with the forming die in the step 1A and in which the convex surface shape had been transferred in the step 1A, is in contact with the forming surface of the forming die in the step 2A, is performed. A curvature radius of a forming surface of a forming die 234 having a concave forming surface, used in the step 2A, is smaller than a curvature radius of the forming surface of the forming die 230 having a convex forming surface, used in the step 1A. In the step 2A, first, as shown in FIG. 15, the optical film 232 obtained in the step 1A is placed on the forming die 234, which has a forming surface with a smaller curvature radius than the forming die 230 used in the step 1A. In a case where the optical film 232 is placed on the forming die 234, the surface of the optical film 232 on a side opposite to the surface which has been in contact with the forming die 230 is placed on the forming surface side of the forming die 234. Next, as shown in FIG. 16, the optical film 232 is deformed along the forming surface of the forming die 234 to obtain an optical film 236 having a curved shape portion.

As described with reference to FIGS. 9 and 10 above, in a case of forming with the concave surface, the film thickness of the center portion of the film is usually smaller than the film thickness of the periphery portion. Therefore, in a case where the step 2A is performed, the decrease in film thickness of the center portion 232C of the optical film 232 is larger than the decrease in film thickness of the periphery portion 232R.

That is, in the step 1A, the decrease in film thickness of the periphery portion of the optical film is larger than the decrease in film thickness of the center portion, and in the step 2A, the decrease in film thickness of the center portion of the optical film is larger than the decrease in film thickness of the periphery portion. Therefore, in a case where the step 1A and the step 2A are performed, the decrease in film thickness of the center portion and the decrease in film thickness of the periphery portion are the same, and as a result, the in-plane variation of the film thickness in the obtained optical film 236 is suppressed.

As described above, the curvature radius of the forming surface of the forming die used in the step 2A is smaller than the curvature radius of the forming surface of the forming die used in the step 1A.

A ratio (CA2/CA1) of the curvature radius (CA2) of the forming surface of the forming die used in the step 2A to the curvature radius (CA1) of the forming surface of the forming die used in the step 1A is selected as an optimum value according to the optical film to be manufactured, but is preferably 0.6 to 0.9 and more preferably 0.7 to 0.85.

In a case where the curvature radius is different depending on the position of the forming surface of the forming die used in the step 1A, the minimum curvature radius is defined as the above-described “curvature radius of the forming surface of the forming die used in the step 1A”.

In addition, in a case where the curvature radius is different depending on the position of the forming surface of the forming die used in the step 2A, the minimum curvature radius is defined as the above-described “curvature radius of the forming surface of the forming die used in the step 2A”.

### [Forming Method 2 not Generating Phase Difference Distribution]

As another example of the forming method not generating the phase difference distribution, a forming method of an optical film, including a step of heating an optical film having a planar shape, a step of pressing the heated optical film against a mold to deform the optical film along a shape of the mold, and a step of cutting the deformed optical film, in which the heating step is a step of heating the optical film by irradiating the optical film with infrared rays, and an irradiation amount of the infrared rays has a distribution in a plane of the optical film, is exemplified.

In particular, in the above-described forming method, it is preferable that the mold is substantially concave sphere, and in a case where an in-plane position of the optical film is projected onto the mold from a normal direction of a surface of the optical film, an amount of infrared irradiation to the optical film located at a vertex of the concave sphere is smaller than an amount of infrared irradiation to the optical film located at an end part of the concave sphere.

In addition, in the above-described forming method, it is preferable that the mold is substantially concave sphere, and in a case where an in-plane position of the optical film is projected onto the mold from a normal direction of a surface of the optical film, a temperature of the optical film located at a vertex of the concave sphere is lower than a temperature of the optical film located at an end part of the concave sphere.

In this manner, it is possible to impart the forming characteristic in which the stretching ratio in the diameter direction increases as the distance from the center increases. As a result, the variation in the product of the stretching ratio in the diameter direction and the stretching ratio in the circumferential direction can be suppressed, and the variation in the film thickness and the variation in the phase difference can be suppressed.

Hereinafter, suitable aspects of the above-described method will be described in more detail.

As described above, in a case where the forming die having a concave forming surface is used, the film thickness of the center portion of the film is likely to be smaller than the film thickness of the periphery portion.

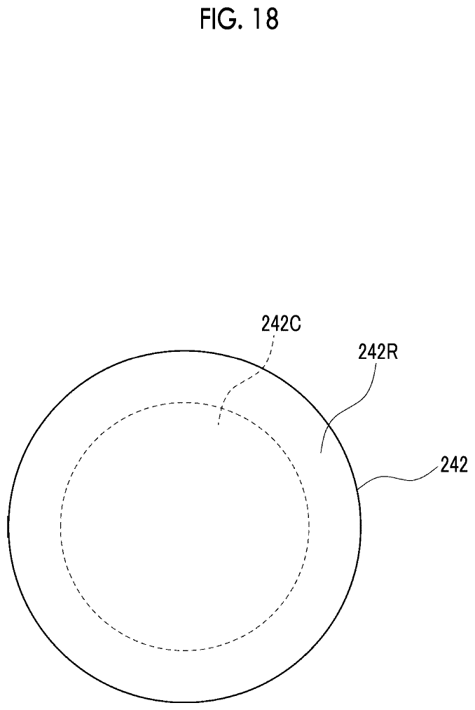

Therefore, in the above-described suitable aspect of the forming method 2, as shown in FIGS. 17 and 18, by heating an optical film 242 having a planar shape, which is placed on a forming die 240 having a concave forming surface, such that a heating temperature of a periphery portion 242R by infrared irradiation is higher than a heating temperature of a center portion 242C by infrared irradiation in the optical film 242, the periphery portion 242R is easily stretched in a case where the optical film 242 is deformed along the forming surface. That is, as described above, in general, the decrease in film thickness of the center portion of the optical film is larger than the decrease in film thickness of the periphery portion in the forming using the forming die having a concave forming surface. However, by changing the heating conditions for the center portion and the periphery portion, the center portion is less likely to stretch and the periphery portion is more likely to stretch, thereby suppressing the decrease in film thickness of the center portion while increasing the decrease in film thickness of the periphery portion. As a result, in the deformed optical film, the in-plane variation of the film thickness is suppressed.

In the present invention, the first embodiment and the second embodiment can be used in combination.

For example, the optically functional film according to the first embodiment and the forming method of the optical film according to the second embodiment may be combined and used. As an example, the optically functional film according to the first embodiment may be formed by the forming method 1 or the forming method 2 according to the second embodiment to manufacture an optical film having a non-planar shape.

The above descriptions are examples of a combination of the first embodiment and the second embodiment, and the combination is not limited in the present invention.

### EXAMPLES

Hereinafter, the features of the present invention will be described in more detail with reference to Examples. The materials, the used amounts, the proportions, the treatment contents, the treatment procedures, and the like described in Examples can be appropriately changed without departing from the gist of the present invention. In addition, configurations other than the configurations described below can be employed without departing from the gist of the present invention.

### First Embodiment

### [Production of Retardation Layer 1]

A retardation layer 1 having reverse dispersibility was produced on a temporary support consisting of a cellulose acylate film using a coating liquid A1 for forming a retardation layer, which contained a liquid crystal compound having a polymerizable group, with reference to the method described in paragraphs 0151 to 0163 of JP2020-084070A. Here, in a case where the coating liquid A1 was irradiated with ultraviolet rays to polymerize the liquid crystal compound, the irradiation amount of the ultraviolet rays was changed from 300 mJ/cm² to 50 mJ/cm².

A phase difference of the obtained retardation layer 1 was Re=146 nm and Rth=73 nm. In addition, a polymerization rate of the liquid crystal compound in the retardation layer 1 was 26%. In addition, in the retardation layer 1, the liquid crystal compound was aligned in one direction.

In the present example, the phase difference of each optically functional film or each layer was measured by the above-described method, using AxoScan OPMF-1 (manufactured by Opto Science, Inc.). In addition, the polymerization rate of the liquid crystal compound in each optically functional film or each layer was measured by the above-described method of measuring the absorption peak based on the polymerizable group, using an infrared spectrophotometer (“FTS-6000” manufactured by Bio-Rad Laboratories, Inc.).

The retardation layer 1 produced in this manner was used as an optically functional film in manufacturing of virtual reality display apparatuses of Examples 1 and 2.

### [Production of Retardation Layer 2]

A retardation layer 2 was produced in the same manner as in the production of the retardation layer 1, except that the irradiation amount of ultraviolet rays for irradiating the coating film of the coating liquid A1 was changed to 300 mJ/cm² in order to polymerize the liquid crystal compound.

A phase difference of the obtained retardation layer 2 was Re=145 nm and Rth=72 nm. In addition, a polymerization rate of the liquid crystal compound contained in the retardation layer 2 was 73%, and the liquid crystal compound in the retardation layer 2 was aligned in one direction.

The retardation layer 2 produced in this manner was used as an optically functional film in manufacturing of a virtual reality display apparatus of Comparative Example 1.

### [Preparation of Coating Liquid for Cholesteric Liquid Crystal Layer]

### (Coating Liquid R-1 for Cholesteric Liquid Crystal Layer)

A composition shown below was stirred and dissolved in a container held at 70° C. to prepare a coating liquid R-1 for a cholesteric liquid crystal layer. Here, R represents a coating liquid containing a rod-like liquid crystal compound.

Coating liquid R-1 for cholesteric liquid crystal layer

| | | |
|---|---|---|
| Methyl ethyl ketone | 120.9 | parts by mass |
| Cyclohexanone | 21.3 | parts by mass |
| Mixture of rod-like liquid crystal compounds | 100.0 | parts by mass |
| shown below | | |
| Photopolymerization initiator b | 1.00 | part by mass |
| Chiral agent A shown below | 3.00 | parts by mass |
| Surfactant F1 shown below | 0.027 | parts by mass |
| Surfactant F2 shown below | 0.067 | parts by mass |

### (Coating Liquid R-2 for Cholesteric Liquid Crystal Layer)

A coating liquid R-2 for a cholesteric liquid crystal layer was prepared in the same manner as the coating liquid R-1 for a cholesteric liquid crystal layer, except that the addition amount of the chiral agent A was changed as shown in the following table.

Table 1. Amount of chiral agent in coating liquid containing rod-like liquid crystal compound

TABLE 1

| | Amount of chiral agent |
|---|---|
| Name of coating liquid | (part by mass) |
| Liquid R-1 | 3.00 |
| Liquid R-2 | 3.62 |

### Mixture of Rod-Like Liquid Crystal Compounds

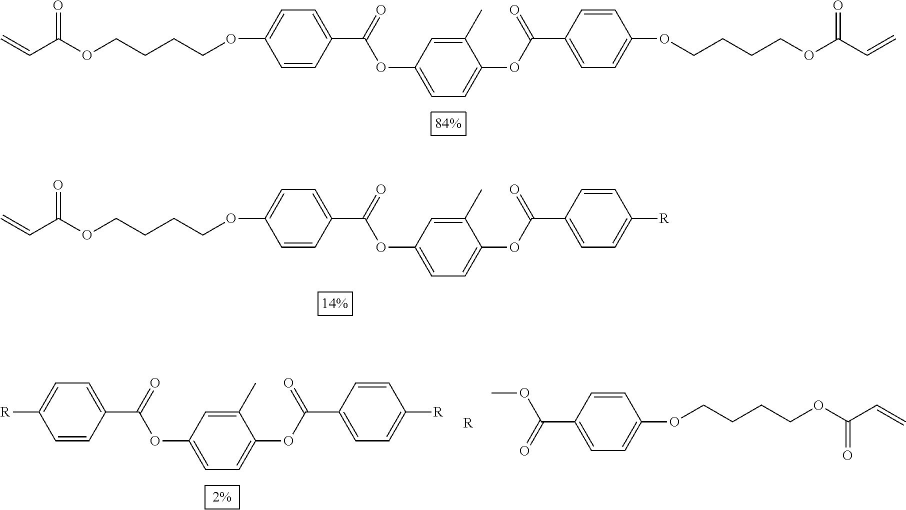

In the above-described mixture, each numerical value denotes the content in units of % by mass. In addition, R is a group bonded through an oxygen atom. Furthermore, an average molar absorption coefficient of the above-described rod-like liquid crystal compound at a wavelength of 300 to 400 nm was 140/mol·cm.

### Chiral Agent A

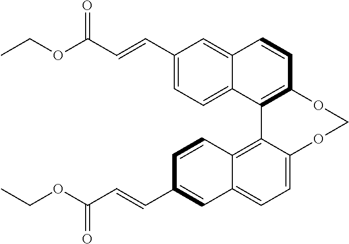

### Surfactant F1

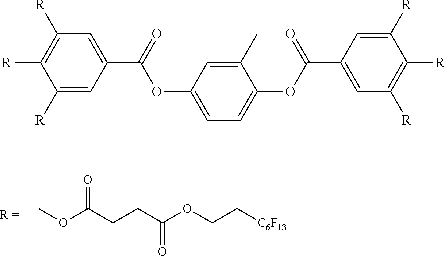

### Surfactant F2

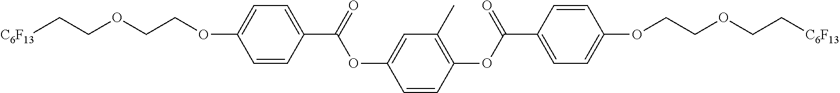

### Photopolymerization Initiator B

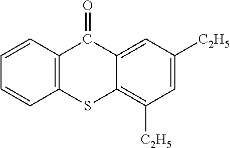 [SMILES: CCc1cc(CC)c2sc3ccccc3c(=O)c2c1]

The chiral agent A is a chiral agent in which the helical twisting power (HTP) is reduced by light.

### (Coating Liquid D-1 for Cholesteric Liquid Crystal Layer)

A composition shown below was stirred and dissolved in a container held at 50° C. to prepare a coating liquid D-1 for a cholesteric liquid crystal layer. Here, D represents a coating liquid containing a disk-like liquid crystal compound.

Coating liquid D-1 for cholesteric liquid crystal layer

| | | |
|---|---|---|
| Disk-like liquid crystal compound (A) | 80 | parts by mass |
| shown below | | |
| Disk-like liquid crystal compound (B) | 20 | parts by mass |
| shown below | | |
| Polymerizable monomer E1 | 10 | parts by mass |
| Surfactant F4 | 0.3 | parts by mass |
| Photopolymerization initiator | 3 | parts by mass |
| (IRGACURE 907 manufactured by | | |
| BASF SE) | | |
| Chiral agent A | 4.00 | parts by mass |
| Methyl ethyl ketone | 290 | parts by mass |
| Cyclohexanone | 50 | parts by mass |

### (Coating Liquid D-2 for Cholesteric Liquid Crystal Layer)

A coating liquid D-2 for a cholesteric liquid crystal layer was prepared in the same manner as the coating liquid D-1 for a cholesteric liquid crystal layer, except that the addition amount of the chiral agent A was changed as shown in Table 2.

Table 2. Amount of chiral agent in coating liquid containing disk-like liquid crystal compound

TABLE 2

| | Amount of chiral agent |
|---|---|
| Name of coating liquid | (part by mass) |
| Liquid D-1 | 4.00 |
| Liquid D-2 | 5.30 |

### Disk-Like Liquid Crystal Compound (A)

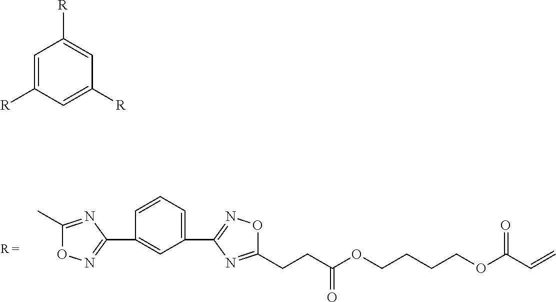

### Disk-Like Liquid Crystal Compound (B)

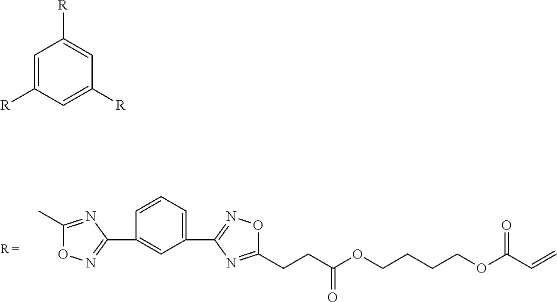

Polymerizable monomer E1

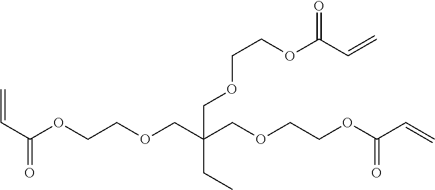 [SMILES: C=CC(=O)OCCOCC(CC)(COCCOC(=O)C=C)COCCOC(=O)C=C]

### Surfactant F4

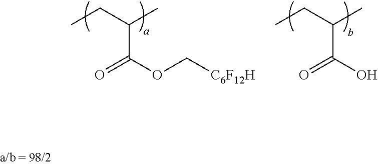

### [Production of Cholesteric Liquid Crystal Layer 1]

A polyethylene terephthalate (PET) film (A4100 manufactured by Toyobo Co., Ltd.) having a thickness of 50 μm was prepared as a temporary support. The PET film had an easy adhesion layer on one surface.

A surface of the PET film, which was not provided with the easy adhesion layer, was subjected to a rubbing treatment, coated with the coating liquid R-1 for a cholesteric liquid crystal layer prepared above using a wire bar coater, and dried at 110° C. for 120 seconds. Thereafter, the surface was irradiated with light using a metal halide lamp at 100° C., an illuminance of 40 mW/cm², and an irradiation amount of 50 mJ/cm² in a low oxygen atmosphere (100 ppm or less), thereby curing the coating liquid to form a red light reflecting cholesteric liquid crystal layer consisting of a cholesteric liquid crystal layer. The irradiation with light was performed from the side of the cholesteric liquid crystal layer in all cases. In this case, the coating thickness was adjusted so that the film thickness of the cured red light reflecting cholesteric liquid crystal layer was 4.5 μm.

A polymerization rate of the liquid crystal compound in the obtained red light reflecting cholesteric liquid crystal layer was 17%.

Next, a surface of the red light reflecting cholesteric liquid crystal layer was subjected to a corona treatment at a discharge amount of 150 W·min/m², and the surface subjected to the corona treatment was coated with the coating liquid D-1 for a cholesteric liquid crystal layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (irradiation amount: 50 mJ/cm²) using a metal halide lamp in a nitrogen atmosphere, thereby curing the coating film to form a yellow light reflecting cholesteric liquid crystal layer on the red light reflecting cholesteric liquid crystal layer. The irradiation with light was performed from the side of the cholesteric liquid crystal layer in all cases. In this case, the coating thickness was adjusted so that the film thickness of the cured yellow light reflecting cholesteric liquid crystal layer was 3.3 μm.

A polymerization rate of the liquid crystal compound in the obtained yellow light reflecting cholesteric liquid crystal layer was 21%.

Next, the yellow light reflecting cholesteric liquid crystal layer was coated with the coating liquid R-2 for a cholesteric liquid crystal layer using a wire bar coater and dried at 110° C. for 120 seconds. Thereafter, the surface was irradiated with light using a metal halide lamp at 100° C., an illuminance of 40 mW, and an irradiation amount of 50 mJ/cm² in a low oxygen atmosphere (100 ppm or less), thereby curing the coating liquid to form a green light reflecting cholesteric liquid crystal layer on the yellow light reflecting cholesteric liquid crystal layer. The irradiation with light was performed from the side of the cholesteric liquid crystal layer in all cases. In this case, the coating thickness was adjusted so that the film thickness of the cured green light reflecting cholesteric liquid crystal layer was 2.7 μm.

A polymerization rate of the liquid crystal compound in the obtained green light reflecting cholesteric liquid crystal layer was 19%.

Next, a surface of the green light reflecting cholesteric liquid crystal layer was subjected to a corona treatment at a discharge amount of 150 W·min/m², and the surface subjected to the corona treatment was coated with the coating liquid D-2 for a cholesteric liquid crystal layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (irradiation amount: 50 mJ/cm²) using a metal halide lamp in a nitrogen atmosphere, thereby curing the coating film to form a blue light reflecting cholesteric liquid crystal layer on the green light reflecting cholesteric liquid crystal layer. The irradiation with light was performed from the side of the cholesteric liquid crystal layer in all cases. In this case, the coating thickness was adjusted so that the film thickness of the cured blue light reflecting cholesteric liquid crystal layer was 2.5 μm.

A polymerization rate of the liquid crystal compound in the obtained blue light reflecting cholesteric liquid crystal layer was 24%.

In this manner, a cholesteric liquid crystal layer 1 (optically functional film) in which the red light reflecting cholesteric liquid crystal layer, the yellow light reflecting cholesteric liquid crystal layer, the green light reflecting cholesteric liquid crystal layer, and the blue light reflecting cholesteric liquid crystal layer were laminated in this order was obtained.

### [Production of Optical Laminate 1]

As a base material, a PMMA film “TECHNOLLOY S001 (thickness: 75 μm)” manufactured by Sumika Acryl Co., Ltd. was prepared, and the above-described retardation layer 1 with a temporary support was bonded to the base material using an ultraviolet curable adhesive. Subsequently, the cellulose acylate film used as the temporary support was peeled off and removed from the retardation layer 1. In this manner, an optical laminate 1 including the retardation layer 1 and the base material was obtained.

In the results measured by the above-described measurement method of tan δ, the peak temperature of tan δ of the above-described resin constituting the base material was 100° C.

### [Production of Optical Laminate 2]

An optical laminate 2 was obtained in the same manner as in the production method of the optical laminate 1, except that the retardation layer 1 was changed to the retardation layer 2.

### [Production of Optical Laminate 3]

An optical laminate 3 was obtained in the same manner as in the production method of the optical laminate 1, except that the retardation layer 1 was changed to the cholesteric liquid crystal layer 1.

### Example 1

A virtual reality display apparatus “VIVE FLOW” manufactured by HTC Corporation was disassembled, and an optical lens was taken out from a lens barrel. The “VIVE FLOW” is a virtual reality display apparatus in which a pancake lens is adopted, and a liquid crystal display device which emits circularly polarized light by a polarizing plate bonded to a surface is used as an image display device.

In addition, the taken optical lens was two types of lenses, one of which was a biconvex lens having a half-mirror coating on one surface and the other of which was a plano-convex lens having an optical laminate bonded to a plane.

Among the two optical lenses taken out, the above-described optical laminate 1 was attached to a surface of the biconvex lens opposite to the surface with the half-mirror coating by a vacuum molding method, thereby obtaining a formed product with a three-dimensional shape including a curved surface. As a pressure-sensitive adhesive for attaching the optical laminate 1 to the biconvex lens, a pressure sensitive adhesive “NCF-D695” manufactured by LINTEC Corporation was used for forming a pressure-sensitive adhesive layer having a thickness of 5 μm. In the following description, in a case where the vacuum molding method was used, the optical film was attached to the curved surface in the same manner using the pressure sensitive adhesive “NCF-D695” manufactured by LINTEC Corporation.

The formed product obtained in this manner was irradiated with ultraviolet rays at an intensity of 300 mJ/cm² to obtain an optical component 1 including the retardation layer 1 (λ/4 retardation layer), the biconvex lens, and the half-mirror coating in this order. In the optical component 1, a polymerization rate of the liquid crystal compound in the retardation layer 1 was 78%.

Next, the optical laminate was peeled off from the plane of the taken plano-convex lens, and an absorption type polarizer, a reflective type linear polarizer “APF” manufactured by 3M, and an antireflection film “AR100” manufactured by Dexerials Corporation were bonded thereto in this order, thereby obtaining a plano-convex lens A with an optical laminate.

The obtained optical component 1 and the plano-convex lens A with an optical laminate were assembled into the lens barrel of “VIVE FLOW” instead of the above-described biconvex lens and plano-convex lens taken out, respectively, thereby producing a virtual reality display apparatus of Example 1.

### Example 2

A virtual reality display apparatus “VIVE FLOW” manufactured by HTC Corporation was disassembled, and the above-described two optical lenses were taken out.

Among the two optical lenses taken out, a plano-convex lens 1 with a curvature radius of 65 mm, a diameter of 50 mm, and a focal length of 125 mm on the convex surface side was prepared as an optical lens to replace a plano-convex lens to which the optical laminate was bonded. An absorption type polarizer, the above-described optical laminate 1, and the above-described optical laminate 3 were attached to a convex surface side of the plano-convex lens 1 in this order while being formed by a vacuum molding method to obtain a formed product with a three-dimensional shape including a curved surface.

Next, the obtained formed product was heated at 110° C. for 30 seconds, an alignment treatment to align the liquid crystal compound contained in each of the retardation layer 1 and the cholesteric liquid crystal layer was performed, and the retardation layer 1 and the cholesteric liquid crystal layer were further irradiated with ultraviolet rays at an intensity of 300 mJ/cm², thereby obtaining an optical component 2. The obtained optical component 2 had the plano-convex lens, the absorption type polarizer, the retardation layer 1 (λ/4 retardation layer), and the cholesteric liquid crystal layer 1 (reflective type circular polarizer) in this order. In the optical component 2, in a case where a polymerization rate of the liquid crystal compound in the retardation layer 1 was measured by peeling off a part of the optical laminate 1 from the optical component 2, the polymerization rate was 73%. Similarly, a polymerization rate of the liquid crystal compound in the cholesteric liquid crystal layer 1 was 65%.

The obtained optical component 2 was assembled into the lens barrel of “VIVE FLOW” instead of the above-described plano-convex lens taken out, and the biconvex lens taken out above was reassembled into the lens barrel of “VIVE FLOW”, thereby producing a virtual reality display apparatus of Example 2.

### Comparative Example 1

A virtual reality display apparatus “VIVE FLOW” manufactured by HTC Corporation was disassembled, and the above-described two optical lenses were taken out.

Among the two optical lenses taken out, the above-described optical laminate 2 was attached to a surface of the biconvex lens opposite to the surface with the half-mirror coating by a vacuum molding method, thereby obtaining a formed product with a three-dimensional shape including a curved surface. The formed product obtained in this manner was used as an optical component 3. In the optical component 3, a part of the retardation layer 2 was broken.

Next, the optical laminate was peeled off from the plane of the taken plano-convex lens, and an absorption type polarizer, a reflective type linear polarizer “APF” manufactured by 3M, and an antireflection film “AR100” manufactured by Dexerials Corporation were bonded thereto in this order, thereby obtaining a plano-convex lens A with an optical laminate.

The obtained optical component 3 and the plano-convex lens A with an optical laminate were assembled into the lens barrel of “VIVE FLOW” instead of the above-described biconvex lens and plano-convex lens taken out, respectively, thereby producing a virtual reality display apparatus of Comparative Example 1.

### [Evaluation]

### <Evaluation of Phase Difference of Optical Laminate>

A phase difference of the optical component produced in Examples 1 and 2 and Comparative Example 1 was measured using AxoScan OPMF-1 (manufactured by Opto Science, Inc.). A phase difference was measured at a position with a radius of 15 mm from a center of the optical lens (biconvex lens or plano-convex lens) included in each optical component at every azimuthal angle of 45°, and a value at which a deviation amount of Re from the phase difference of the retardation layer 1 or the retardation layer 2 was largest was recorded. In the optical component 2 of Example 2, the cholesteric liquid crystal layer 1 used in the optical laminate 3 was measured for the phase difference at a wavelength of 500 nm, at which the cholesteric liquid crystal layer 1 did not have reflectivity. In the other optical laminates, the phase difference was measured at a wavelength of 550 nm.

The measurement results of the phase difference of each optical component are shown in Table 1.

### <Evaluation of Light Leakage>

In the virtual reality display apparatuses produced in Examples 1 and 2 and Comparative Example 1, a black-and-white checker pattern was displayed on the image display device, and a degree of light leakage was evaluated by visual observation in the following three stages. In a case where there was the light leakage, double images were visually recognized, and a contrast of the corresponding portion was lowered.
A: double images were hardly visible.
B: double images were slightly visible but not noticeable.
C: clear double images were observed.

The evaluation results of the light leakage are shown in Table 1.

### <Evaluation of Display Uniformity>

In the virtual reality display apparatuses produced in Examples 1 and 2 and Comparative Example 1, a black-and-white checker pattern was displayed on the image display device, and display uniformity was evaluated by visual observation in the following three stages.
A: image was uniformly displayed over the entire surface.
B: part of the image was non-uniformly distorted.
C: large part of the image was distorted.

The evaluation results of the display uniformity are shown in Table 3.

Table 3. Evaluation results of virtual reality display apparatuses of Examples and

### Comparative Example

TABLE 3

| | | Phase difference | | |
|---|---|---|---|---|
| | Optical | deviation of | Light | Display |
| | component | optical component | leakage | uniformity |
| Example 1 | Optical | 4 nm | A | A |
| | component 1 | | | |
| Example 2 | Optical | 3 nm | A | A |
| | component 2 | | | |
| Comparative | Optical | 22 nm | C | C |
| Example 1 | component 3 | | | |

As shown in Table 3, in the optical components of Examples 1 and 2, the in-plane deviation of Re from the retardation layer 1 was suppressed to be small, and thus, in the virtual reality display apparatus according to the first embodiment, it was found that the light leakage was effectively reduced as compared with that of Comparative Example, and the occurrence of double images and the decrease in contrast were suppressed.

In addition, in the virtual reality display apparatus using the optical components of Examples 1 and 2, the image display was uniform over the entire surface, but in the virtual reality display apparatus using the optical component of Comparative Example 1, most of the image was distorted because the retardation layer 1 used in the optical component was broken.

The virtual reality display apparatus according to the first embodiment of the present invention has been described in detail above, but the present invention is not limited to the above-described examples, and various improvements and changes may be made without departing from the spirit of the present invention.

### Second Embodiment

### <Production of Retardation Film 11>

A retardation film 11 having reverse dispersibility was produced using a coating liquid for forming a retardation layer containing a liquid crystal compound having a polymerizable group, with reference to the method described in paragraphs 0151 to 0163 of JP2020-084070A. As the phase difference of the retardation film 11, Re was 146 nm and Rth was 73 nm. AxoScan OPMF-1 (manufactured by Opto Science, Inc.) was used for the evaluation of the phase difference. In addition, an in-plane variation of Re was 0.7%. A film thickness of the coating film of the retardation film 11 was 2.5 μm. In addition, an in-plane variation of the film thickness of the coating film was 0.7%. Here, the film thickness of the coating film was evaluated using SEM. In addition, in the retardation film 11, the liquid crystal compound was aligned in one direction.

The in-plane variation of Re and the in-plane variation of the film thickness were measured as follows.

First, a circle having a center (corresponding to a centroid) at the center of the retardation film 11 was drawn. In this case, an inscribed circle having the largest radius was defined as a first circle, and a circle having a radius half the radius of the first circle was defined as a second circle. In addition, a straight line passing through the center of the above-described retardation film 11 and extending in one direction in the in-plane direction was defined as a first straight line; a straight line passing through the center and obtained by rotating the first straight line clockwise by 45° was defined as a second straight line; a straight line passing through the center and obtained by rotating the second straight line clockwise by 45° was defined as a third straight line; and a straight line passing through the center and obtained by rotating the third straight line clockwise by 45° was defined as a fourth straight line.

Next, a film thickness and an in-plane retardation at the center of the above-described retardation film 11, a film thickness and an in-plane retardation at two intersection points between the first straight line and the first circle, a film thickness and an in-plane retardation at two intersection points between the first straight line and the second circle, a film thickness and an in-plane retardation at two intersection points between the second straight line and the first circle, a film thickness and an in-plane retardation at two intersection points between the second straight line and the second circle, a film thickness and an in-plane retardation at two intersection points between the third straight line and the first circle, a film thickness and an in-plane retardation at two intersection points between the third straight line and the second circle, a film thickness and an in-plane retardation at two intersection points between the fourth straight line and the first circle, and a film thickness and an in-plane retardation at two intersection points between the fourth straight line and the second circle were each measured. The in-plane variation (in-plane variation of Re and in-plane variation of film thickness) was calculated from the average value, the maximum value, and the minimum value of the 17 measured values. Specifically, among the obtained measured values, the maximum value, minimum value, and average value were obtained, and the in-plane variation (%) of Re and the in-plane variation (%) of the film thickness were calculated from the following expression.

$$\begin{matrix}Expression & \\ In - plane variation ( \% ) = \{ ( Maximum value - Minimum value ) / Average value \} \times 100 & \end{matrix}$$

For example, in the case of calculating the in-plane variation of the film thickness, the average value, maximum value, and minimum value of the 17 film thickness measurement values were calculated, and each value was substituted into the expression.

### <Production of Retardation Film 12>

A retardation film 12 having reverse dispersibility was produced using a coating liquid for forming a retardation layer containing a liquid crystal compound having a polymerizable group, with reference to the method described in paragraphs 0151 to 0163 of JP2020-084070A. Here, in a case of curing the liquid crystal compound, the irradiation amount of ultraviolet rays was changed from 300 mJ/cm² to 50 mJ/cm². In addition, in the retardation film 12, the liquid crystal compound was aligned in one direction.

In the obtained retardation film 12, Re was 146 nm and Rth was 73 nm. In addition, an in-plane variation of Re was 0.7%. A film thickness of the coating film of the retardation film 12 was 2.5 μm. In addition, an in-plane variation of the film thickness of the coating film was 0.7%. Here, the film thickness of the coating film was evaluated using SEM. In addition, a polymerization rate of the liquid crystal compound was 26%.

The in-plane variation (%) of Re and the in-plane variation (%) of the film thickness were calculated by the same procedures as the procedures carried out in [Production of retardation film 1] described above.

The polymerization rate was measured by the method described in the first embodiment above.

### <Production of Reflective Type Circular Polarizer 11>

### [Coating Liquid R-1 for Reflecting Layer]

A composition shown below was stirred and dissolved in a container held at 70° C. to prepare a coating liquids R-1 for a reflecting layer. Here, R represents a coating liquid containing a rod-like liquid crystal compound.

Coating liquid R-1 for reflecting layer

| | | |
|---|---|---|
| Methyl ethyl ketone | 120.9 | parts by mass |
| Cyclohexanone | 21.3 | parts by mass |
| Mixture of rod-like liquid crystal compounds | 100.0 | parts by mass |
| shown below | | |
| Photopolymerization initiator b | 1.00 | part by mass |
| Chiral agent A shown below | 3.45 | parts by mass |
| Surfactant F1 shown below | 0.027 | parts by mass |
| Surfactant F2 shown below | 0.067 | parts by mass |

Mixture of rod-like liquid crystal compounds

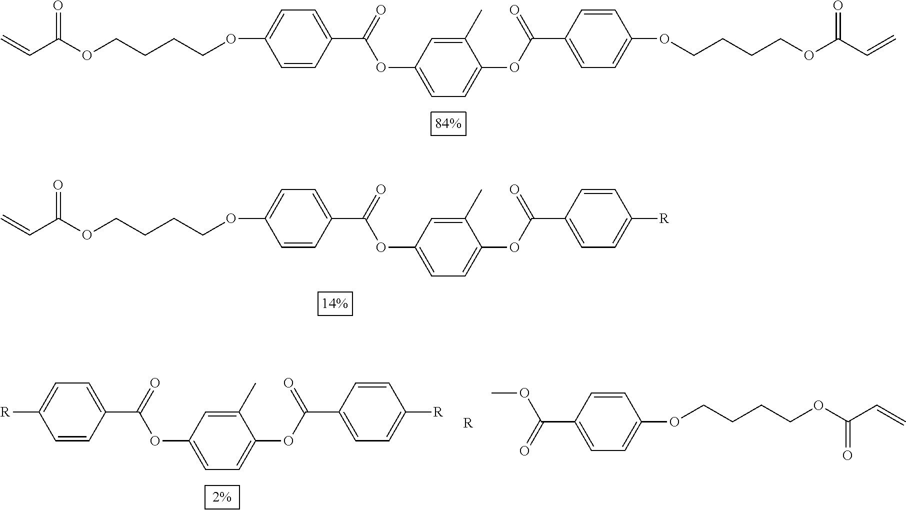

In the above-described mixture, each numerical value denotes the content in units of % by mass. In addition, R is a group bonded through an oxygen atom. Furthermore, an average molar absorption coefficient of the above-described rod-like liquid crystal compound at a wavelength of 300 to 400 nm was 140/mol·cm.

### Chiral Agent A

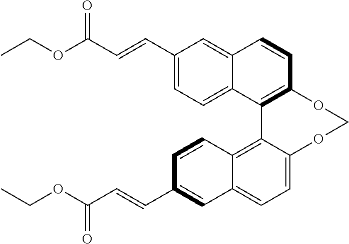

### Surfactant F1

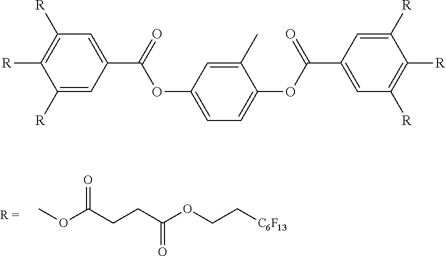

### Surfactant F2

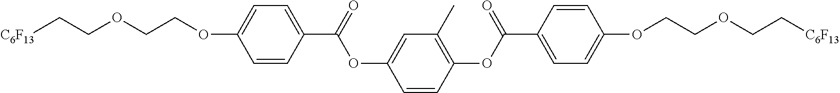

### Photopolymerization Initiator B

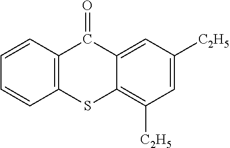 [SMILES: CCc1cc(CC)c2sc3ccccc3c(=O)c2c1]

The chiral agent A is a chiral agent in which helical twisting power (HTP) is reduced by light.

### [Coating Liquid R-2 for Reflecting Layer]

A coating liquid was prepared in the same manner as in the coating liquid R-1 for a reflecting layer, except that the amount of the chiral agent A added was changed as shown in Table 4 below.

Table 4. Amount of chiral agent in coating liquid containing rod-like liquid crystal compound

TABLE 4

| | Amount of chiral agent |
|---|---|
| Name of coating liquid | (part by mass) |
| Liquid R-1 | 3.45 |
| Liquid R-2 | 3.05 |

### [Coating Liquid D-1 for Reflecting Layer]

A composition shown below was stirred and dissolved in a container held at 50° C. to prepare a coating liquids D-1 for a reflecting layer. Here, D represents a coating liquid containing a disk-like liquid crystal compound.

Coating liquid D-1 for reflecting layer

| | | |
|---|---|---|
| Disk-like liquid crystal compound (A) | 80 | parts by mass |
| shown below | | |
| Disk-like liquid crystal compound (B) | 20 | parts by mass |
| shown below | | |
| Polymerizable monomer E1 | 10 | parts by mass |
| Surfactant F4 | 0.3 | parts by mass |
| Photopolymerization initiator | 3 | parts by mass |
| (IRGACURE 907 manufactured by | | |
| BASF SE) | | |
| Chiral agent A described above | 4.48 | parts by mass |
| Methyl ethyl ketone | 290 | parts by mass |
| Cyclohexanone | 50 | parts by mass |

### Disk-Like Liquid Crystal Compound (A)

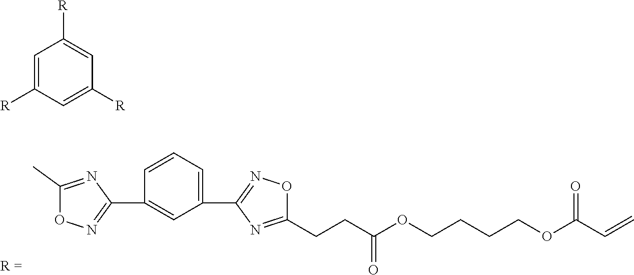

DISK-like liquid crystal compound (B)

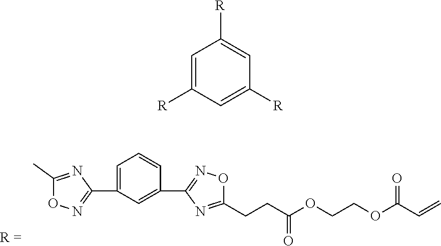

### Polymerizable Monomer E1

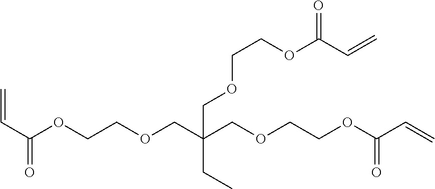 [SMILES: C=CC(=O)OCCOCC(CC)(COCCOC(=O)C=C)COCCOC(=O)C=C]

### Surfactant F4

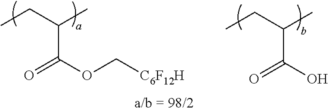

### [Coating Liquid D-2 for Reflecting Layer]

A coating liquid D-2 for a reflective layer was prepared in the same manner as in the coating liquid D-1 for a reflective layer, except that the amount of the chiral agent A added was changed as shown in Table 5.

Table 5. Amount of chiral agent in coating liquid containing disk-like liquid crystal compound

TABLE 5

| | Amount of chiral agent |
|---|---|
| Name of coating liquid | (part by mass) |
| Liquid D-1 | 4.48 |
| Liquid D-2 | 5.31 |

### [Production of Reflective Type Circular Polarizer 11]

A polyethylene terephthalate (PET) film (A4100 manufactured by Toyobo Co., Ltd.) having a thickness of 50 μm was prepared as a temporary support. The PET film had an easy adhesion layer on one surface.

A surface of the PET film, which was not provided with the easy adhesion layer, was subjected to a rubbing treatment, coated with the coating liquid R-1 for a reflecting layer prepared above using a wire bar coater, and dried at 110° C. for 120 seconds. Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a yellow light reflecting layer (first light reflecting layer) consisting of a cholesteric liquid crystal layer. The irradiation with light was performed from the side of the cholesteric liquid crystal layer in all cases. Here, the coating thickness was adjusted so that the film thickness of the cured yellow light reflecting layer was 2.5 μm.

Next, the surface of the yellow light reflecting layer was subjected to a corona treatment at a discharge amount of 150 W·min/m², and the surface subjected to the corona treatment was coated with the coating liquid D-1 for a reflecting layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a green light reflecting layer (second light reflecting layer) on the yellow light reflecting layer. The irradiation with light was performed from the side of the cholesteric liquid crystal layer in all cases. Here, the coating thickness was adjusted so that the film thickness of the cured green light reflecting layer was 2.4 μm.

Next, the green light reflecting layer was coated with the coating liquid R-2 for a reflecting layer using a wire bar coater and dried at 110° C. for 120 seconds. Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a red light reflecting layer (third light reflecting layer) on the green light reflecting layer. The irradiation with light was performed from the side of the cholesteric liquid crystal layer in all cases. Here, the coating thickness was adjusted so that the film thickness of the cured red light reflecting layer was 2.4 μm.

Next, the surface of the red light reflecting layer was subjected to a corona treatment at a discharge amount of 150 W·min/m², and the surface subjected to the corona treatment was coated with the coating liquid D-2 for a reflecting layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a blue light reflecting layer (fourth light reflecting layer) on the red light reflecting layer. The irradiation with light was performed from the side of the cholesteric liquid crystal layer in all cases. Here, the coating thickness was adjusted so that the film thickness of the cured blue light reflecting layer was 2.6 μm.

In this manner, a reflective type circular polarizer 11 was produced. Coating liquids for a reflecting layer used for producing the reflective type circular polarizer 11, the reflection center wavelength, and the film thickness are shown in Table 6.

TABLE 6

| | | Reflection center | |
|---|---|---|---|
| | | wavelength | Film thickness |
| | Type of coating liquid | (nm) | (μm) |
| Fourth | Liquid D-2 | 459 | 2.6 |
| layer | | | |
| Third layer | Liquid R-2 | 644 | 2.4 |
| Second | Liquid D-1 | 539 | 2.4 |
| layer | | | |
| First layer | Liquid R-1 | 576 | 2.5 |

### <Production of Positive C-Plate 11>

A positive C-plate 11 was produced by adjusting the film thickness with reference to the method described in paragraphs 0132 to 0134 of JP2016-053709A. Re of the positive C-plate 11 was 0.2 nm and Rth thereof was −310 nm.

### <Production of Retardation Layer 11>

A retardation layer 11 having reverse dispersibility was produced using a coating liquid for forming a retardation layer containing a liquid crystal compound having a polymerizable group, with reference to the method described in paragraphs 0151 to 0163 of JP2020-084070A. Re of the retardation layer 11 was 146 nm and Rth thereof was 73 nm. As the phase difference of the retardation layer 11, Re was 146 nm and Rth was 73 nm. AxoScan OPMF-1 (manufactured by Opto Science, Inc.) was used for the evaluation of the phase difference. In addition, an in-plane variation of Re was 0.7%. The film thickness of the retardation layer 11 was 2.5 μm. In addition, in the retardation layer 11, the liquid crystal compound was aligned in one direction. In addition, an in-plane variation of the film thickness was 0.7%. Here, the film thickness was evaluated using SEM.

The in-plane variation (%) of Re and the in-plane variation (%) of the film thickness were calculated by the same procedures as the procedures carried out in [Production of retardation film 11] described above.

### <Production of Retardation Layer 12>

A retardation layer 12 having reverse dispersibility was produced using a coating liquid for forming a retardation layer containing a liquid crystal compound having a polymerizable group, with reference to the method described in paragraphs 0151 to 0163 of JP2020-084070A. Here, in a case of curing the liquid crystal compound, the irradiation amount of ultraviolet rays was changed from 300 mJ/cm² to 50 mJ/cm². In addition, in the retardation layer 12, the liquid crystal compound was aligned in one direction.

In the obtained retardation layer 12, Re was 146 nm and Rth was 73 nm. In addition, an in-plane variation of Re was 0.7%. A film thickness of the coating film of the retardation layer 12 was 2.5 μm. In addition, an in-plane variation of the film thickness of the coating film was 0.7%. Here, the film thickness of the coating film was evaluated using SEM. In addition, a polymerization rate of the liquid crystal compound was 26%.

The in-plane variation (%) of Re and the in-plane variation (%) of the film thickness were calculated by the same procedures as the procedures carried out in [Production of retardation film 11] described above.

The polymerization rate was measured by the method described in the first embodiment above.

### <Production of Linear Polarizer>

### (Production of Cellulose Acylate Film 11)

The following composition was put into a mixing tank and stirred to dissolve each component, thereby preparing a cellulose acetate solution used as a core layer cellulose acylate dope.

Core layer cellulose acylate dope

| | | |
|---|---|---|
| Cellulose acetate having acetyl substitution | 100 | parts by mass |
| degree of 2.88 | | |
| Polyester compound B described in Examples | 12 | parts by mass |
| of JP2015-227955A | | |
| Compound F shown below | 2 | parts by mass |
| Methylene chloride (first solvent) | 430 | parts by mass |
| Methanol (second solvent) | 64 | parts by mass |

### Compound F

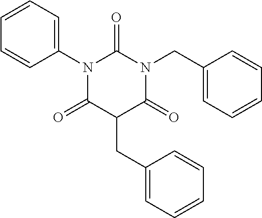 [SMILES: O=C1C(Cc2ccccc2)C(=O)N(c2ccccc2)C(=O)N1Cc1ccccc1]

10 parts by mass of the following matte agent solution was added to 90 parts by mass of the core layer cellulose acylate dope to prepare a cellulose acetate solution to be used as an outer layer cellulose acylate dope.

Matting agent solution

| | | |
|---|---|---|
| Silica particles having an average particle | 2 | parts by mass |
| diameter of 20 nm (AEROSIL R972, | | |
| manufactured by Nippon Aerosil Co., Ltd.) | | |
| Methylene chloride (first solvent) | 76 | parts by mass |
| Methanol (second solvent) | 11 | parts by mass |
| Core layer cellulose acylate dope described | 1 | part by mass |
| above | | |

The core layer cellulose acylate dope and the outer layer cellulose acylate dope were filtered through filter paper having an average hole diameter of 34 μm and a sintered metal filter having an average pore size of 10 μm, and three layers which were the core layer cellulose acylate dope and the outer layer cellulose acylate dopes provided on both sides of the core layer cellulose acylate dope were simultaneously cast from a casting port onto a drum at 20° C. (band casting machine).

Next, the film was peeled off in a state where the solvent content was approximately 20% by mass, both ends of the film in the width direction were fixed by tenter clips, and the film was dried while being stretched at a stretching ratio of 1.1 times in the lateral direction.

Thereafter, the film was further dried by being transported between the rolls of the heat treatment device to prepare an optical film having a thickness of 40 μm, and the optical film was used as a cellulose acylate film 11. An in-plane retardation of the obtained cellulose acylate film 11 was 0 nm.

### (Formation of Photoalignment Layer PA1)

The cellulose acylate film 11 was continuously coated with a coating liquid S-PA-1 for forming an alignment layer described below with a wire bar. The support on which the coating film was formed was dried with hot air at 140° C. for 120 seconds, and the coating film was irradiated with polarized ultraviolet rays (10 mJ/cm², using an ultra-high pressure mercury lamp) to form a photoalignment layer PAL. A film thickness thereof was 0.3 μm.

(Coating liquid S-PA-1 for forming alignment layer)

| | | |
|---|---|---|
| Polymer M-PA-1 shown below | 100.00 | parts by mass |
| Acid generator PAG-1 shown below | 5.00 | parts by mass |
| Acid generator CPI-110TF shown below | 0.005 | parts by mass |
| Xylene | 1220.00 | parts by mass |
| Methyl isobutyl ketone | 122.00 | parts by mass |

### Polymer M-PA-1

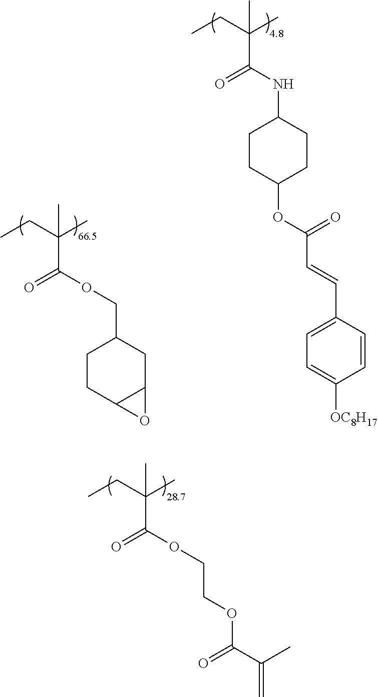

### Acid Generator PAG-1

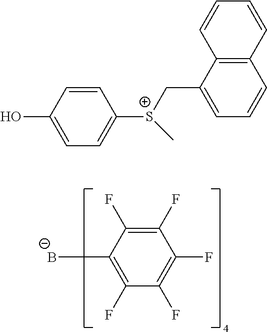

### Acid Generator CPI-110F

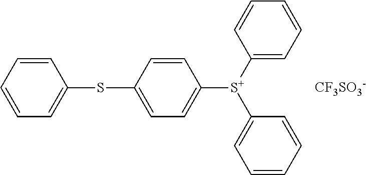

### (Formation of Light Absorption Anisotropic Layer P1)

The obtained photoalignment layer PA1 was continuously coated with the following coating liquid S-P-1 for forming a light absorption anisotropic layer with a wire bar. Next, the coating layer P1 was heated at 140° C. for 30 seconds and cooled to room temperature (23° C.). Next, the coating layer P1 was heated at 90° C. for 60 seconds and cooled to room temperature again. Thereafter, the coating layer P1 was irradiated with an LED lamp (central wavelength of 365 nm) for 2 seconds under an irradiation condition of an illuminance of 200 mW/cm², thereby forming a light absorption anisotropic layer P1 on the photoalignment layer PAL. A film thickness thereof was 1.6 μm.

Composition of coating liquid S-P-1 for forming light absorption
anisotropic layer

| | | |
|---|---|---|
| Dichroic substance D-1 shown below | 0.25 | parts by mass |
| Dichroic substance D-2 shown below | 0.36 | parts by mass |
| Dichroic substance D-3 shown below | 0.59 | parts by mass |
| Polymer liquid crystal compound M-P-1 | 2.21 | parts by mass |
| shown below | | |
| Low-molecular-weight liquid crystal | 1.36 | parts by mass |
| compound M-1 | | |
| Polymerization initiator | | |
| IRGACURE OXE-02 | 0.200 | parts by mass |
| (manufactured by BASF SE) | | |
| Surfactant F-1 shown below | 0.026 | parts by mass |
| Cyclopentanone | 46.00 | parts by mass |
| Tetrahydrofuran | 46.00 | parts by mass |
| Benzyl alcohol | 3.00 | parts by mass |

### Dichroic Substance D-1

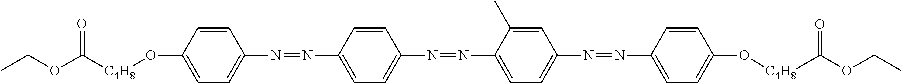

### Dichroic Substance D-2

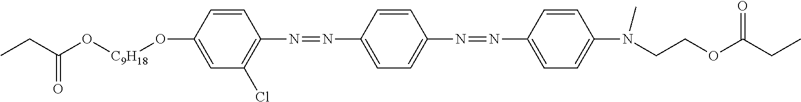

### Dichroic Substance D-3

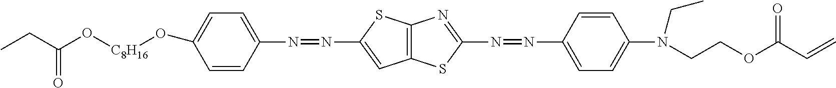

### Polymer Liquid Crystal Compound M-P-1

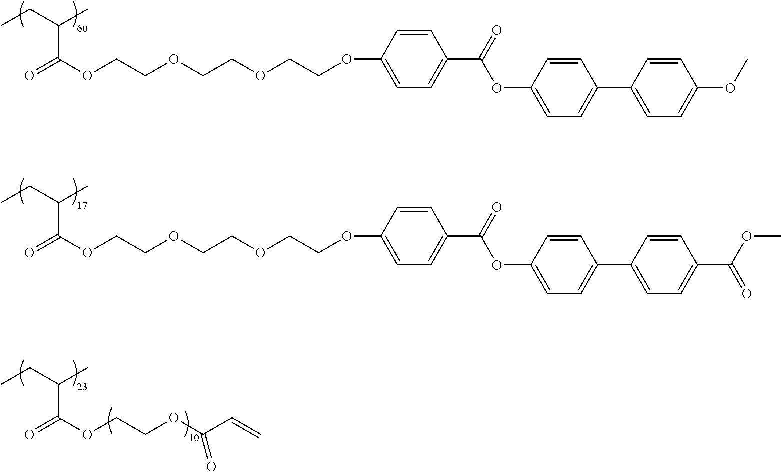

### Low-Molecular-Weight Liquid Crystal Compound M-1

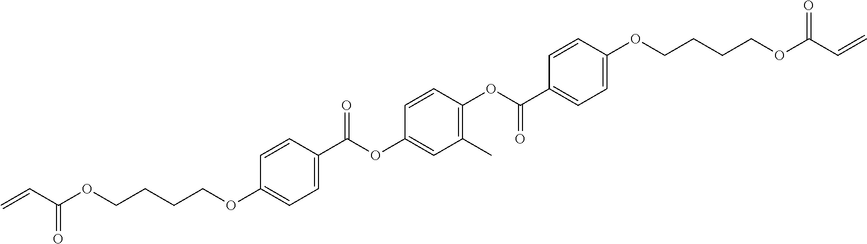 [SMILES: C=CC(=O)OCCCCOc1ccc(C(=O)Oc2ccc(OC(=O)c3ccc(OCCCCOC(=O)C=C)cc3)c(C)c2)cc1]

### Surfactant F-1

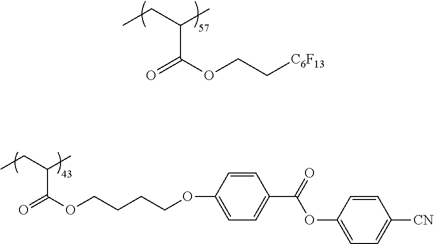

### <Production of Laminated Optical Body 11>

The transfer of the reflective type circular polarizer 11 was carried out by the following procedure. The obtained reflective type circular polarizer 11 was transferred to a support side of the obtained positive C-plate 11. In this case, the reflective type circular polarizer 11 was once transferred to a temporary support having a pressure-sensitive adhesive layer to expose the layer on the temporary support side and then bonded to the positive C-plate 11, such that the layer on the temporary support side (first light reflecting layer) was the positive C-plate 11 side. The temporary support of the reflective type circular polarizer 11 was peeled off and removed after the bonding. The obtained retardation layer 11 was bonded to the obtained positive C-plate 11 on a side opposite to the support. Next, the light absorption anisotropic layer P1 was transferred. In this case, the light absorption anisotropic layer P1 was transferred such that a layer on a side opposite to the temporary support was on the retardation layer 11 side. The temporary support of the light absorption anisotropic layer P1 was peeled off and removed after the transfer. The transfer of the light absorption anisotropic layer P1 was performed by the following procedure.

(1) A UV adhesive Chemi-seal U2084B (manufactured by ChemiTech Inc., refractive index n after curing: 1.60) was applied onto the positive C-plate 11 on the support side using a wire bar coater such that the thickness was set to 2 μm; the light absorption anisotropic layer P1 was laminated thereon with a laminator such that the side opposite to the temporary support was in contact with the UV adhesive.

(2) After nitrogen purging until the oxygen concentration reached 100 ppm or less in a purge box, the light absorption anisotropic layer P1 was cured by being irradiated with ultraviolet rays using a high-pressure mercury lamp from the temporary support side; the illuminance was 25 mW/cm² and the irradiation amount was 1,000 mJ/cm².

(3) Finally, the temporary support of the light absorption anisotropic layer P1 was peeled off.

Here, the retardation layer 11 and the light absorption anisotropic layer P1 were laminated such that the slow axis of the retardation layer 1 and the absorption axis of the light absorption anisotropic layer P1 formed an angle of 45°. Finally, the support of the positive C-plate 11 was peeled off. Next, the retardation layer 11 and the antireflection film were laminated on the light absorption anisotropic layer P1 in this order. In this manner, a laminated optical body 1 in which the reflective type circular polarizer 11 was used as a circularly polarized light reflective polarizer was obtained.

### <Production of Laminated Optical Body 12>

A wideband dielectric multi-layer film (trade name: APF, 3M Company) was used as a linear polarization type reflective polarizer. The retardation layer 11 and the positive C-plate 11 were bonded to one surface of APF in this order. In addition, the light absorption anisotropic layer P1 was transferred to a surface on the opposite side by the same procedure as in the laminated optical body 11. Next, the retardation layer 11 and the antireflection film were laminated on the light absorption anisotropic layer P1. In this manner, a laminated optical body 2 was produced using the linear polarization type reflective polarizer.

### <Production of Laminated Optical Body 13>

A wideband dielectric multi-layer film (trade name: APF, 3M Company) was used as a linear polarization type reflective polarizer. The light absorption anisotropic layer P1 was transferred to one surface of APF by the same procedure as in the laminated optical body 11. Next, the retardation layer 11 and the antireflection film were laminated on the light absorption anisotropic layer P1. In this manner, a laminated optical body 13 was produced using the linear polarization type reflective polarizer. In addition, the retardation layer 12 and the positive C-plate 11 were bonded to the surface of the opposite side in this order through a pressure-sensitive adhesive sheet “NCF-D692(5)” manufactured by LINTEC Corporation.

### <Formation of Half Mirror on Composite Lens>

A convex surface side of a lens (convex meniscus lens LE1076-A (diameter: 2 inches, focal length: 100 mm) manufactured by Thorlabs, Inc.) was subjected to aluminum vapor deposition so that the reflectivity was 40%, thereby forming a half mirror.

### Examples 11 and 12

### (Forming Method 1)

The retardation film 11 was bonded to a PMMA film through a pressure-sensitive adhesive sheet “NCF-D692(5)” manufactured by LINTEC Corporation, and set in a forming device. At this time, the PMMA film side was positioned on the lower side. A forming space in the forming device consisted of a box 1 and a box 2, partitioned by the retardation film 11, and in the box 1 on the lower side of the retardation film 11, #32-974 (convex lens with a diameter of 2 inches and a curvature radius of 78 mm) manufactured by Edmund Optics was placed as a mold with the convex surface facing upward. In addition, a transparent window was installed on the upper part of the box 2 on the upper side of the retardation film 11, and an IR light source for heating the retardation film 11 was installed on the outside of the forming device. Next, each of the inside of box 1 and the inside of box 2 was evacuated to 0.1 atm or less by a vacuum pump. Next, as a step of heating the retardation film 11, infrared rays were emitted, and the retardation film 11 was heated until a temperature reached 108° C. Since the glass transition temperature Tg of the PMMA film used as the support was 105° C., it was intended that the film would be more likely to stretch during the forming. Next, as a step of pressing the retardation film 11 against the mold to deform the retardation film 11 along a shape of the mold, gas was allowed to flow into the box 2 from a gas cylinder to pressurize the retardation film to 300 kPa, and the retardation film 11 was pressed against the mold. Finally, the retardation film 11 was removed from the mold which was a lens. As a result, the retardation film 11 formed into a non-planar shape was obtained.

Next, the retardation film 11 formed into a non-planar shape was set in the forming device such that the PMMA film side was located on the upper side, with the first forming being performed in the opposite direction. In this case, a region of the retardation film 11, which was formed into a non-planar shape by the first forming, protruded on the lower side. A convex meniscus lens LE1076-A (diameter: 2 inches, focal length: 100 mm, curvature radius on the concave side: 65 mm) manufactured by Thorlabs, Inc., which had been subjected to aluminum vapor deposition on the convex surface side, was disposed as a mold just below the region of the retardation film 11 which was formed into a non-planar shape, such that the concave surface was directed upward. Next, each of the inside of box 1 and the inside of box 2 was evacuated to 0.1 atm or less by a vacuum pump. Next, as a step of heating the retardation film 11, infrared rays were emitted, and the retardation film 11 was heated until a temperature reached 108° C. Next, as a step of pressing the retardation film 11 against the mold to deform the retardation film 11 along a shape of the mold, gas was allowed to flow into the box 2 from a gas cylinder to pressurize the retardation film to 300 kPa, and the retardation film 11 was pressed against the mold. Finally, the retardation film 11 was removed from the mold which was a lens. In this manner, a retardation film 11 formed on the curved surface by the forming method 1 was obtained as Example 11.

### (Forming Method 2)

The retardation film 11 was bonded to a PMMA film through a pressure-sensitive adhesive sheet “NCF-D692(5)” manufactured by LINTEC Corporation, and set in a forming device. A forming space in the forming device consisted of a box 1 and a box 2, partitioned by the retardation film 11, and a convex meniscus lens LE1076-A (diameter: 2 inches, focal length: 100 mm, curvature radius on the concave side: 65 mm) manufactured by Thorlabs, Inc., which had been subjected to aluminum vapor deposition on the convex surface side, was disposed as a mold in the box 1 on the lower side of the retardation film 11, with the concave surface facing upward. In addition, a transparent window was installed on the upper part of the box 2 on the upper side of the retardation film 11, and an JR light source for heating the retardation film 11 was installed on the outside of the forming device. Between the IR light source and the retardation film 11, a cholesteric liquid crystal layer which reflects infrared rays with wavelengths from 2.2 μm to 3.0 μm at a reflectivity of approximately 50% was cut into a circular shape having a diameter of 1 inch, and a circular patterned infrared reflecting filter was disposed. In this case, the center portion of the patterned infrared reflecting filter was disposed to be located at the center portion of the mold in a case of being viewed from directly above. Next, each of the inside of box 1 and the inside of box 2 was evacuated to 0.1 atm or less by a vacuum pump. Next, as a step of heating the retardation film 11, infrared rays were emitted, and the retardation film 11 was heated until the center portion was heated to 99° C. and the end part heated to 108° C. Since the glass transition temperature Tg of the PMMA film used as the support was 105° C., it was intended that the center portion would be less likely to stretch and the end part would be more likely to stretch during the forming. Next, as a step of pressing the retardation film 11 against the mold to deform the retardation film 11 along a shape of the mold, gas was allowed to flow into the box 2 from a gas cylinder to pressurize the retardation film to 300 kPa, and the retardation film 11 was pressed against the mold. Finally, the retardation film 11 was removed from the mold which was a lens. In this manner, a retardation film 11 formed on the curved surface by the forming method 2 was obtained as Example 12.

In the above-described forming method 2, the stretching ratio in the diameter direction increased as the distance from the center increased.

### Examples 15 and 16

### (Forming Method 3)

The retardation film 12 was bonded to a PMMA film through a pressure-sensitive adhesive sheet “NCF-D692(5)” manufactured by LINTEC Corporation, and set in a forming device. At this time, the PMMA film side was positioned on the lower side. A forming space in the forming device consisted of a box 1 and a box 2, partitioned by the retardation film 12, and in the box 1 on the lower side of the retardation film 12, #32-974 (convex lens with a diameter of 2 inches and a curvature radius of 78 mm) manufactured by Edmund Optics was placed as a mold with the convex surface facing upward. In addition, a transparent window was installed on the upper part of the box 2 on the upper side of the retardation film 12, and an IR light source for heating the retardation film 12 was installed on the outside of the forming device. Next, each of the inside of box 1 and the inside of box 2 was evacuated to 0.1 atm or less by a vacuum pump. Next, as a step of heating the retardation film 12, infrared rays were emitted, and the retardation film 12 was heated until a temperature reached 108° C. Since the glass transition temperature Tg of the PMMA film used as the support was 105° C., it was intended that the film would be more likely to stretch during the forming. Next, as a step of pressing the retardation film 12 against the mold to deform the retardation film 12 along a shape of the mold, gas was allowed to flow into the box 2 from a gas cylinder to pressurize the retardation film to 300 kPa, and the retardation film 12 was pressed against the mold. Finally, the retardation film 12 was removed from the mold which was a lens. As a result, the retardation film 12 formed into a non-planar shape was obtained.

Next, the retardation film 12 formed into a non-planar shape was set in the forming device such that the PMMA film side was located on the upper side, with the first forming being performed in the opposite direction. In this case, a region of the retardation film 12, which was formed into a non-planar shape by the first forming, protruded on the lower side. A convex meniscus lens LE1076-A (diameter: 2 inches, focal length: 100 mm, curvature radius on the concave side: 65 mm) manufactured by Thorlabs, Inc., which was subjected to aluminum vapor deposition on the convex surface side, was disposed as a mold just below the region of the retardation film 12 which was formed into a non-planar shape, such that the concave surface was directed upward. Next, each of the inside of box 1 and the inside of box 2 was evacuated to 0.1 atm or less by a vacuum pump. Next, as a step of heating the retardation film 12, infrared rays were emitted, and the retardation film 12 was heated until a temperature reached 108° C. Next, as a step of pressing the retardation film 12 against the mold to deform the retardation film 12 along a shape of the mold, gas was allowed to flow into the box 2 from a gas cylinder to pressurize the retardation film to 300 kPa, and the retardation film 12 was pressed against the mold. Next, the mold in which the retardation film 12 had been pressed was heated at 110° C. for 30 seconds to perform an alignment treatment, and further irradiated with ultraviolet rays at an intensity of 300 mJ/cm² to be cured. As a result of measuring a polymerization rate of the liquid crystal layer in the retardation film 12 by the ATR method, the polymerization rate was 78%. Finally, the retardation film 12 was removed from the mold which was a lens. In this manner, a retardation film 12 formed on the curved surface by the forming method 3 was obtained as Example 15.

### (Forming Method 4)

The retardation film 12 was bonded to a PMMA film through a pressure-sensitive adhesive sheet “NCF-D692(5)” manufactured by LINTEC Corporation, and set in a forming device. A forming space in the forming device consisted of a box 1 and a box 2, partitioned by the retardation film 12, and a convex meniscus lens LE1076-A (diameter: 2 inches, focal length: 100 mm, curvature radius on the concave side: 65 mm) manufactured by Thorlabs, Inc., which had been subjected to aluminum vapor deposition on the convex surface side, was disposed as a mold in the box 1 on the lower side of the retardation film 12, with the concave surface facing upward. In addition, a transparent window was installed on the upper part of the box 2 on the upper side of the retardation film 12, and an IR light source for heating the retardation film 12 was installed on the outside of the forming device. Between the IR light source and the retardation film 12, a cholesteric liquid crystal layer which reflects infrared rays with wavelengths from 2.2 μm to 3.0 μm at a reflectivity of approximately 50% was cut into a circular shape having a diameter of 1 inch, and a circular patterned infrared reflecting filter was disposed. In this case, the center portion of the patterned infrared reflecting filter was disposed to be located at the center portion of the mold in a case of being viewed from directly above. Next, each of the inside of box 1 and the inside of box 2 was evacuated to 0.1 atm or less by a vacuum pump. Next, as a step of heating the retardation film 12, infrared rays were emitted, and the retardation film 12 was heated until the center portion was heated to 99° C. and the end part heated to 108° C. Since the glass transition temperature Tg of the PMMA film used as the support was 105° C., it was intended that the center portion would be less likely to stretch and the end part would be more likely to stretch during the forming. Next, as a step of pressing the retardation film 12 against the mold to deform the retardation film 12 along a shape of the mold, gas was allowed to flow into the box 2 from a gas cylinder to pressurize the retardation film to 300 kPa, and the retardation film 12 was pressed against the mold. Next, the mold in which the retardation film 12 had been pressed was heated at 110° C. for 30 seconds to perform an alignment treatment, and further irradiated with ultraviolet rays at an intensity of 300 mJ/cm² to be cured. As a result of measuring a polymerization rate of the liquid crystal layer in the retardation film 12 by the ATR method, the polymerization rate was 78%. Finally, the retardation film 12 was removed from the mold which was a lens. In this manner, a retardation film 12 formed on the curved surface by the forming method 4 was obtained as Example 16.

### <Evaluation of Formed Retardation Film>

The phase difference of the retardation film 11 formed on the curved surface of Example 11 was Re=140 nm and Rth=70 nm. In addition, an in-plane variation of Re was 2.7%. A film thickness of the retardation film 11 formed on the curved surface of Example 11 was 2.4 μm. In addition, an in-plane variation of the film thickness was 3.0%. As a result, it was found that the retardation film 11 formed on the curved surface by the forming method 1 had an in-plane variation which increased by approximately 2% in both the phase difference and the film thickness.

The in-plane variation of the product of the stretching ratio in the diameter direction and the stretching ratio in the circumferential direction (direction orthogonal to the diameter direction) of the retardation film 11 formed on the curved surface of Example 11 was 2.1%.

The above-described in-plane variation of Re and the above-described in-plane variation of the film thickness were measured by the above-described methods (the above-described specific method 1 and the above-described specific method 2).

The phase difference of the retardation film 11 formed on the curved surface of Example 12 was Re=140 nm and Rth=70 nm. In addition, an in-plane variation of Re was 3.3%. A film thickness of the retardation film 11 formed on the curved surface of Example 12 was 2.4 μm. In addition, an in-plane variation of the film thickness was 3.2%. As a result, it was found that the retardation film 11 formed on the curved surface by the forming method 2 had an in-plane variation which increased by approximately 2.5% in both the phase difference and the film thickness.

The in-plane variation of the product of the stretching ratio in the diameter direction and the stretching ratio in the circumferential direction (direction orthogonal to the diameter direction) of the retardation film 11 formed on the curved surface of Example 12 was 2.5%.

The above-described in-plane variation of Re and the above-described in-plane variation of the film thickness were measured by the above-described methods (the above-described specific method 1 and the above-described specific method 2).

The phase difference of the retardation film 12 formed on the curved surface of Example 15 was Re=140 nm and Rth=70 nm. In addition, an in-plane variation of Re was 2.5%. A film thickness of the retardation film 12 formed on the curved surface of Example 15 was 2.4 μm. In addition, an in-plane variation of the film thickness was 3.2%. As a result, it was found that the retardation film 12 formed on the curved surface by the forming method 3 had an in-plane variation of the phase difference, which increased by approximately 1.8%. In addition, it was found that the in-plane variation of the film thickness increased by approximately 2.5%.

The in-plane variation of the product of the stretching ratio in the diameter direction and the stretching ratio in the circumferential direction (direction orthogonal to the diameter direction) of the retardation film 12 formed on the curved surface of Example 15 was 2.5%.

The phase difference of the retardation film 12 formed on the curved surface of Example 16 was Re=140 nm and Rth=70 nm. In addition, an in-plane variation of Re was 2.5%. A film thickness of the retardation film 12 formed on the curved surface of Example 16 was 2.4 μm. In addition, an in-plane variation of the film thickness was 3.2%. As a result, it was found that the retardation film 12 formed on the curved surface by the forming method 4 had an in-plane variation of the phase difference, which increased by approximately 1.8%. In addition, it was found that the in-plane variation of the film thickness increased by approximately 2.5%.

The in-plane variation of the product of the stretching ratio in the diameter direction and the stretching ratio in the circumferential direction (direction orthogonal to the diameter direction) of the retardation film 12 formed on the curved surface of Example 16 was 2.5%.

### Examples 13 and 14

The laminated optical body 11 was formed by the same procedure as in the forming method 1. The laminated optical member 11 was attached to the mold through a pressure-sensitive adhesive sheet, and the laminated optical member 11 was cut by trimming the portion protruding from the lens which was the mold, thereby obtaining a composite lens 11 in which the laminated optical body 11 formed on a curved surface was bonded to the lens.

The laminated optical body 12 was formed by the same procedure as in the forming method 1. The laminated optical member 12 was attached to the mold through a pressure-sensitive adhesive sheet, and the laminated optical member 12 was cut by trimming the portion protruding from the lens which was the mold, thereby obtaining a composite lens 12 in which the laminated optical body 12 formed on a curved surface was bonded to the lens.

### Examples 17 and 18

The laminated optical body 14 was formed by the same procedure as in the forming method 3. The laminated optical member 13 was attached to the mold through a pressure-sensitive adhesive sheet, and the laminated optical member 13 was cut by trimming the portion protruding from the lens which was the mold, thereby obtaining a composite lens 13 in which the laminated optical body 14 formed on a curved surface was bonded to the lens.

The laminated optical body 14 was formed by the same procedure as in the forming method 4. The laminated optical member 13 was attached to the mold through a pressure-sensitive adhesive sheet, and the laminated optical member 13 was cut by trimming the portion protruding from the lens which was the mold, thereby obtaining a composite lens 14 in which the laminated optical body 14 formed on a curved surface was bonded to the lens.

### <Production of Virtual Reality Display Apparatus>

A virtual reality display apparatus “Huawei VR Glass” (manufactured by Huawei Technologies Co., Ltd.), which was a virtual reality display apparatus for which a reciprocating optical system was employed, was disassembled, and all composite lenses were taken out. A virtual reality display apparatus of Example 13 was produced by incorporating the composite lens 11 to which the laminated optical body 11 had been bonded into the body instead of the lens, in which the light absorption anisotropic layer P1 side of the laminated optical body was installed between the composite lens 11 and the eye such that the light absorption anisotropic layer P1 side was on the eye side. In the produced virtual reality display apparatus, a black-and-white checkered pattern was displayed on an image display panel, and ghost visibility was visually evaluated in terms of the following four stages.

### (Evaluation of Ghost)

AA: ghost was almost invisible.
A: ghost was slightly visible, but not noticeable.
B: weak ghost was visible.
C: slightly strong ghost was visible.
D: strong ghost was visible.

Furthermore, virtual reality display apparatuses of Examples 14, 17, and 18 were produced by the same procedure, and the ghost visibility was evaluated. Table 7 shows the forming method and the type of optical film used in each of Examples. In addition, the evaluation results thereof are described in Table 8.

As a result, in the virtual reality display apparatuses of Examples 13, 14, 17, and 18, the ghost was good over the entire region of visual field. In addition, the change in color of the white portion of the black-and-white checkered pattern was not noticeable.

Table 7. Type of forming method and optical film used in Examples

TABLE 7

| | | Forming | |
|---|---|---|---|
| Example | Composite lens | method | Optical film before forming |
| Example 11 | — | Forming | Optical film 11 |
| | | method 1 | |
| Example 12 | — | Forming | Optical film 11 |
| | | method 2 | |
| Example 15 | — | Forming | Optical film 12 |
| | | method 3 | |
| Example 16 | — | Forming | Optical film 12 |
| | | method 4 | |
| Example 13 | Composite lens | Forming | Laminated optical body 11 |
| | 11 | method 1 | (circularly polarized light |
| | | | reflective polarizer) |
| Example 14 | Composite lens | Forming | Laminated optical body 12 |
| | 12 | method 1 | (linear polarization type |
| | | | reflective polarizer) |
| Example 17 | Composite lens | Forming | Laminated optical body 13 |
| | 13 | method 3 | (linear polarization type |
| | | | reflective polarizer) |
| Example 18 | Composite lens | Forming | Laminated optical body 14 |
| | 14 | method 4 | (linear polarization type |
| | | | reflective polarizer) |

Table 8. Evaluation results of Examples

TABLE 8

| | Ghost visibility | |
|---|---|---|
| | Center portion of visual field | End part of visual field |
| Example 13 | A | A |
| Example 14 | A | A |
| Example 17 | A | AA |
| Example 18 | A | AA |

### EXPLANATION OF REFERENCES

10, 20: virtual reality display apparatus
11, 12, 13, 14: λ/4 retardation layer
21, 22: absorption type linear polarizer
30: half mirror
34, 36: lens base material
40: reflective type circular polarizer
42: reflective type linear polarizer
50, 51, 52: antireflection layer
70: image display panel
72: image display device
80, 82: plano-convex lens with optically functional layer
90, 92: biconvex lens with optically functional layer
100, 100B: laminated optical body
101: cholesteric liquid crystal layer
102: positive C-plate
103: retardation layer
104: linear polarizer
105: retardation layer
106: antireflection film
111: positive C-plate
112: retardation layer
113: linear polarization type reflective polarizer
114: linear polarizer
115: retardation layer
116: antireflection film
131: first light reflecting layer
132: second light reflecting layer
133: third light reflecting layer
134: fourth light reflecting layer
200: lens
220, 234, 240: forming die having concave forming surface
222: film
224: film on which concave surface shape is transferred
226, 230: forming die having convex forming surface
228: film on which convex surface shape is transferred
232: optical film on which convex surface shape is transferred
236: optical film having curved shape portion
242: optical film having planar shape
300: half mirror
400: reflective type circular polarizer
500: image display panel
1000: ray forming virtual image
2000: ray forming ghost

What is claimed is:

1. An optically functional film obtained by forming a composition which contains at least a liquid crystal compound having a polymerizable group,
wherein a polymerization rate of the liquid crystal compound is 40% or less.

2. The optically functional film according to claim 1,
wherein the liquid crystal compound is aligned in one direction.

3. The optically functional film according to claim 1,
wherein the liquid crystal compound is helically aligned.

4. An optical laminate comprising:
the optically functional film according to claim 1; and
a substrate film consisting of a resin having a peak temperature of tan δ of 170° C. or lower.

5. A formed product obtained by forming, into a three-dimensional shape including a curved surface, an optical laminate including the optically functional film according to claim 1 and a substrate film.

6. A manufacturing method of an optical component, comprising:
a curing step of performing at least one curing treatment selected from the group consisting of a heat treatment and an ultraviolet irradiation on the formed product according to claim 5,
wherein the polymerization rate of the liquid crystal compound in the optically functional film is to be 50% or more by the curing treatment.

7. The manufacturing method of an optical component according to claim 6, further comprising, before the curing step:
an alignment step of heating the formed product to align the liquid crystal compound.

8. An optical component manufactured by the manufacturing method of an optical component according to claim 6.

9. A virtual reality display apparatus comprising:
an image display device which emits polarized light; and
the optical component according to claim 8.

10. An optical film having a non-planar shape,
wherein a curvature radius is 30 mm to 1,000 mm, and
an in-plane variation of a phase difference is less than 5%.

11. The optical film according to claim 10,
wherein the curvature radius is 30 mm to 100 mm.

12. The optical film according to claim 10,
wherein the in-plane variation of the phase difference is less than 3%.

13. The optical film according to claim 10,
wherein an in-plane variation of a film thickness is less than 5%.

14. The optical film according to claim 10,
wherein the optical film is a retardation film.

15. The optical film according to claim 10,
wherein the optical film is a retardation film in which an in-plane retardation at a wavelength of 550 nm is in a range of 120 nm to 160 nm.

16. The optical film according to claim 10,
wherein the optical film is a laminated optical body including a retardation film and a reflective type polarizer.

17. A forming method of an optical film, comprising:
a step of heating an optical film having a planar shape;
a first forming step of pressing the optical film against a first mold to deform the optical film along a shape of the first mold; and
a second forming step of pressing the optical film obtained in the first forming step against a second mold to deform the optical film along a shape of the second mold.

18. The forming method of an optical film according to claim 17,
wherein the shape of the first mold includes a convex curved surface portion, and
the shape of the second mold includes a concave curved surface portion.

19. The forming method of an optical film according to claim 17,
wherein a curvature radius of the first mold is larger than a curvature radius of the second mold.

20. A forming method of an optical film, comprising:
a step of heating an optical film having a planar shape;
a step of pressing the optical film against a mold to deform the optical film along a shape of the mold; and
a step of cutting the deformed optical film,
wherein the heating step is a step of heating the optical film by irradiating the optical film with infrared rays, and
an irradiation amount of the infrared rays has a distribution in a plane of the optical film.

21. The forming method of an optical film according to claim 20,
wherein the mold is substantially concave sphere, and
in a case where an in-plane position of the optical film is projected onto the mold from a normal direction of a surface of the optical film, an amount of infrared irradiation to the optical film located at a vertex of the concave sphere is smaller than an amount of infrared irradiation to the optical film located at an end part of the concave sphere.

22. The forming method of an optical film according to claim 20,
wherein the mold is substantially concave sphere, and
in a case where an in-plane position of the optical film is projected onto the mold from a normal direction of a surface of the optical film, a temperature of the optical film located at a vertex of the concave sphere is lower than a temperature of the optical film located at an end part of the concave sphere.

23. A forming method of an optical film, in which an optical film having a planar shape is deformed into a non-planar shape,
wherein an in-plane variation of a product of a stretching ratio in a diameter direction and a stretching ratio in a circumferential direction is less than 5%.

24. The forming method of an optical film according to claim 23,
wherein the in-plane variation of the product of the stretching ratio in the diameter direction and the stretching ratio in the circumferential direction is less than 3%.

25. The forming method of an optical film according to claim 23,
wherein the stretching ratio in the diameter direction increases as a distance from a center increases.
